(19) United States
(12) Patent Application Publication
(10) Pub. No.: US 2022/0371737 A1
(43) Pub. Date: Nov. 24, 2022

(54) VEHICLE SUITE SEATING ARRANGEMENT

(71) Applicant: Zephyr Aerospace, LLC, San Juan, PR (US)

(72) Inventors: Jeffrey O'Neill, San Francisco, CA (US); Victor Dominique Carlioz, Manhattan Beach, CA (US); Matthew Cleary, Manhattan Beach, CA (US)

(21) Appl. No.: 17/700,418

(22) Filed: Mar. 21, 2022

Related U.S. Application Data
(63) Continuation-in-part of application No. 16/374,376, filed on Apr. 3, 2019, now Pat. No. 11,312,494.
(60) Provisional application No. 63/233,698, filed on Aug. 16, 2021.
(60) Provisional application No. 62/652,836, filed on Apr. 4, 2018.

(51) Int. Cl. B64D 11/06

(52) U.S. Cl. CPC B64D 11/0641; B64D 11/0606; B64D 11/0605

(57) ABSTRACT

Disclosed is a vehicle seating arrangement may include structural units positioned along a longitudinal axis of a vehicle. Each structural unit may include a frame supported relative to the vehicle, a lower seating suite generally facing a forward portion of the vehicle, and an upper seating suite generally facing an aft portion of the vehicle. Each of the lower and upper seating suites may be configurable between an upright seating position and a lie-flat seating position. Further, each of the lower seating suit and the upper seating suit of each structural unit may include an integrated seat pan and extension positioned in same for optionally configuring the respective seating suite in either the upright seating position or the lie-flat seating position.

### CROSS REFERENCE TO RELATED APPLICATIONS

This application is a continuation-in-part tracing priority to U.S. patent application Ser. No. 16/374,376 filed on Apr. 3, 2019 which itself traces priority to U.S. Provisional Patent Application 62/652,836 filed on Apr. 4, 2018. This application is also a non-provisional application tracing priority to U.S. Provisional Application 63/233,698 filed on Aug. 16, 2021. The entirety of the U.S. patent application Ser. No. 16/374,376 and U.S. Provisional Patent Application Nos. 62/652,836 and 63/233,698 are expressly incorporated herein by reference.

### TECHNICAL FIELD AND BACKGROUND OF INVENTION

The present disclosure generally relates to vehicular seating suite arrangements and configurations and, more particularly, to vertically stacked seating suites in a vehicle.

More individuals are traveling further than ever before. Long trips, either by aircraft, boat, train, bus, car, etc., often extend overnight making travel uncomfortable. For example, many passengers are unable to sleep in the limited recline of a chair. While many premium seating options provide motorized reclining seats and private cabins for passengers, these seating options provide poor seating density in a vehicle and/or a significant expense for vehicle operators. Additionally, safety regulations associated with most commercial travel limit vehicle operators from providing more comfortable seating options.

As such, a need exists in the art for an improved vehicular seating suit arrangement and configuration that overcomes the above limitations.

### BRIEF SUMMARY OF INVENTION

Therefore, it is an object of the invention to provide vehicular seating suit arrangements and configurations that overcome the limitation of the known art. To achieve the foregoing and other objects and advantages, in one aspect, the present subject matter is directed to a vehicle seating arrangement including two or more structural units positioned along a longitudinal axis of a vehicle. Each structural unit may include a frame supported relative to the vehicle. Each structural unit may further include a lower seating suite generally facing a forward portion of the vehicle. The lower seating suit may be configurable between an upright seating position and a lie-flat seating position. Each structural unit may also include an upper seating suite generally facing an aft portion of the vehicle. The upper seating suit may be configurable between an upright seating position and a lie-flat seating position. Further, each of the lower seating suite and the upper seating suite of each structural unit may include an integrated seat pan and extension. Each integrated seat pan and extension may be positioned in the respective upper or lower seating suite and may optionally configure the respective upper or lower seating suite in either the upright seating position or the lie-flat seating position.

In at least one embodiment, each structural unit may further include two or more steps supported relative to the frame on an exterior surface of the lower seating suite for accessing the upper seating suite. In additional or alternative embodiments, each one of the structural units may be connected one to another in a row along an outboard wall of the vehicle. In additional or alternative embodiments, each one of the structural units may be connected one to another in a row along an inboard aisle of the vehicle. In additional or alternative embodiments, a first set of structural units may be connected one to another in a row along the outboard wall of the vehicle, and a second set of structural units may be connected one to another in row along an aisle of the vehicle. The aisle may be formed between the respective first set of structural units and the second set of structural units. In additional or alternative embodiments, the vehicle may be configured as an aircraft. In additional or alternative embodiments, the vehicle may be configured as an airplane. In additional or alternative embodiments, the vehicle may be configured as train.

In an additional or alternative aspect, the present subject matter is directed to a vehicle seating arrangement including two or more structural units positioned along a longitudinal axis of a vehicle. Each structural unit may include a frame supported relative to the vehicle. Each structural unit may further include a lower seating suite generally facing an aft portion of the vehicle. The lower seating suit may be configurable between an upright seating position and a lie-flat seating position. Each structural unit may also include an upper seating suite generally facing a forward portion of the vehicle. The upper seating suit may be configurable between an upright seating position and a lie-flat seating position. Further, each of the lower seating suit and the upper seating suit of each structural unit may include an integrated seat pan and extension. Each integrated seat pan and extension may be positioned in the respective upper or lower seating suite and may optionally configure the respective upper or lower seating suite in either the upright seating position or the lie-flat seating position.

In at least one embodiment, each structural unit may further include two or more steps supported relative to the frame on an exterior surface of the lower seating suite for accessing the upper seating suite. In additional or alternative embodiments, each one of the structural units may be connected one to another in a row along an outboard wall of the vehicle. In additional or alternative embodiments, each one of the structural units may be connected one to another in a row along an inboard aisle of the vehicle. In additional or alternative embodiments, a first set of structural units may be connected one to another in a row along the outboard wall of the vehicle, and a second set of structural units may be connected one to another in row along an aisle of the vehicle. The aisle may be formed between the respective first set of structural units and the second set of structural units. In additional or alternative embodiments, the vehicle may be configured as an aircraft. In additional or alternative embodiments, the vehicle may be configured as an airplane. In additional or alternative embodiments, the vehicle may be configured as train.

In an additional or alternative aspect, the present subject matter is directed to a vehicle seating arrangement including two or more structural units positioned within a vehicle. Each structural unit may include a frame supported relative to the vehicle. Each structural unit may further include a lower seating suite generally facing a first direction relative to the vehicle. The lower seating suit may be configurable between an upright seating position and a lie-flat seating position. Each structural unit may also include an upper seating suite generally facing a second direction relative to the vehicle. The second direction is substantially opposite to the first direction. The upper seating suit may be configurable between an upright seating position and a lie-flat seating position. Further, each of the lower seating suit and the upper seating suit of each structural unit may include an integrated seat pan and extension. Each integrated seat pan and extension may be positioned in the respective upper or lower seating suite and may optionally configure the respective upper or lower seating suite in either the upright seating position or the lie-flat seating position.

In at least one embodiment, each structural unit may further include two or more steps supported relative to the frame on an exterior surface of the lower seating suite for accessing the upper seating suite. In additional or alternative embodiments, the vehicle may be configured as an aircraft. In additional or alternative embodiments, the vehicle may be configured as an airplane. In additional or alternative embodiments, the vehicle may be configured as train.

Embodiments of the inventive concepts can include one or more or any combination of the above aspects, features, and configurations.

Additional features, aspects, and advantages of the invention will be set forth in the detailed description that follows, and in part will be readily apparent to those skilled in the art from that description or recognized by practicing the invention as described herein. It is to be understood that both the foregoing general description and the following detailed description present various embodiments of the invention, and are intended to provide an overview or framework for understanding the nature and character of the invention as it is claimed. The accompanying drawings are included to provide a further understanding of the invention, and are incorporated in and constitute a part of this specification.

### BRIEF DESCRIPTION OF THE DRAWING FIGURES

A full and enabling disclosure of the present invention, including the best mode thereof, directed to one of ordinary skill in the art, is set forth in the specification, which makes reference to companying drawings. Implementations of the inventive concepts disclosed herein may be better understood when consideration is given to the following detailed description thereof. Such description makes reference to the included drawings, which are not necessarily to scale, and in which some features may be exaggerated and some features may be omitted or may be represented schematically in the interest of clarity. In the drawings:

FIGS. 1-3 are various perspective views of vehicular seating suite configurations, according to example embodiments;

FIG. 4 is a top view of a plurality of vehicular seating suite configurations, according to an example embodiment;

FIG. 5 is a front elevation view of a vehicular seating suite configuration, according to an example embodiment;

FIG. 6 is a front view and a top view of a vehicular seating suite configuration, according to an example embodiment;

FIGS. 7-8 are side views of vehicular seating suite configurations, according to example embodiments;

FIG. 9 is a front view a vehicular seating suite configuration, according to an example embodiment;

FIGS. 10-12 are various diagrammatic views of vehicular seating suite configurations, according to example embodiments;

FIG. 13 includes multiple front views of a vehicular seating suite configuration, according to an example embodiment;

FIGS. 14-15 are side views of vehicular seating suite configurations, according to example embodiments;

FIGS. 16A and 16B are perspective views of a seating portion and a bed portion of a seating suite, according to an example embodiment;

FIG. 17 is a side elevation view of a vehicular seating suite configuration, according to an example embodiment;

FIGS. 18-23 are various perspective views of interiors of seating suites, according to example embodiments;

FIG. 24 is a top view of a seating suite including a passenger in a lie-flat position, according to an example embodiment;

FIGS. 25-28 are various perspective views of vehicular seating suite configurations, according to example embodiments;

FIG. 29 is a perspective view of a vehicular seating suite configuration, according to an example embodiment;

FIG. 30 is a perspective view of a vehicular seating suite configuration, according to an example embodiment;

FIG. 31 is a perspective view of a vehicular seating suite configuration, according to an example embodiment;

FIG. 32 is a perspective view of a vehicular seating suite configuration, according to an example embodiment;

FIG. 33 is a bottom view of a vehicular seating suite configuration, according to an example embodiment;

FIG. 34 is a front view of a vehicular seating suite configuration, according to an example embodiment;

FIG. 35 is a side view of a vehicular seating suite configuration, according to an example embodiment;

FIG. 36 is a back view of a vehicular seating suite configuration, according to an example embodiment;

FIG. 37 is an exterior side view of a vehicular seating suite configuration, according to an example embodiment;

FIG. 38 is a top view of a vehicular seating suite configuration, according to an example embodiment;

FIG. 39 is an outboard perspective view of a vehicular seating suite configuration, according to an example embodiment;

FIG. 40 is an inboard perspective view of a vehicular seating suite configuration, according to an example embodiment;

FIG. 41 is an inboard perspective view of a vehicular seating suite configuration, according to an example embodiment;

FIG. 42 is an outboard perspective view of a vehicular seating suite configuration, according to an example embodiment;

FIG. 43 is an inboard perspective view of a vehicular seating suite configuration, according to an example embodiment;

FIG. 44 is an inboard perspective view of a vehicular seating suite configuration, according to an example embodiment;

FIG. 45 is an outboard perspective view of a vehicular seating suite configuration, according to an example embodiment;

FIG. 46 is an inboard perspective view of a vehicular seating suite configuration, according to an example embodiment;

FIG. 47 is an inboard perspective view of a vehicular seating suite configuration, according to an example embodiment;

FIG. 48 is an outboard perspective view of a vehicular seating suite configuration, according to an example embodiment;

FIG. 49 is an outboard perspective view of a vehicular seating suite configuration, according to an example embodiment;

FIG. 50 is an inboard perspective view of a vehicular seating suite configuration, according to an example embodiment;

FIG. 51 is an inboard perspective view of a vehicular seating suite configuration, according to an example embodiment;

FIG. 52 is an outboard perspective view of a vehicular seating suite configuration, according to an example embodiment;

FIG. 53 is an outboard perspective view of a vehicular seating suite configuration, according to an example embodiment;

FIG. 54 is an inboard perspective view of a vehicular seating suite configuration, according to an example embodiment;

FIG. 55 is an inboard perspective view of a vehicular seating suite configuration, according to an example embodiment;

FIG. 56 is an inboard perspective view of a vehicular seating suite configuration, according to an example embodiment;

FIG. 57 is an inboard perspective view of a vehicular seating suite configuration, according to an example embodiment;

FIG. 58 is side view of a vehicular seating suite configuration, according to an example embodiment;

FIG. 59 is an inboard perspective view of a vehicular seating suite configuration, according to an example embodiment;

FIG. 60 is an inboard perspective view of a vehicular seating suite configuration, according to an example embodiment;

FIG. 61 is a perspective view of an interior of a seating suite, according to an example embodiment;

FIG. 62 is a perspective view of an interior of a seating suite, according to an example embodiment;

FIG. 63 is a perspective view of an interior of an upper seating suite and an associated tray table, according to an example embodiment;

FIG. 64 is a perspective view of an interior of an upper seating suite and an associated tray table, according to an example embodiment;

FIG. 65 is a perspective view of an interior of an upper seating suite and an associated tray table, according to an example embodiment;

FIG. 66 is a perspective view of an interior of a seating suite, according to an example embodiment;

FIG. 67 is a perspective view of an interior of a seating suite and an associated stowage compartment, according to an example embodiment;

FIG. 68 is a perspective view of an interior of a seating suite, according to an example embodiment;

FIG. 69 is a perspective view of an interior of a seating suite, according to an example embodiment;

FIG. 70 is an inboard perspective view of a vehicular seating suite configuration, according to an example embodiment;

FIG. 71 is an inboard perspective view of a vehicular seating suite configuration, according to an example embodiment;

FIG. 72 is top view of a vehicular seating suite configuration including a passenger in a lie-flat position, according to an example embodiment;

FIG. 73 is an inboard, elevated side view of a vehicular seating suite configuration including passengers, according to an example embodiment;

FIG. 74 is an inboard, elevated side view of a vehicular seating suite configuration including passengers, according to an example embodiment; and

FIG. 75 is an outboard perspective view of a vehicular seating suite configuration utilized in a train car, according to an example embodiment.

Like reference numerals in the drawings may represent and refer to the same, analogous, or similar elements, features, or functions.

### DETAILED DESCRIPTION

The inventive concepts are described hereinafter with reference to the accompanying drawings in which exemplary embodiments are shown. However, the inventive concepts may be embodied in many different forms and should not be construed as limited to the representative embodiments set forth herein. Each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. It is envisioned that other embodiments may perform similar functions and/or achieve similar results. Any and all such equivalent embodiments and examples are within the scope of the present invention and are intended to be covered by the appended claims.

The exemplary embodiments are provided so that this disclosure will be both thorough and complete, and will fully convey the scope of the invention and enable one of ordinary skill in the art to make, use, and practice the invention.

The terms “coupled,” “fixed,” “attached to,” and the like refer to both direct coupling, fixing, or attaching, as well as indirect coupling, fixing, or attaching through one or more intermediate components or features, unless otherwise specified herein.

The inventive concepts disclosed herein are generally directed to vehicle seating suite configurations for passenger vehicles. In an exemplary embodiment, the vehicular seating suite configuration including vertically stacked seating suites is provided to accommodate passengers both in a seating position and a lying position. For example, the vehicular seating suite configuration may include an upper seating suite and a lower seating suite within the vehicle. Each seating suite may include an elongated generally horizontal seating surface and a generally vertical backrest portion, where the combination of the elongated generally horizontal seating surface and the generally vertical backrest portion may be configured to accommodate a person in a seating position, while the elongated generally horizontal seating surface may be configured to accommodate a person in a lying position. For example, when a person or passenger of a vehicle desires to be in a sitting position, the person may rest his or her back against the generally vertical backrest portion while sitting on the elongated generally horizontal seating surface with or without her or his legs extending out on the elongated generally horizontal seating surface. When a person desires to move to a lying posture, the person may slide his or her head and back down the generally vertical backrest portion on the elongated generally horizontal seating surface until he or she is generally in a lying position on the elongated generally horizontal seating surface. In this manner, the vehicular seating suite configuration of the present disclosure can provide higher seating density than current seating options without the use of motorized seats.

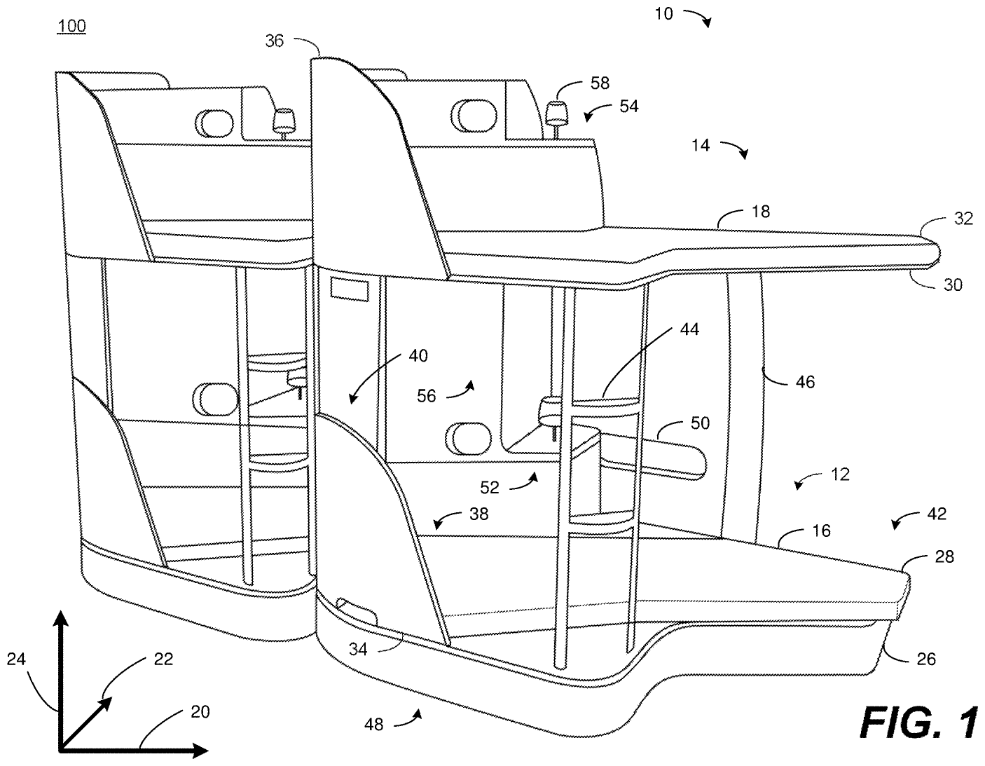

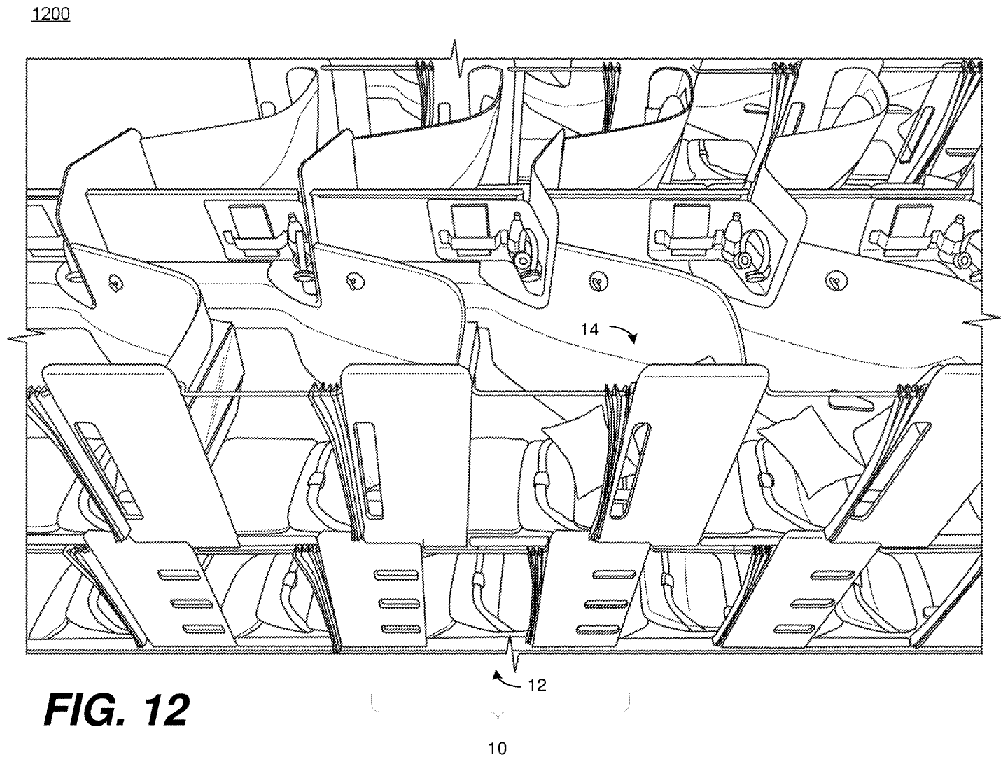

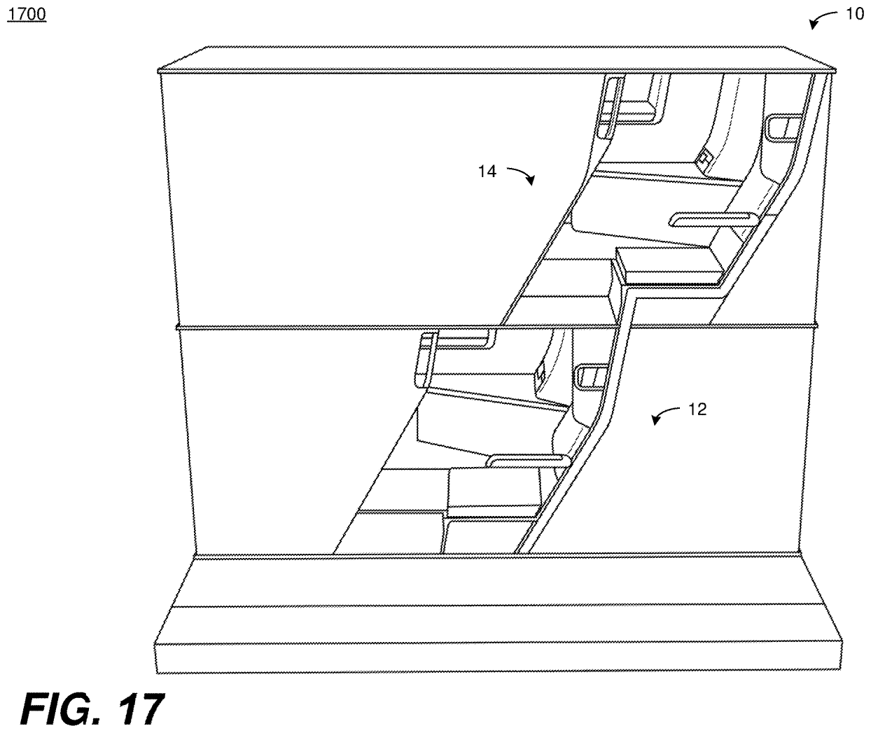

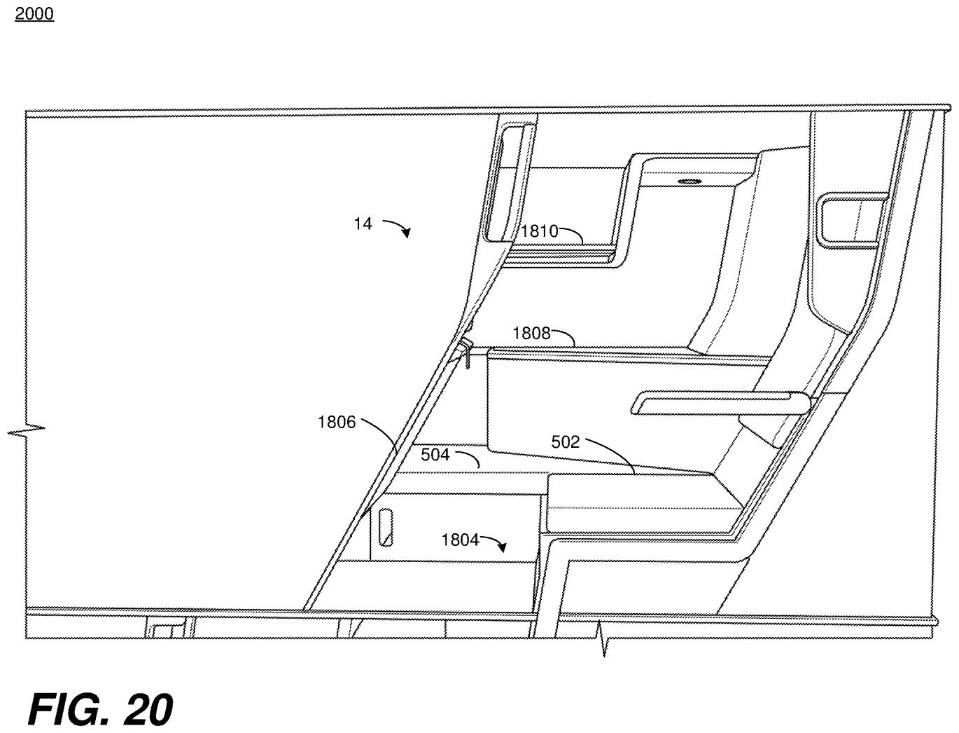

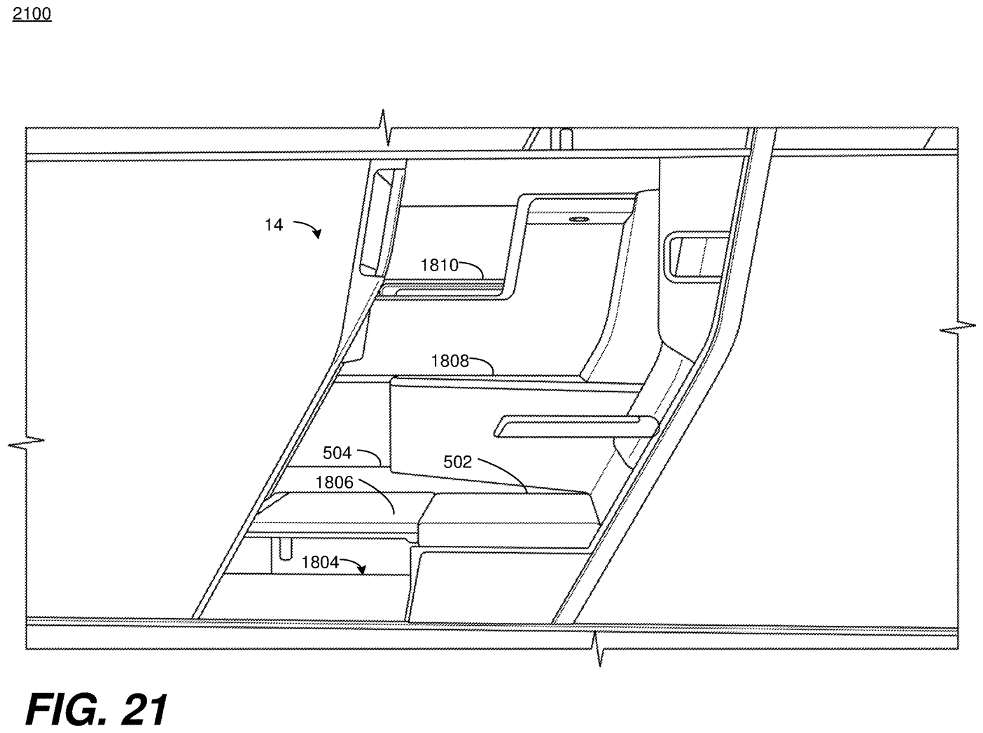

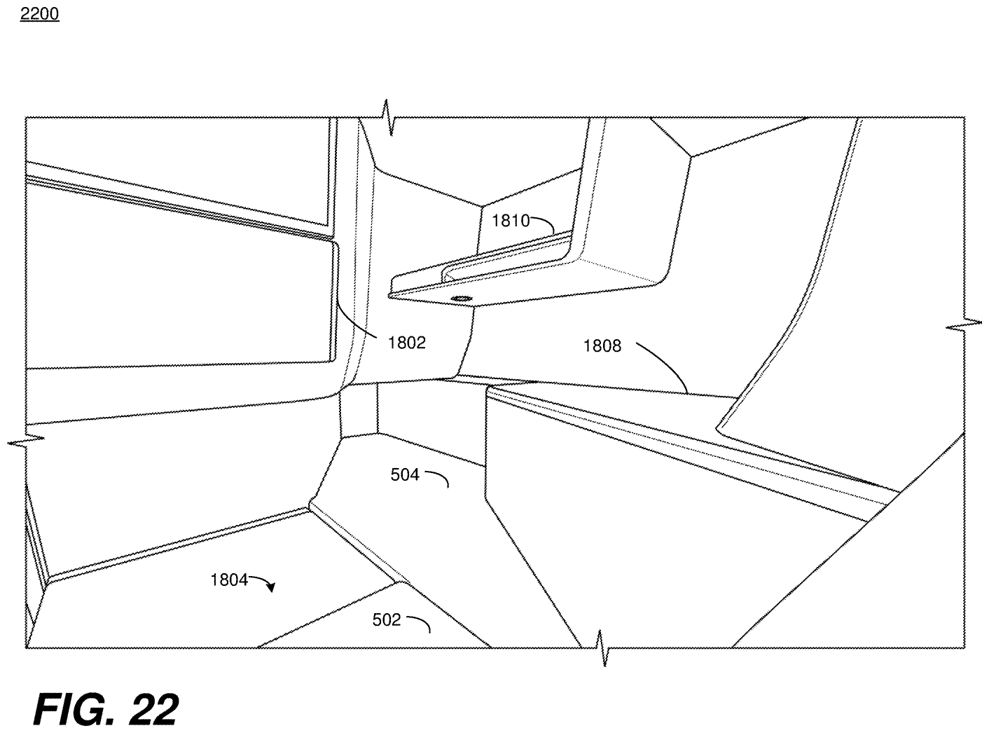

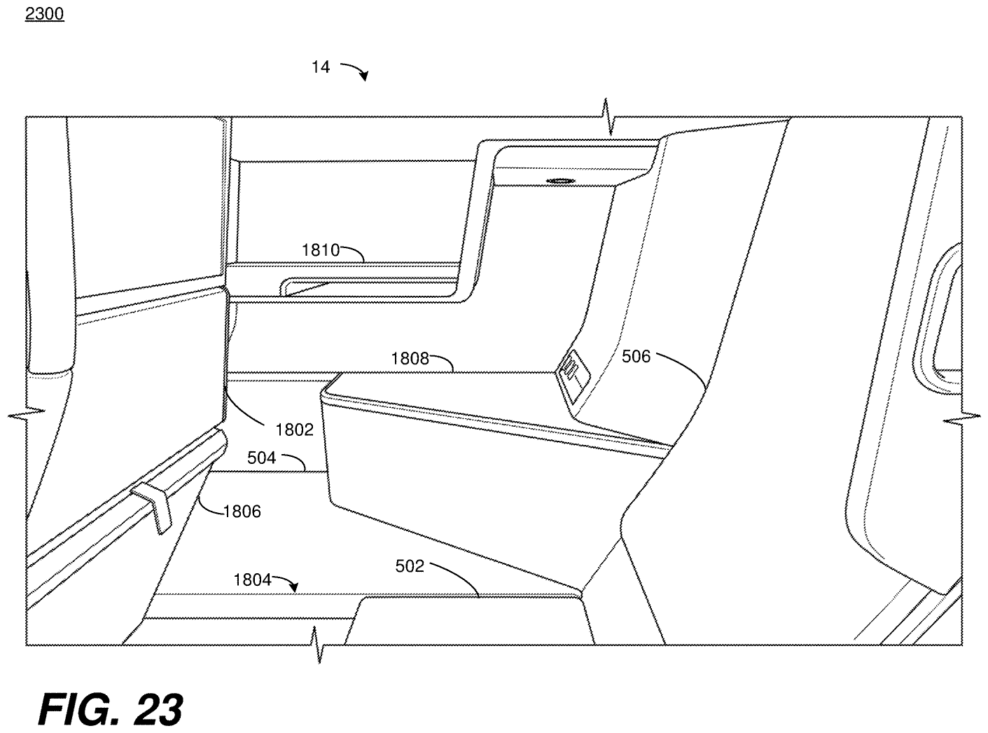

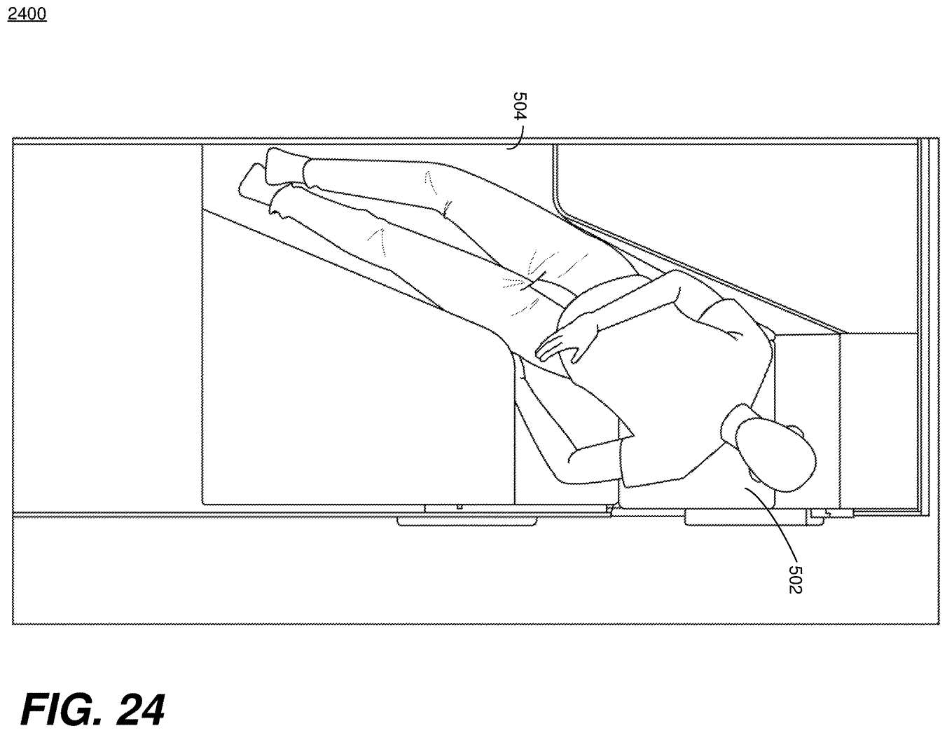

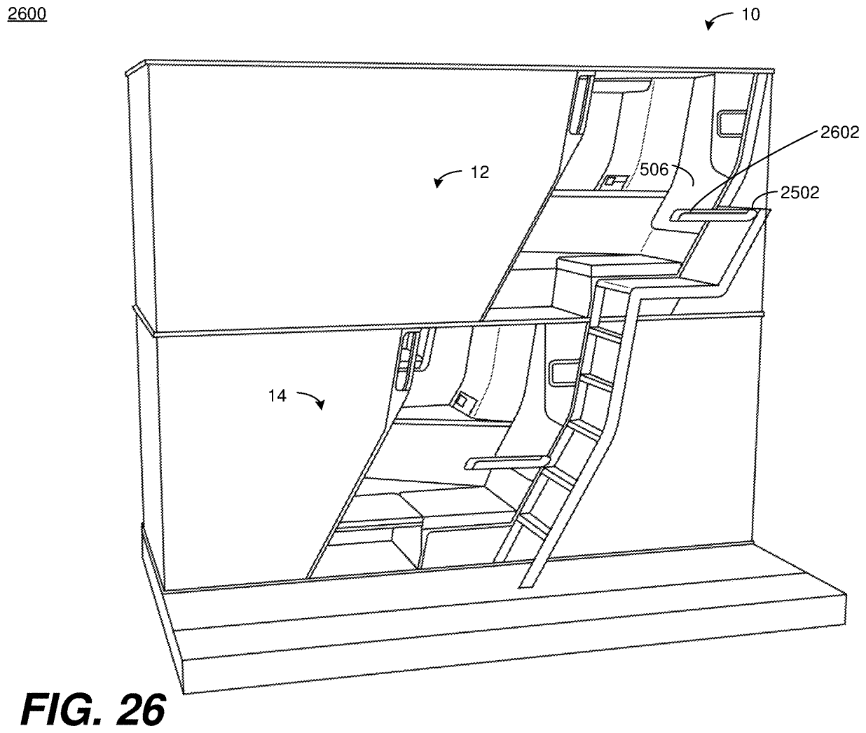

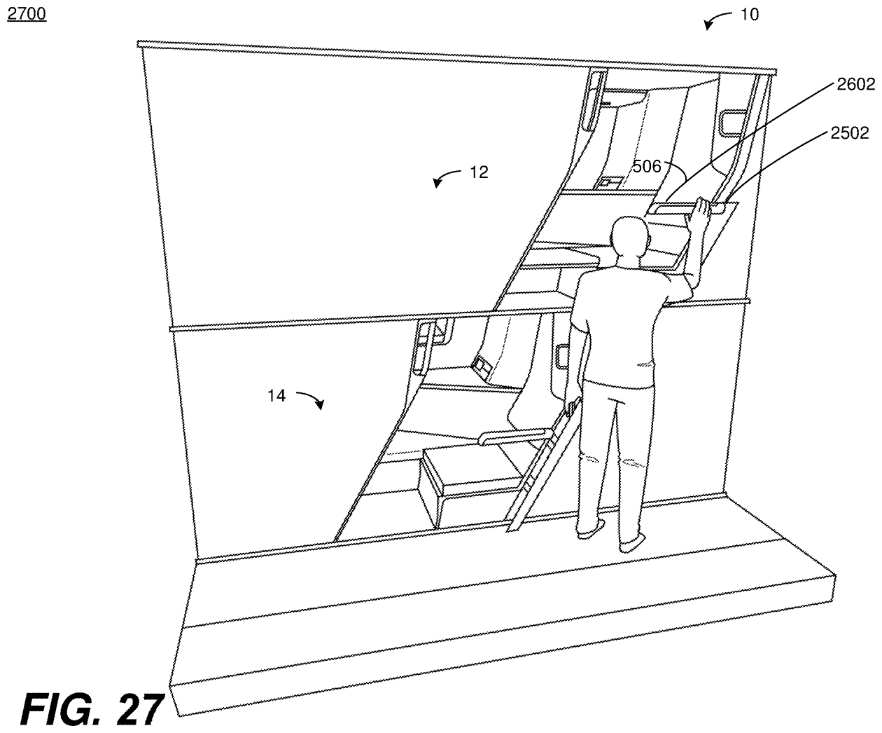

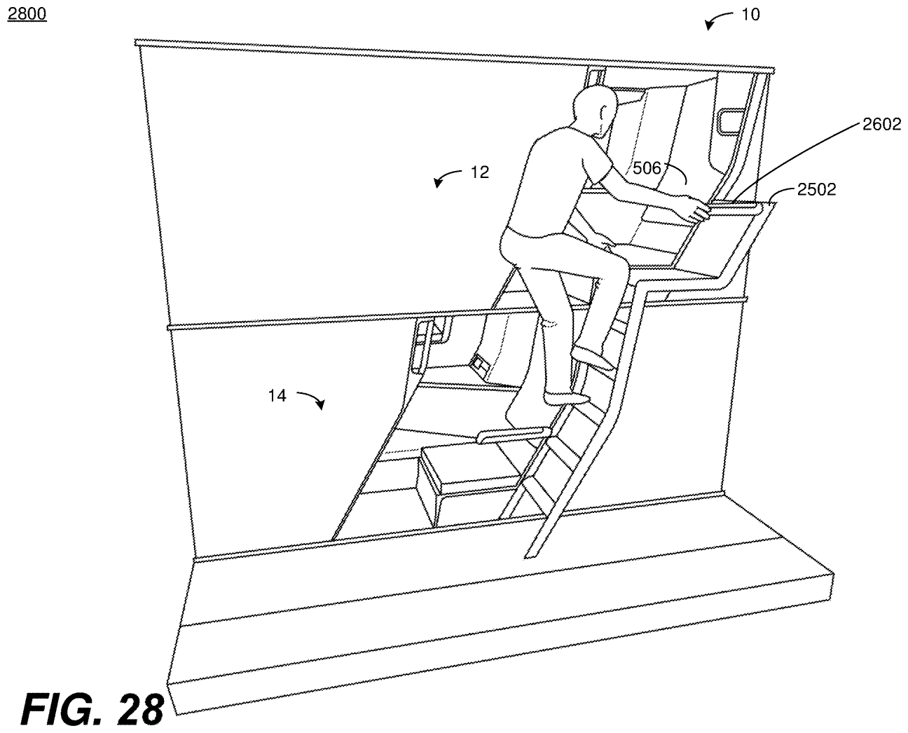

For example, and referring generally to FIGS. 1 through 28, exemplary embodiments of vehicular seating suite configurations (e.g., vehicular seating suite configuration 10) may each include a plurality of vertically stacked seating suites. In some embodiments, the vehicular seating suite configuration (e.g., vehicular seating suite configuration 10) may include a lower seating suite (e.g., lower seating suite 12) and an upper seating suite (e.g., upper seating suite 14). While reference is made throughout the figures and the detailed description to two vertically stacked seating suites, it will be appreciated that any number of seating suites may be stacked within the vehicular seating suite configuration of the present disclosure. For example, a vehicular seating suite configuration may include a lower seating suite and two or more upper seating suites.

In some embodiments, the vehicular seating suite configuration (e.g., vehicular seating suite configuration 10) may be configured to be positioned within a vehicle. In the example of FIG. 1, vehicular seating suite configuration (e.g., vehicular seating suite configuration 10) may be positioned within the fuselage of an aircraft, such as an airplane. However, it will be appreciated that embodiments of the vehicular seating suite configuration of the present disclosure may be adapted to and positioned within any vehicle, such as a boat, a train, a bus, a car, etc. In a preferred embodiment, the vehicular seating suite configuration (e.g., vehicular seating suite configuration 10) may be configured to be positioned within an aircraft and/or may be positioned within an airplane.

In some embodiments, each seating suite (e.g., lower seating suite 12 and upper seating suite 14) may include an elongated generally horizontal seating surface (e.g., elongated generally horizontal seating surface 16). Elongated, within the scope of the present disclosure, may generally include a length greater than a width, or long in proportion to width. For example, the elongated generally horizontal seating surface (e.g., elongated generally horizontal seating surface 16 of lower seating suite 12 and/or elongated generally horizontal seating surface 18 of upper seating suite 14) may have a length of, e.g., 78 inches and a width of, e.g., 30 inches. It will be appreciated that other lengths and widths may be used within the scope of the present disclosure while maintaining an elongated seating surface that is long in proportion to its width. In some embodiments, elongated generally horizontal seating surface 16 of lower seating suite 12 may be structurally the same as or different from elongated generally horizontal seating surface 18 of upper seating suite 14. For example, the dimensions of elongated generally horizontal seating surface 16 of lower seating suite 12 may be the same as or different from elongated generally horizontal seating surface 18 of upper seating suite 14. Generally horizontal, within the scope of the present disclosure, may include an orientation generally parallel to the longitudinal axis of the vehicle.

For example and as shown in FIG. 1, a coordinate system referencing a longitudinal axis (e.g., longitudinal axis 20), a lateral axis (e.g., lateral axis 22), and a vertical axis (e.g., vertical axis 24) is provided for reference. In some embodiments, the longitudinal axis (e.g., longitudinal axis 20) may generally describe the axis along the length of the vehicle from the front to the back along the direction of travel of the vehicle. The lateral axis (e.g., lateral axis 22) may generally describe the axis along the width of the vehicle from side to side. The vertical axis (e.g., vertical axis 24) may generally describe the axis along the height of the vehicle from bottom to top.

Accordingly, the elongated generally horizontal seating surface (e.g., elongated generally horizontal seating surface 16) may extend generally along the longitudinal axis (e.g., longitudinal axis 20) of the vehicle. It will be appreciated that the elongated generally horizontal seating surface (e.g., elongated generally horizontal seating surface 16) is not required to be exactly parallel with this reference plane defined by the longitudinal axis (e.g., longitudinal axis 20) and the lateral axis (e.g., lateral axis 22) of the vehicle. In this manner, embodiments of the elongated generally horizontal seating surface may have at least some vertical distance or gradient between its ends (e.g., sloping up from one end to another or sloping down from one end to another). As will be discussed in greater detail below, it will be appreciated that the vertical distance or pitch between the ends can be constrained by the lying position of a passenger. In other words, the amount of vertical distance between the ends of the elongated generally horizontal seating surface may be constrained to a gradient that would allow a passenger to lay on the elongated generally horizontal seating surface. It will also be appreciated that the elongated generally horizontal seating surface (e.g., elongated generally horizontal seating surface 16) may be at least partially rotated about the longitudinal axis (e.g., longitudinal axis 20).

In some embodiments, the elongated generally horizontal seating surface (e.g., elongated generally horizontal seating surface 16 and/or elongated generally horizontal seating surface 18) may be a unitary body or may include multiple adjacent bodies. For example and as will be discussed in greater detail below, the elongated generally horizontal seating surface may include a seating portion and a bed portion. In some embodiments, the elongated generally horizontal seating surface (e.g., elongated generally horizontal seating surface 16 and/or elongated generally horizontal seating surface 18) may include a rigid portion (e.g., rigid portion 26 for elongated generally horizontal seating surface 16 or rigid portion 30 for elongated generally horizontal seating surface 18) configured to support the weight of a passenger and a padded portion (e.g., padded portion 28 for elongated generally horizontal seating surface 16 or padded portion 32 for elongated generally horizontal seating surface 18) configured to cushion the passenger from the rigid portion. In some embodiments, the rigid portion 26 of lower seating suite 12 may include a platform to support elongated generally horizontal seating surface 16. The padded portion (e.g., padded portion 28 and/or padded portion 32) may include various fabrics, cushioning elements, etc. known in the art. In this manner, a passenger may lay down on the elongated horizontal seating surface (e.g., elongated generally horizontal seating surface 16 and/or elongated generally horizontal seating surface 18) comfortably.

In some embodiments, the elongated generally horizontal seating surface may be configured to accommodate a person in a lying position. As discussed above and in some embodiments, the length of the elongated horizontal seating surface (e.g., elongated generally horizontal seating surface 16 and/or elongated generally horizontal seating surface 18) may be such that a passenger can lay down with their head at one end and their feet adjacent to the opposite end. As will be discussed in greater detail below, embodiments of the present disclosure may allow a passenger to move from a sitting position on the elongated horizontal seating surface (e.g., elongated generally horizontal seating surface 16 and/or elongated generally horizontal seating surface 18) to a lying position on the horizontal seating surface (e.g., elongated generally horizontal seating surface 16 and/or elongated generally horizontal seating surface 18) during travel on a vehicle without the use of motorized components. However, in some embodiments, the elongated horizontal seating surface (e.g., elongated generally horizontal seating surface 16) may include motorized components for reclining or orienting.

In some embodiments, each seating suite (e.g., lower seating suite 12 and upper seating suite 14) may include a generally vertical backrest portion (e.g., generally vertical backrest portion 34 for lower seating suite 12 and/or generally vertical backrest portion 36 for upper seating suite 14) adjacent to a proximal end (e.g., proximal end 38) of the elongated generally horizontal seating surface (e.g., elongated generally horizontal seating surface 16). It will be appreciated that elongated generally horizontal seating surface 18 similarly has a proximal end. In some embodiments, generally vertical backrest portion (e.g., generally vertical backrest portion 34 for lower seating suite 12 and/or generally vertical backrest portion 36 for upper seating suite 14) may include an orientation generally parallel to the vertical axis (e.g., vertical axis 24) of the vehicle. In other words, the generally vertical backrest portion (e.g., generally vertical backrest portion 34 for lower seating suite 12 and/or generally vertical backrest portion 36 for upper seating suite 14) may generally extend along the vertical axis (e.g., vertical axis 24) of the vehicle. It will be appreciated that the generally vertical backrest portion (e.g., generally vertical backrest portion 34 for lower seating suite 12 and/or generally vertical backrest portion 36 for upper seating suite 14) may be angled relative to the proximal end (e.g., proximal end 38) of the elongated generally horizontal seating surface (e.g., elongated generally horizontal seating surface 16) to provide at least a partial recline. For example and in some embodiments, the generally vertical backrest portion (e.g., generally vertical backrest portion 34) may be perpendicular to the elongated generally horizontal seating surface (e.g., elongated generally horizontal seating surface 16). In some embodiments, the generally vertical backrest portion (e.g., generally vertical backrest portion 34) may be oriented relative to the elongated generally horizontal seating surface (e.g., elongated generally horizontal seating surface 16) to form an obtuse angle (e.g., an angle measured from the proximal end (e.g., proximal end 38) of the elongated generally horizontal seating surface (e.g., elongated generally horizontal seating surface 16) to a distal end (e.g., distal end 40) of the generally vertical backrest portion (e.g., generally vertical backrest portion 34)). Again, while reference is made in FIG. 1 to distal end 40 of generally vertical backrest portion 34, it will be appreciated that generally vertical backrest portion 36 similarly has a distal end. In this manner, the combination of the elongated generally horizontal seating surface and the generally vertical backrest portion may be configured to provide a reclined seat for a passenger. In some embodiments, the generally vertical backrest portion (e.g., generally vertical backrest portion 34) may include a rigid portion configured to support a passenger's back and a padded portion configured to cushion the passenger from the rigid portion. The padded portion may include various fabrics, cushioning elements, etc. known in the art. In this manner, a passenger may rest their back against the generally vertical backrest portion (e.g., generally vertical backrest portion 34) comfortably.

As discussed above and in some embodiments, the elongated generally horizontal seating surface and the generally vertical backrest portion may be configured to accommodate a person in a sitting position. For example, many vehicles have requirements for passengers to be secured in a sitting position during certain periods of travel. For example, as an aircraft is taxiing, taking off, or landing, regulations require each passenger to be in a sitting position. It will be appreciated that each passenger may be required to be in a sitting position (as opposed to standing in the vehicle or in a lying position) during other periods of travel. In this manner, a passenger may easily move from a lying position (e.g., with the passenger's head near proximal end 38 of elongated generally horizontal seating surface 16 and with the passenger's legs extending toward distal end 42 of elongated generally horizontal seating surface 16) to a sitting position (e.g., with the passenger's back against generally vertical backrest portion 34, the passenger's hips near proximal end 38 of elongated generally horizontal seating surface 16, and/or with the passenger's legs extending at least partially toward distal end 42 of elongated generally horizontal seating surface 16) and vice versa. While reference has been made to lower seating suite 12, it will be appreciated that the above discussion applies to upper seating suite 14.

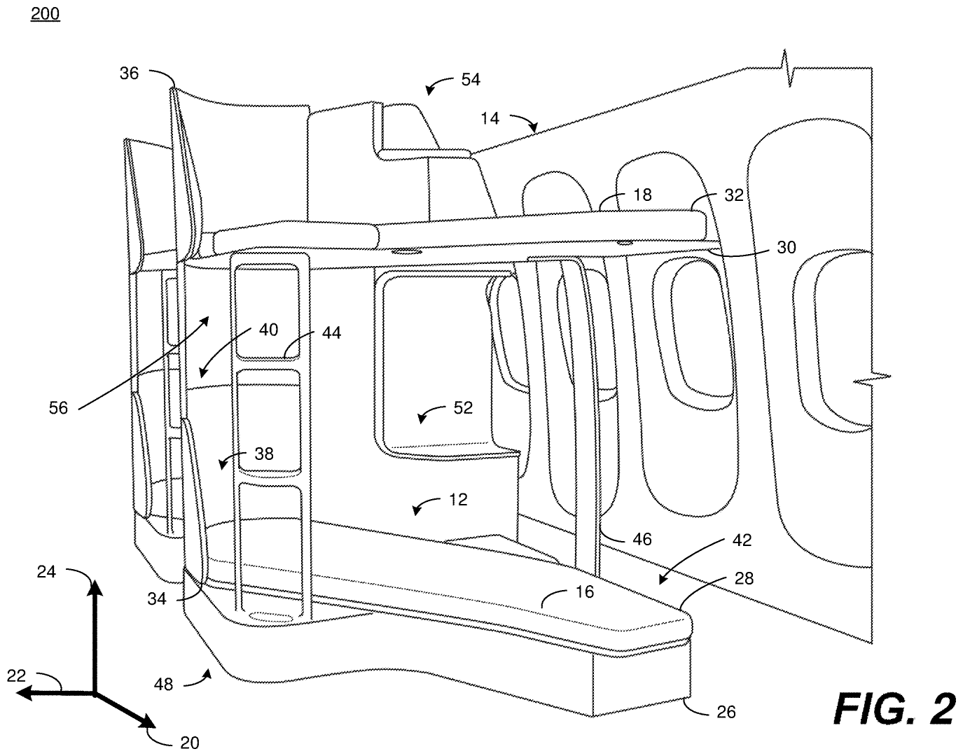

Referring also to FIG. 2 and in some embodiments, the elongated generally horizontal seating surface 16 may be angled away from the longitudinal axis 20 of the vehicle. Angled away may generally include any orientation extending along the longitudinal axis 20 of the vehicle but not in parallel with the longitudinal axis 20 of the vehicle. As shown in FIG. 2, elongated generally horizontal seating surface 16 may generally extend along longitudinal axis 20 of the vehicle (e.g., aircraft) but at an unparalleled angle relative to the longitudinal axis 20. In some embodiments, the elongated generally horizontal seating surface 16 may be oriented in any angle ranging from parallel to the longitudinal axis 20 of the vehicle to perpendicular to the longitudinal axis 20 of the vehicle. As will be discussed in greater detail below, angling away the elongated generally horizontal seating surface 16 may allow for higher seating density within a vehicle.

The generally vertical backrest portion 34 may be aligned with the longitudinal axis 20 of the vehicle. For example, when a passenger is sitting with their back resting against generally vertical backrest portion 34, a passenger may be oriented in parallel with longitudinal axis 20. However, in some embodiments, generally vertical backrest portion 34 may be oriented in the same direction as elongated generally horizontal seating surface 16. In some embodiments, generally vertical backrest portion 34 may be oriented in a different direction from elongated generally horizontal seating surface 16.

In some embodiments and referring again to FIG. 1, a ladder may be disposed between a lower seating suite and an upper seating suite. As discussed above, vehicular seating suite configuration 10 may include a lower seating suite (e.g., lower seating suite 12) and an upper seating suite (e.g., upper seating suite 14). In some embodiments, a ladder (e.g., ladder 44) may be disposed between a lower seating suite (e.g., lower seating suite 12) and an upper seating suite (e.g., upper seating suite 14). Ladder 44 may be disposed anywhere between lower seating suite 12 and upper seating suite 14. For example and in some embodiments, ladder 44 may be adjacent to proximal end 38 of elongated generally horizontal seating surface 16. In some embodiments, ladder 44 may be a rigid structure configured to accommodate the weight of a passenger. Ladder 44 may be formed from any metal, metal alloy, plastic, wood, synthetic materials, etc. known in the art. In some embodiments, a support structure or support structures (e.g., support structure 46) may be disposed between a lower seating suite (e.g., lower seating suite 12) and an upper seating suite (e.g., upper seating suite 14).

In some embodiments, vehicular seating suite configuration 10 may include at least one storage compartment disposed beneath at least a portion of a lower seating suite. For example, a storage compartment (e.g., storage compartment 48) may be disposed beneath the lower seating suite (e.g., lower seating suite 12). In some embodiments, a plurality of storage compartments (e.g., storage compartment 48) may be disposed beneath the lower seating suite (e.g., lower seating suite 12) to provide a storage compartment (e.g., for luggage or other personal belongings) for each passenger of each pair of stacked seating suites (e.g., lower seating suite 12 and upper seating suite 14).

In some embodiments, each seating suite may include a tray table disposed adjacent to the proximal end of the elongated generally horizontal seating surface. Referring also to FIG. 1 and in some embodiments, a seating suite (e.g., lower seating suite 12) may include a tray table (e.g., tray table 50) disposed adjacent to proximal end 38 of elongated generally horizontal seating surface 16. In some embodiments, tray table 50 may be rotatably coupled to a side console (e.g., side console 52 of lower seating suite 12 or side console 54 of upper seating suite 14) of the seating suite (e.g., lower seating suite 12 or upper seating suite 14) and configured to rotate across at least a portion of the elongated generally horizontal seating surface (e.g., elongated generally horizontal seating surface 16 or elongated generally horizontal seating surface 18). In this manner, a passenger may use tray table 50 while in a sitting position by rotating table tray 50 across their lap. In some embodiments, tray table 50 may fold out or extend out from the side console (e.g., side console 52 or side console 54).

As discussed above and in some embodiments, each seating suite may include a side console. In some embodiments, side console 52 may be incorporated into an enclosure or wall (e.g., wall 56) of the seating suite (e.g., lower seating suite 12). In some embodiments, side console 54 may include a lamp (e.g., lamp 58) or other lighting fixture(s).

In some embodiments, each seating suite may be at least partially enclosed. For example, each seating suite may include walls around at least part of the seating suite. In the examples of FIGS. 1-3, 5-7, and 17-28, a seating suite may include walls extending from behind or from the top of the generally vertical backrest portion around the back of the generally vertical backrest portion and at least partially around at least one side of the elongated generally horizontal seating surface. In the example of FIG. 2, where the lower seating suite is positioned along an interior wall of the vehicle, the wall (e.g., wall 56) may extend around the back of generally vertical backrest portion 34 and at least partially vertically between generally vertical backrest portion 34 and the bottom of upper seating suite 14. Further in this example, wall 56 may extend along one side of elongated generally horizontal seating surface 16 and may taper to form side console 52. In some embodiments, each seating suite may be almost entirely enclosed by wall 56 (e.g., other than a gap in wall 56 to allow for a passenger to access the seating suite). It will be appreciated that each seating suite may be at least partially enclosed in various configurations within the scope of the present disclosure. For example, a seating suite positioned against a wall of a vehicle may be less enclosed than a seating suite positioned within the middle of the vehicle.

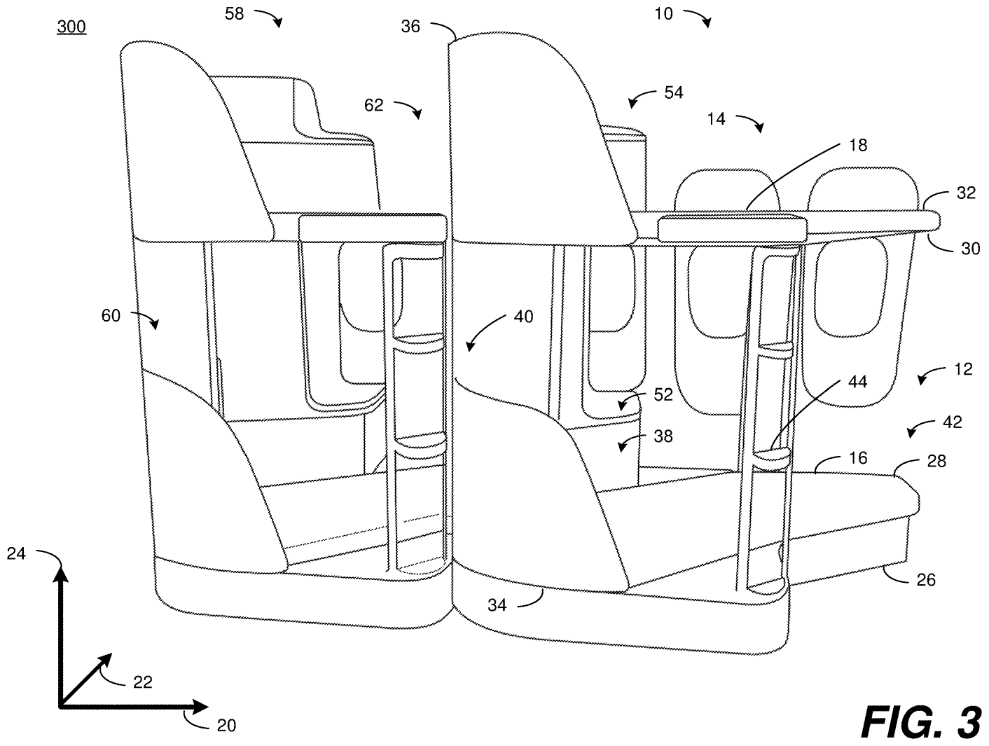

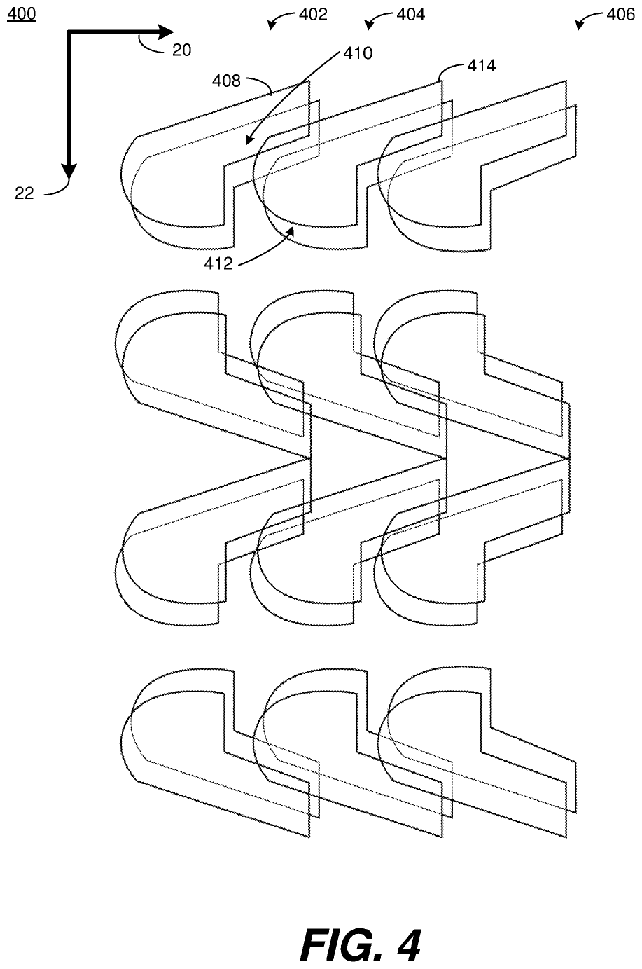

In some embodiments, each vehicular seating suite configuration may be configured to nest against at least one other vehicular seating suite configuration. In some embodiments and referring also to the example of FIG. 3, a first vehicular seating suite configuration (e.g., vehicular seating suite configuration 10) including a lower seating suite (e.g., lower seating suite 12) and an upper seating suite (e.g., upper seating suite 14) may be configured to nest against a second vehicular seating suite configuration (e.g., vehicular seating suite configuration 58) including a lower seating suite (e.g., lower seating suite 60) and an upper seating suite (e.g., upper seating suite 62). Referring also to the example of FIG. 4 and in some embodiments, a plurality of vehicular seating configurations (e.g., vehicular seating suite configurations 402, 404, 406) may be nested against one another.

As can be seen from FIG. 4, each seating suite may include at least one concave portion and at least one convex portion. In some embodiments, the at least one concave portion of each vehicular seating suite configuration may be configured to receive at least one convex portion of an adjacent vehicular seating suite configuration. For example, upper seating suite 408 of first vehicular seating configuration 402 may include concave portion 410 that may be configured to at least partially receive convex portion 412 of upper seating suite 414 of second vehicular seating configuration 404. This pattern may be duplicated for lower seating suites as to allow a plurality of vehicular seating suite configurations to nest together (e.g., lower seating suites nesting against lower seating suites and upper seating suites nesting against upper seating suites).

In some embodiments, the plurality of vehicular seating suite configurations may be positioned in a vehicle as shown in FIG. 4. In this example, the plurality of vehicular seating suite configurations may be oriented in a “reverse herringbone” pattern within the vehicle. In some embodiments, the reverse herringbone pattern may allow a higher seating density than conventional seating layouts. In a preferred embodiment, an aircraft fuselage may include at least one column of nested vehicular seating suite configurations against the edges of the fuselage and at least one central column of nested vehicular seating suite configurations along the longitudinal axis of the aircraft. However, it will be appreciated that various positions are possible within the scope of the present disclosure. Referring also to FIG. 2 and in some embodiments, the vehicular seating suite configuration (e.g., vehicular seating suite configuration 10) may be configured to be positioned against a curved wall of an aircraft fuselage. In this example, the upper seating suite (e.g., upper seating suite 14) may have curved walls and edges to contour to the curved wall of the aircraft fuselage. It will be appreciated that the upper and lower seating suites of a vehicular seating suite configuration may be contoured to fit various positions within a vehicle and for various other configurations of a vehicle, e.g., trains.

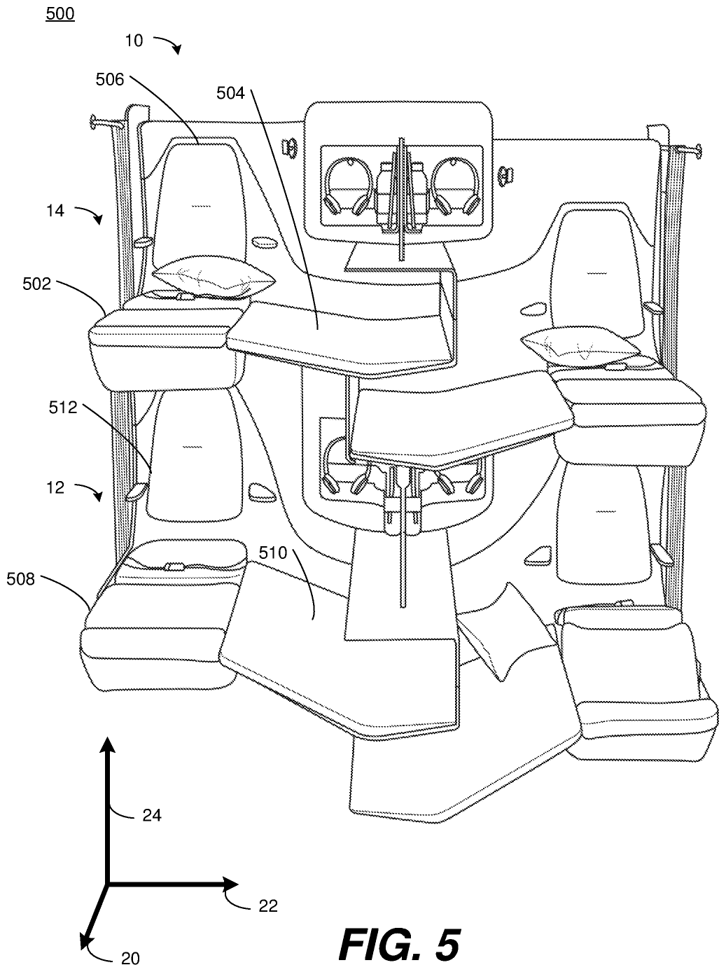

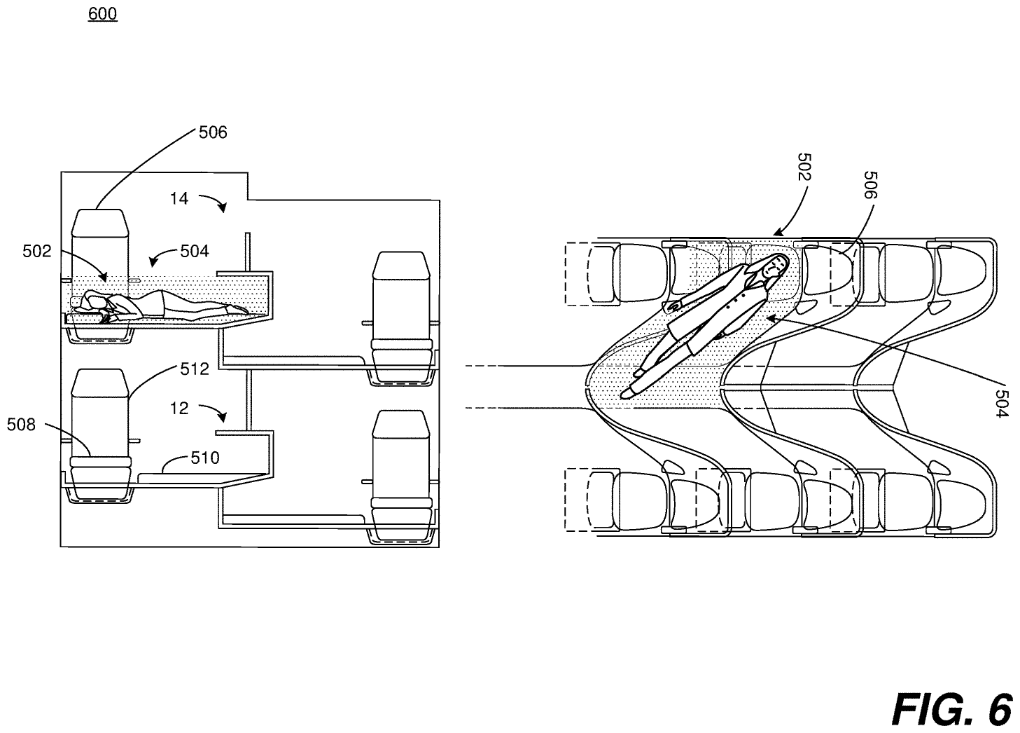

According to another implementation, a vehicular seating suite configuration may include a plurality of vertically stacked seating suites. Referring also to FIGS. 5-6 and in some embodiments, vehicular seating suite configuration 10 may include lower seating suite 12 and upper seating suite 14. As discussed above, while two seating suites are shown stacked vertically in vehicular seating suite configuration 10, it will be appreciated that any number of seating suites may be vertically stacked within the scope of the present disclosure. In some embodiments, each seating suite may include a generally horizontal seating portion and a generally horizontal bed portion adjacent to the generally horizontal seating portion. For example and as shown in FIG. 5, a seating suite (e.g., upper seating suite 14) may include generally horizontal seating portion 502 and generally horizontal bed portion 504 adjacent to generally horizontal seating portion 502. While reference has been made to upper seating suite 14 it will be appreciated that the features of upper seating suite 14 may be replicated in lower seating suite 12 and vice versa. For example, a seating suite (e.g., lower seating suite 12) may include generally horizontal seating portion 508 and generally horizontal bed portion 510 adjacent to generally horizontal seating portion 508.

In some embodiments, generally horizontal seating portion 502 may include a rigid portion configured to support the weight of a passenger and a padded portion configured to cushion the passenger from the rigid portion. The padded portion may include various fabrics, cushioning elements, etc. known in the art.

In some embodiments and as shown in the example of FIG. 6, the generally horizontal bed portion in combination with the generally horizontal seating portion may be configured to accommodate a person in a lying position. As discussed above and in some embodiments, the length of the generally horizontal seating portion (e.g., generally horizontal seating portion 502) and the generally horizontal bed portion (e.g., generally horizontal bed portion 504) may be such that a passenger can lay down with their head on the generally horizontal seating portion (e.g., generally horizontal seating portion 502) with the rest of their body on the generally horizontal bed portion (e.g., generally horizontal bed portion 504). As will be discussed in greater detail below, embodiments of the present disclosure may allow a passenger to move from a sitting position in the generally horizontal seating portion (e.g., generally horizontal seating portion 502) to a lying position on the combination of the generally horizontal seating portion (e.g., generally horizontal seating portion 502) and the generally horizontal bed portion (e.g., generally horizontal bed portion 504) during travel on a vehicle without the use of motorized components. However, in some embodiments, the generally horizontal seating portion (e.g., generally horizontal seating portion 502) and/or the generally horizontal bed portion (e.g., generally horizontal bed portion 504) may include motorized components for reclining or orienting.

In some embodiments, the generally horizontal seating portion may be aligned with a longitudinal axis of a vehicle, and the generally horizontal bed portion may be angled away from the longitudinal axis of the vehicle. For example and referring also to the example of FIG. 5, generally horizontal seating portion 502 may be aligned or in parallel with longitudinal axis 20 of a vehicle and generally horizontal bed portion 504 may be angled away from longitudinal axis 20. As discussed above, angled away may generally include any angle not parallel, e.g., unparalleled, to the longitudinal axis 20. In some embodiments, the angled orientation of generally horizontal bed portion 504 may allow a higher seating density of seating suites. While examples have been provided of a generally horizontal seating portion aligned with the longitudinal axis 20 of the vehicle, it will be appreciated that the generally horizontal seating portion may be oriented in any direction within the vehicle. In some embodiments, regardless of the orientation of the generally horizontal seating portion relative to the longitudinal axis 20 of the vehicle, the generally horizontal bed portion may be angled away relative to the direction of the generally horizontal seating portion.

In some embodiments, each seating suite may include a generally vertical backrest portion disposed adjacent to a proximal end of the generally horizontal seating portion. For example and referring again to FIG. 5, a seating suite (e.g., upper seating suite 14) may include a generally vertical backrest portion (e.g., generally vertical backrest portion 506) disposed adjacent to proximal end of generally horizontal seating portion 502. Lower seating suite 12 may include a generally vertical backrest portion (e.g., generally vertical backrest portion 512) disposed adjacent to proximal end of generally horizontal seating portion 508. As discussed above, generally vertical backrest portion 512 may be stationary and/or configured to recline. In some embodiments, generally vertical backrest portion 512 may not include any motorized components. However, it will be appreciated that in some embodiments, generally vertical backrest portion 512 may include motorized components.

As discussed above and in some embodiments, the generally horizontal seating portion and the generally vertical backrest portion may be configured to accommodate a person in a sitting position. For example, many vehicles have requirements for each passenger to be secured in a sitting position during certain periods of travel. For example, as an aircraft is taxiing, taking off, or landing, regulations require each passenger to be in a sitting position. It will be appreciated that each passenger may be required to be in a sitting position (as opposed to standing in the vehicle or in a lying position) during other periods of travel. In this manner and referring again to FIG. 6, a passenger may easily move from a lying position (e.g., with the passenger's head on the generally horizontal seating portion 502 with the passenger's body extending toward distal end of generally horizontal bed portion 504) to a sitting position (e.g., with the passenger's back against generally vertical backrest portion 506 and with the passenger's hips on the generally horizontal seating portion 502) and vice versa.

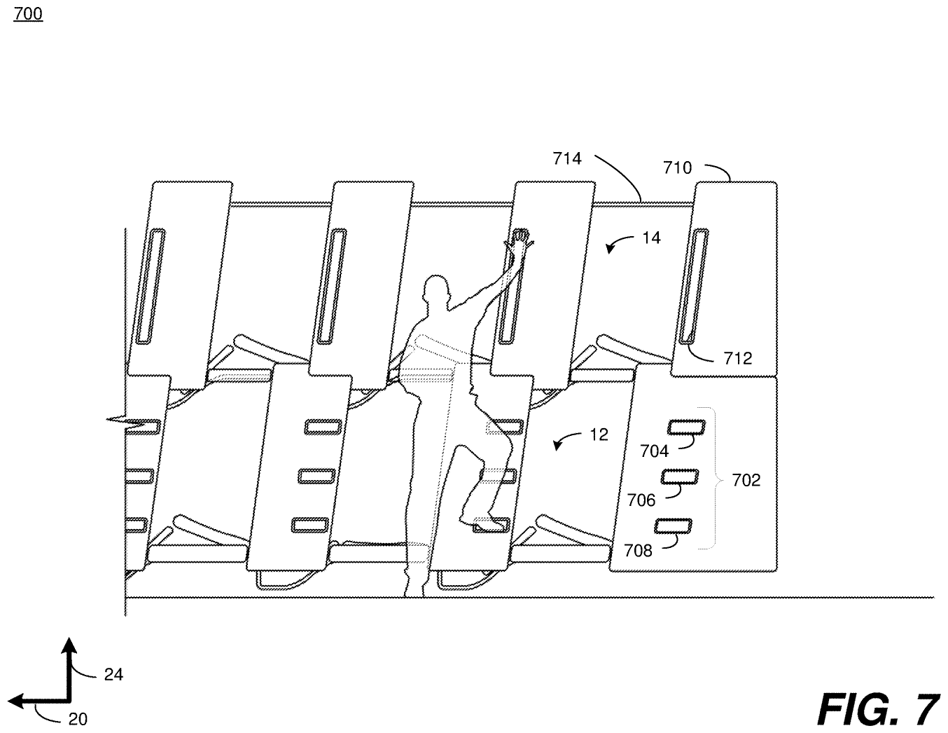

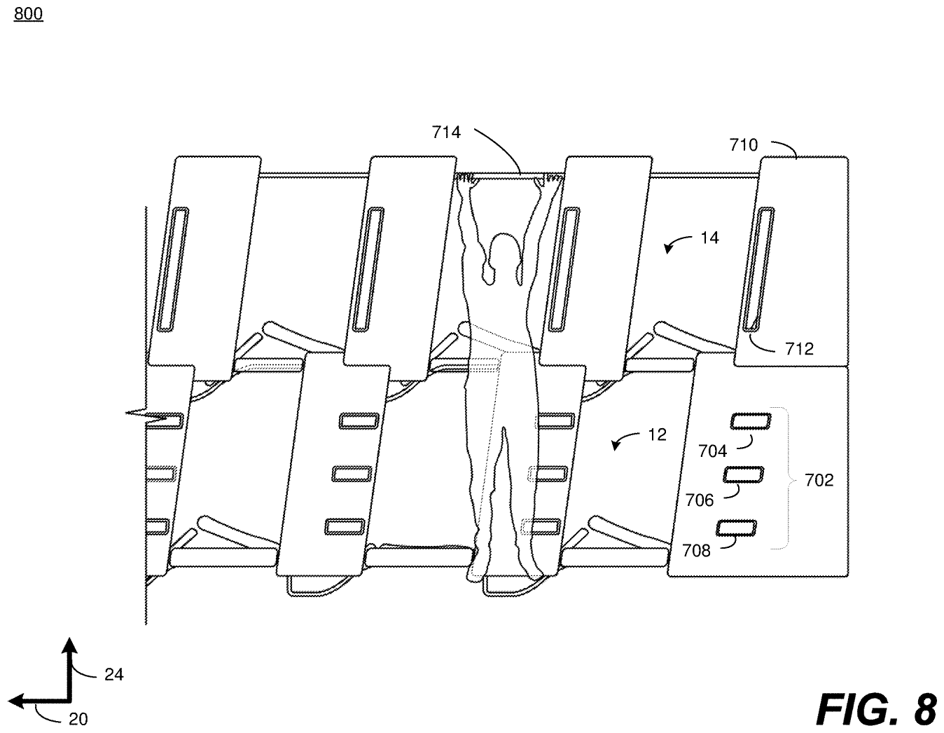

As discussed above, a ladder may be disposed between a lower seating suite and an upper seating suite. In some embodiments, ladder 44 may be disposed anywhere between lower seating suite 12 and upper seating suite 14. In some embodiments and referring also to FIG. 7, ladder 702 may be incorporated into an enclosure around at least part of each seating suite. Ladder 702 may be defined by a plurality of openings or apertures (e.g., apertures 704, 706, 708) within an enclosure (e.g., enclosure 710) of one or more of lower seating suite 12 and upper seating suite 14. In some embodiments, the plurality of openings or apertures (e.g., apertures 704, 706, 708) that define ladder 702 may be reinforced with metal or other high strength material. In some embodiments, each of the plurality of openings or apertures (e.g., apertures 704, 706, 708) may have smoothed edges to facilitate insertion and removal of hands and/or feet when using ladder 702. In some embodiments, one or more seating suites may include one or more handrails (e.g., handrail 712) to provide safe access to and from upper seating suite 14. In some embodiments, seating suites may include a rail (e.g., rail 714) that may be used to assist a passenger in an exiting or emergency scenario. For example and as shown in FIG. 8, a passenger can use rail 714 to lower himself or herself from upper seating suite 14. By sitting with the passenger's legs over the edge and reaching up to the rail, the passenger can easily lower herself or himself to the vehicle floor.

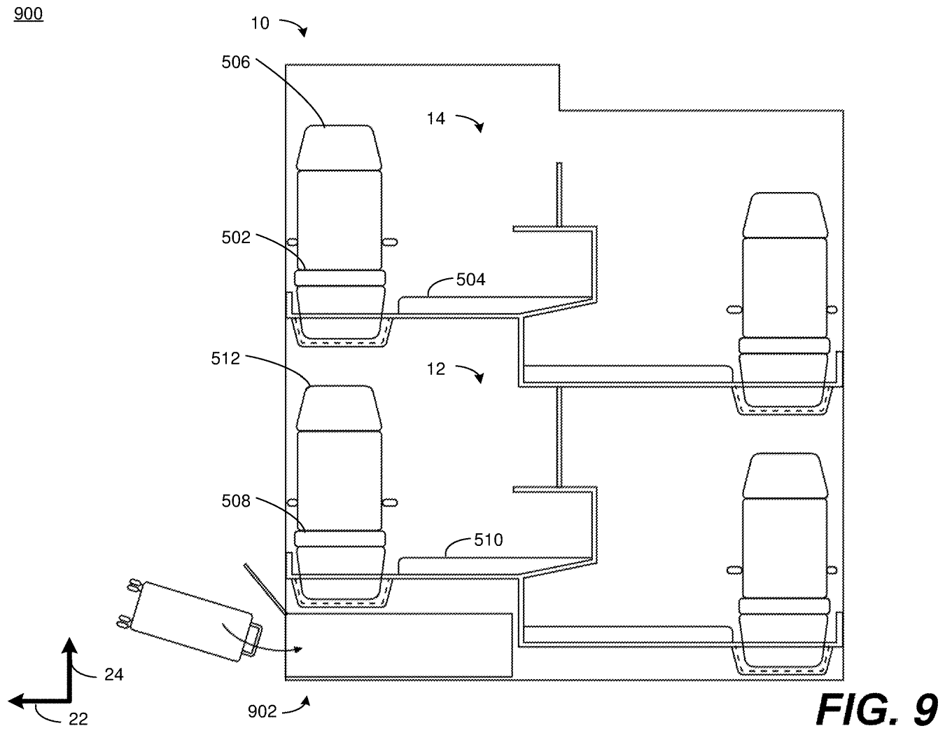

In some embodiments, vehicular seating suite configuration 10 may include at least one storage compartment disposed beneath at least a portion of a lower seating suite. For example and referring also to FIG. 9, a storage compartment (e.g., storage compartment 902) may be disposed beneath the lower seating suite (e.g., lower seating suite 12). In some embodiments, a plurality of storage compartments (e.g., storage compartment 902) may be disposed beneath the lower seating suite (e.g., lower seating suite 12) to provide a storage compartment (e.g., for luggage or other personal belongings) for each passenger of each pair of stacked seating suites (e.g., lower seating suite 12 and upper seating suite 14).

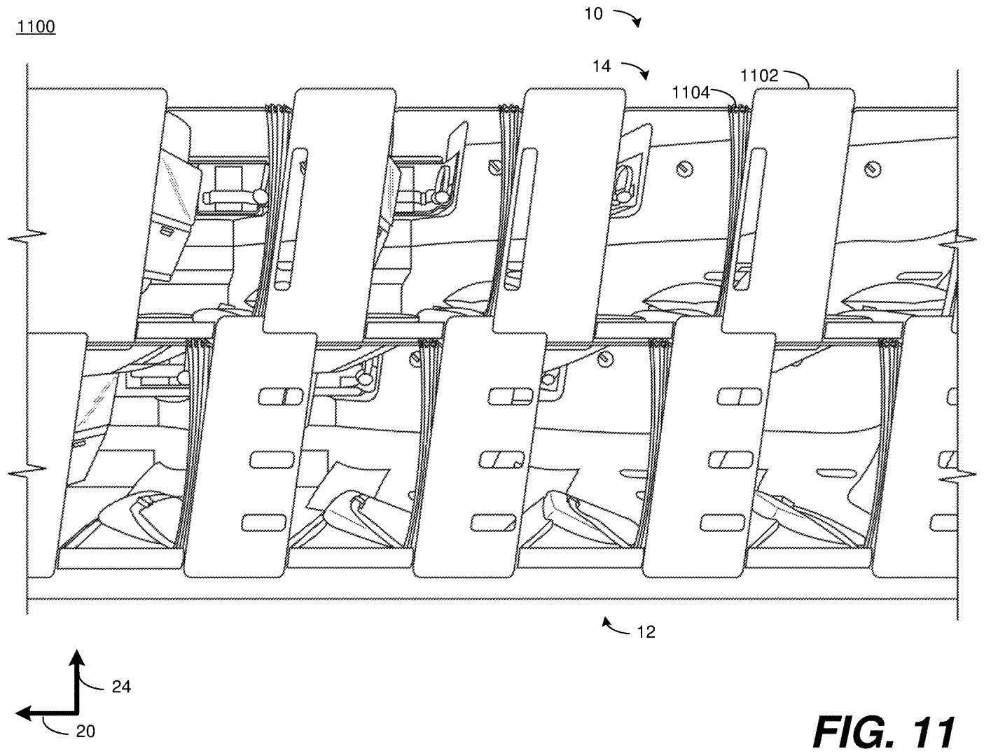

In some embodiments, as shown particularly with respect to FIG. 11, each seating suite may be at least partially enclosed. For example and as discussed above, each seating suite may be almost entirely enclosed by wall 1102 (e.g., other than a gap in wall 1102 to allow for a passenger to access the seating suite). In some embodiments, the gap in wall 1102 may include a curtain (e.g., curtain 1104) to provide a passenger privacy in their seating suite (e.g., seating suite 14).

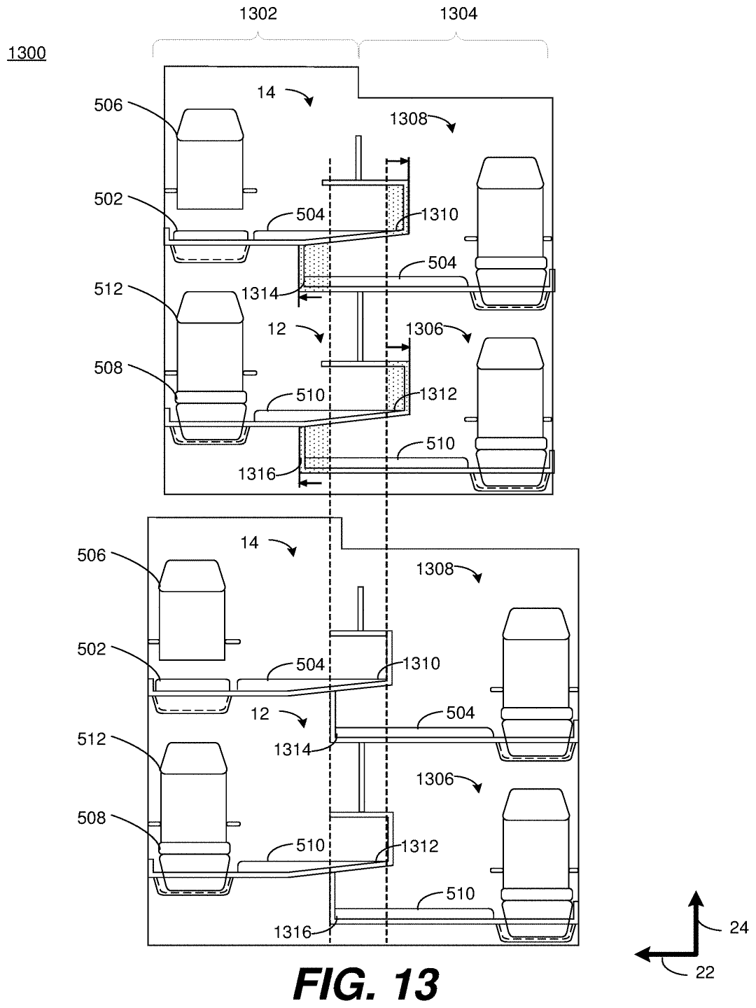

In some embodiments, a distal end of at least one generally horizontal bed portion of the plurality of seating suites of a first vehicular seating suite configuration may be configured to at least partially overlap a distal end of at least one adjacent generally horizontal bed portion of a plurality of seating suites of a second vehicular seating suite configuration. Referring also to the examples of FIG. 13, a first vehicular seating suite configuration (e.g., first vehicular seating suite configuration 1302) may include a lower seating suite (e.g., lower seating suite 12) and an upper seating suite (e.g., upper seating suite 14) and a second vehicular seating suite configuration (e.g., second vehicular seating suite configuration 1304) may include a lower seating suite (e.g., lower seating suite 1306) and an upper seating suite (e.g., upper seating suite 1308). In this example, first vehicular seating suite configuration 1302 may be laterally adjacent to and nested against second vehicular seating suite configuration 1304. In some embodiments, the distal end (e.g., distal end 1310 and e.g., distal end 1312) of at least one generally horizontal bed portion (e.g., generally horizontal bed portion 504 and generally horizontal bed portion 510) of a plurality of seating suites (e.g., upper seating suite 14 and lower seating suite 12) of a first vehicular seating suite configuration (e.g., first vehicular seating suite configuration 1302) may at least partially overlap the distal end (e.g., distal end 1314 and e.g., distal end 1316) of at least one generally horizontal bed portion (e.g., generally horizontal bed portion 504 and generally horizontal bed portion 510) of a plurality of seating suites (e.g., upper seating suite 1308 and lower seating suite 1306) of a second vehicular seating suite configuration (e.g., second vehicular seating suite 1304). In some embodiments, first vehicular seating suite configuration 1302 may be laterally adjacent to and nested against second vehicular seating suite configuration 1304 in a column within the vehicle. In a preferred embodiment, first vehicular seating suite configuration 1302 may be laterally adjacent to and nested against second vehicular seating suite configuration 1304 in a center column within an aircraft fuselage.

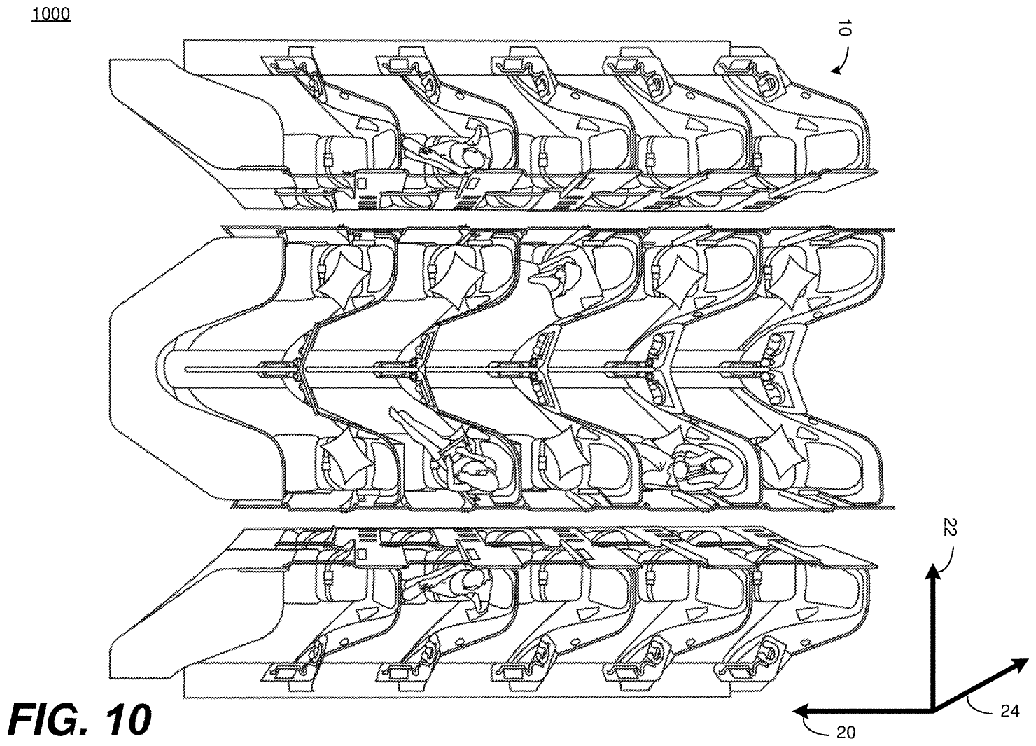

Referring also to the example of FIG. 10 and in some embodiments, the first vehicular seating suite configuration 1302 and the second vehicular seating suite configuration 1304 may be manufactured with different widths to accommodate a range of vehicle types. For example, the overlap between vehicular seating suite configurations may be increased or decreased in order to fit on various vehicle types (e.g., aircraft types). The upper portion of FIG. 10 may include a narrower variant while the lower portion of FIG. 10 may include a wider variant.

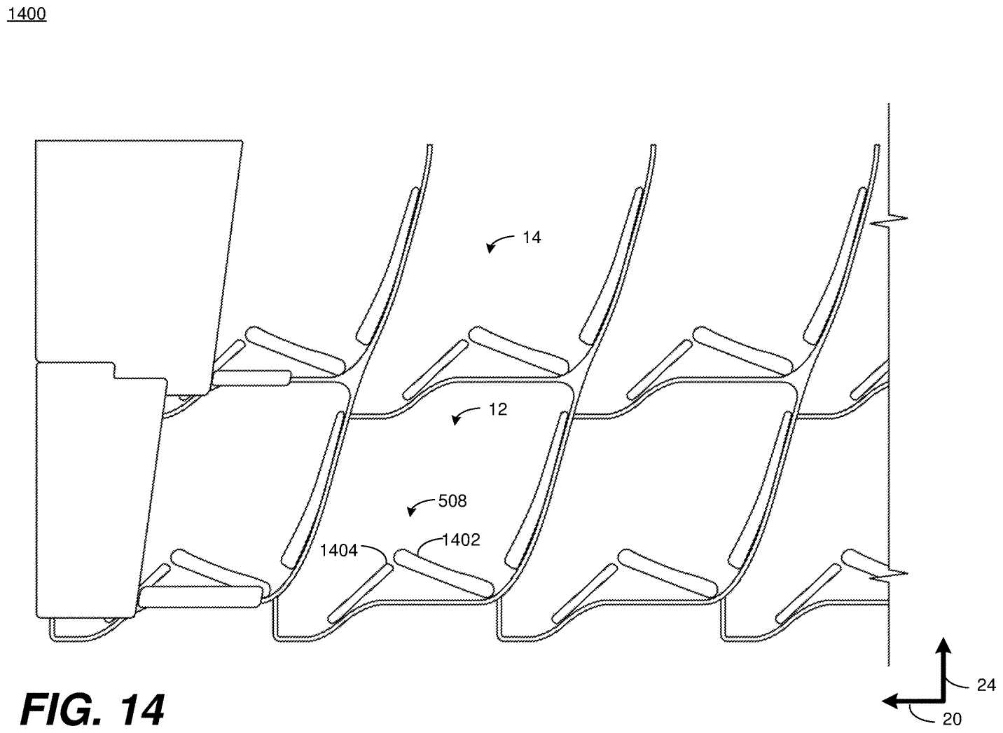

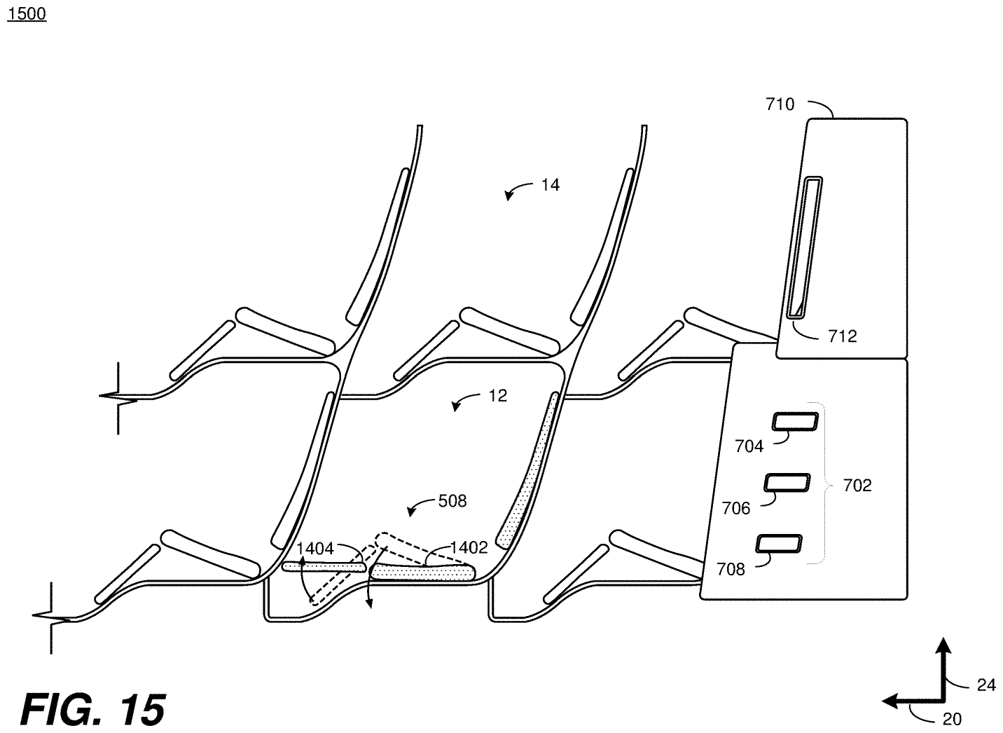

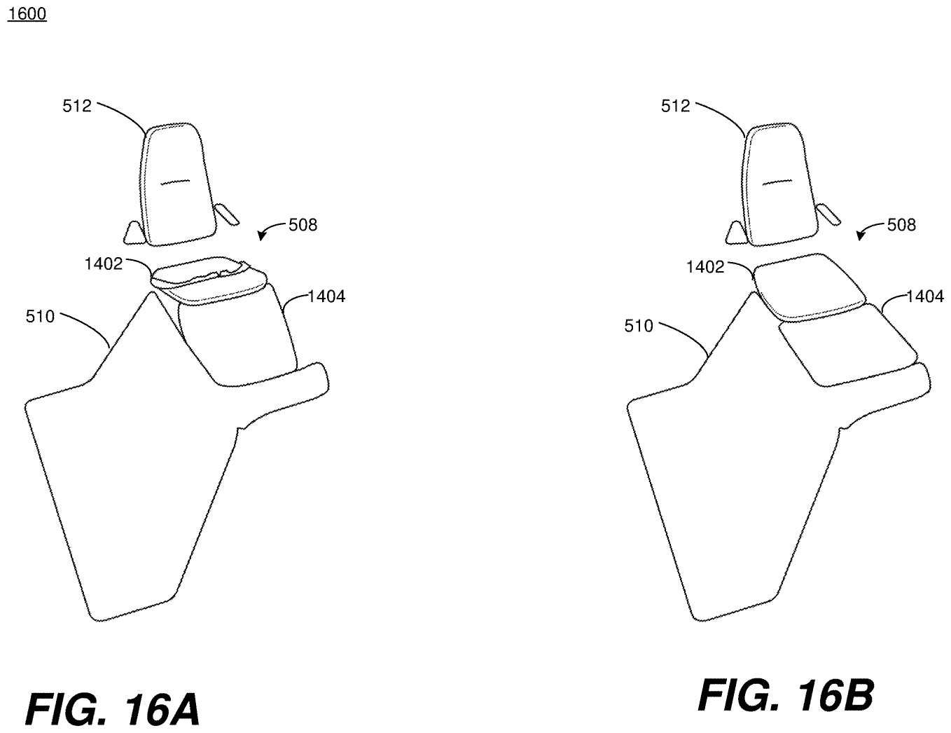

In some embodiments, the generally horizontal seating portion may include a seat pan and a leg rest coupled to the seat pan. For example and referring also to FIGS. 14-15, generally horizontal seating portion 508 may include seat pan 1402 and leg rest 1404 coupled to seat pan 1402. In some embodiments, seat pan 1402 may be moved together or separately to adjust the generally horizontal seating portion. As shown in FIG. 15 and in some embodiments, seat pan 1402 may be configured to rotate vertically to form an inclined seating surface. In some embodiments, leg rest 1404 may be rotatably coupled to seat pan 1402. In some embodiments, the seat pan and the leg rest may be configured to provide a continuous surface across the seat pan, the leg rest, and the generally horizontal bed portion. For example and as shown in FIG. 16A, seat pan 1402 and leg rest 1404 may be configured in a seating configuration. In some embodiments and as shown in FIG. 16B, seat pan 1402 and leg rest 1404 may be configured in a bed configuration. In some embodiments, both the seat pan 1402 and leg rest 1404 may be moved to close out a footwell. In this manner, seat pan 1402 and leg rest 1404 may be configured to provide a continuous surface across seat pan 1402, leg rest 1404, and generally horizontal bed portion 510.

Referring again to the example of FIG. 11 and in some embodiments, an upper seating suite may be horizontally offset from the lower seating suite along the longitudinal axis 20 of the vehicle. In this example, upper seating suite 14 may be horizontally offset or staggered from lower seating suite 12 along longitudinal axis 20 of the vehicle. Optionally, as shown, the footwell of upper seating suite 14 extends down into the space of lower seating suite 12 without reducing the headroom of passenger in lower seating suite 12.

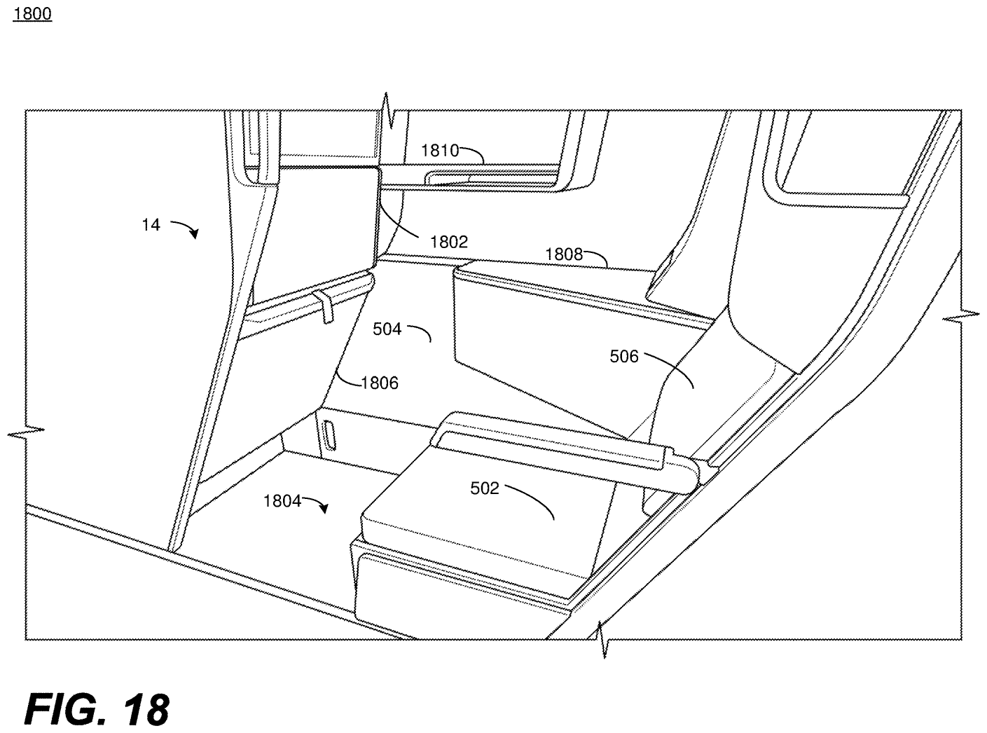

In some embodiments, a seating suite may include a tray table disposed adjacent to the generally horizontal seating portion. For example and as shown in FIG. 18, seating suite 14 may include tray table 1802 incorporated into the wall of seating suite 14. In some embodiments, tray table 1802 may be a bi-fold tray table. However, it will be appreciated that various configurations for the tray table are possible within the scope of the present disclosure.

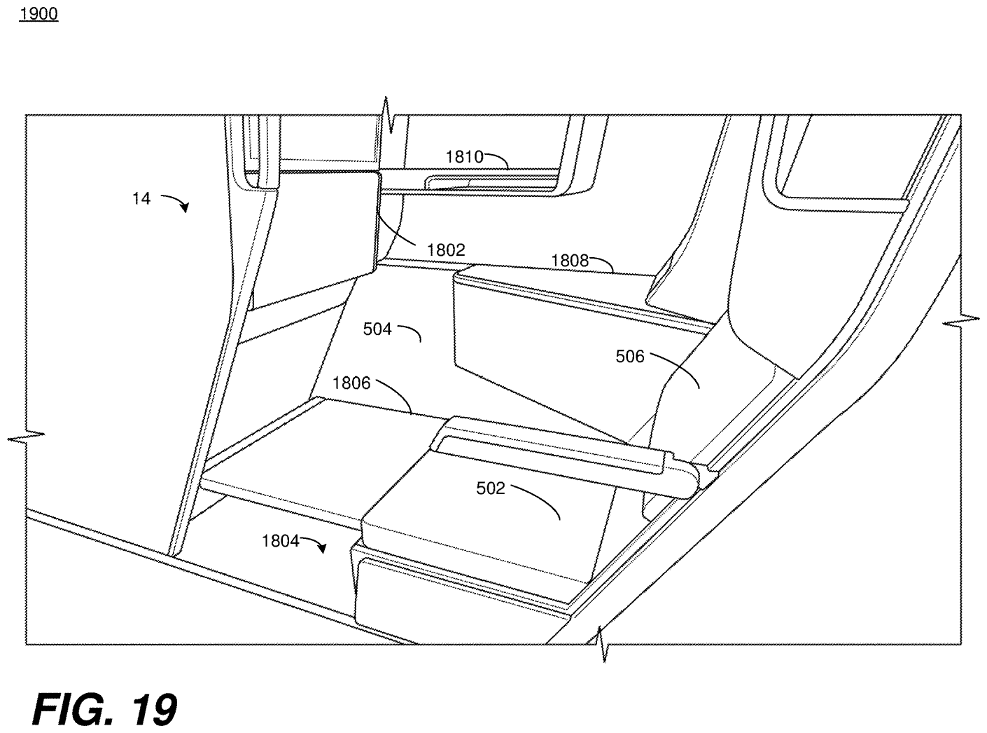

As indicated above and in some embodiments, each seating suite may include a footwell adjacent to the generally horizontal seating portion and a removable footwell cover adjacent to the footwell. Referring to the examples of FIGS. 18-19, the seating suite (e.g., the seating suite 14) may include footwell 1804 adjacent to generally horizontal seating portion 502 and removable footwell cover 1806 adjacent to footwell 1804. In some embodiments, the removable footwell cover (e.g., removable footwell cover 1806) may be configured to provide a continuous surface from the generally horizontal seating portion (e.g., generally horizontal seating portion 502) and the generally horizontal bed portion (e.g., generally horizontal bed portion 504) and across the footwell (e.g., footwell 1804).

As discussed above and in some embodiments, each seating suite may include a side console. In some embodiments, side console 1808 may be incorporated into an enclosure or wall of the seating suite (e.g., upper seating suite 14). In some embodiments, side console 1808 may include one or more lighting fixture(s). As shown in exemplary FIGS. 18-23, seating suite 14 may include one or more storage compartments (e.g., storage compartment 1810) within the seating suite.

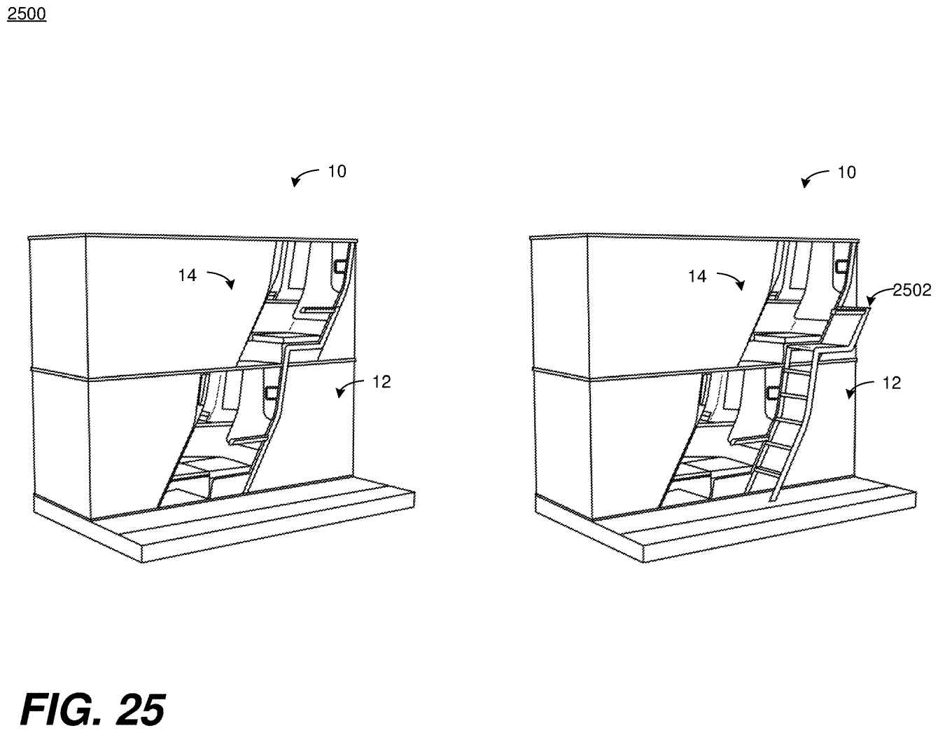

In some embodiments, the vehicular seating suite configuration may also include a telescopic ladder integrated into a lower seating suite and configured to provide access to an upper seating suite. Referring also to the example of FIGS. 25-28 and in some embodiments, telescopic ladder 2502 may be integrated into lower seating suite 12 and may be configured to retract into and telescope or extend out of lower seating suite 12. In this manner, ladder 2502 may provide access from the floor of a vehicle to upper seating suite 14. In some embodiments, telescopic ladder 2502 may be accessed by pulling on a handle or tab attached to telescopic ladder 2502. In some embodiments, ladder 2502 may automatically extend from and retract into lower seating suite 12 in response to selection of a push button or electronic user interface affixed to lower seating suite 12. In this manner, telescopic ladder 2502 may be accessed with little to no physical force by the passenger. While FIGS. 25-28 show telescopic ladder 2502 with five rungs, it will be appreciated that telescopic ladder 2502 may include any number of rungs or features for a passenger to hold or step on when using telescopic ladder 2502.

In some embodiments, the telescopic ladder may include a support mechanism that provides an armrest adjacent to the generally vertical backrest portion of the upper seating suite when the telescopic ladder is retracted into the lower seating suite. For example, support mechanism (e.g., support mechanism 2602) may provide an armrest adjacent to generally vertical backrest portion 506 when telescopic ladder 2502 is retracted into lower seating suite 12 (e.g., when a passenger is occupying upper seating suite 14). When telescopic ladder 2502 is extended out from lower seating suite 12 (e.g., when a passenger is using telescopic ladder 2502 to access upper seating suite 14), support mechanism 2602 may provide a handle or other graspable feature to help stabilize a passenger when using telescopic ladder 2502.

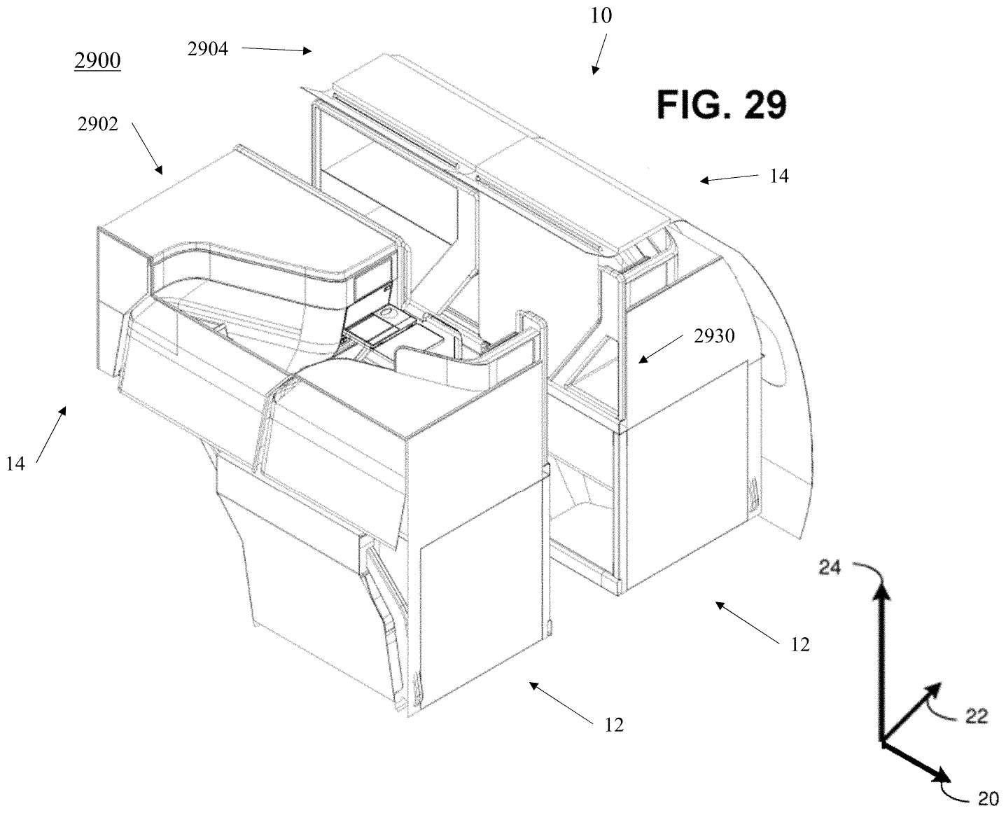

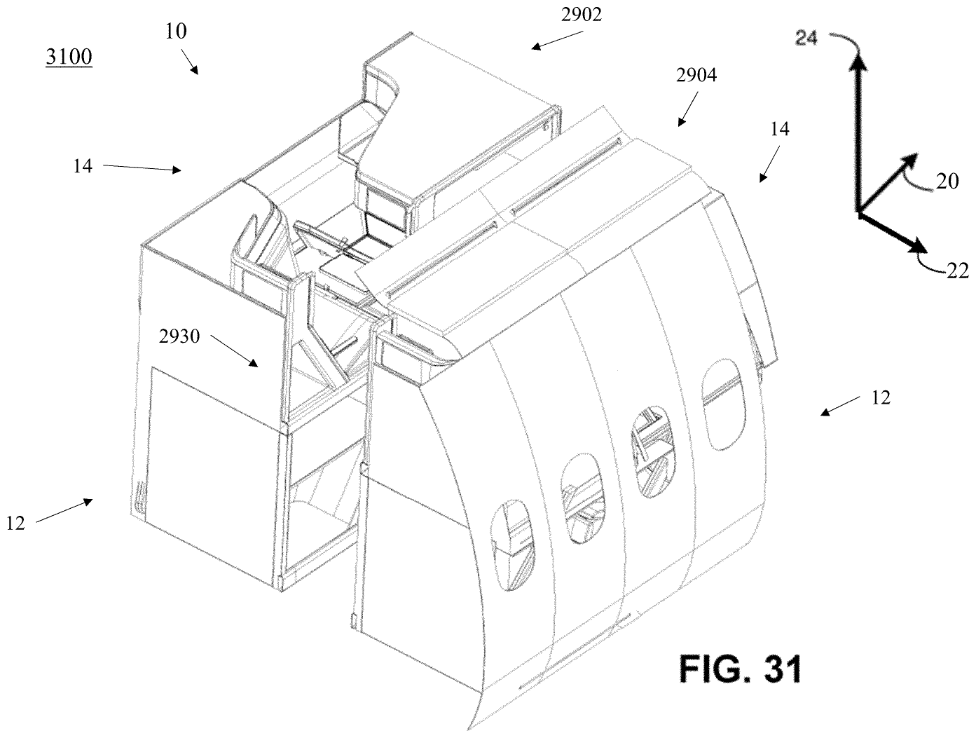

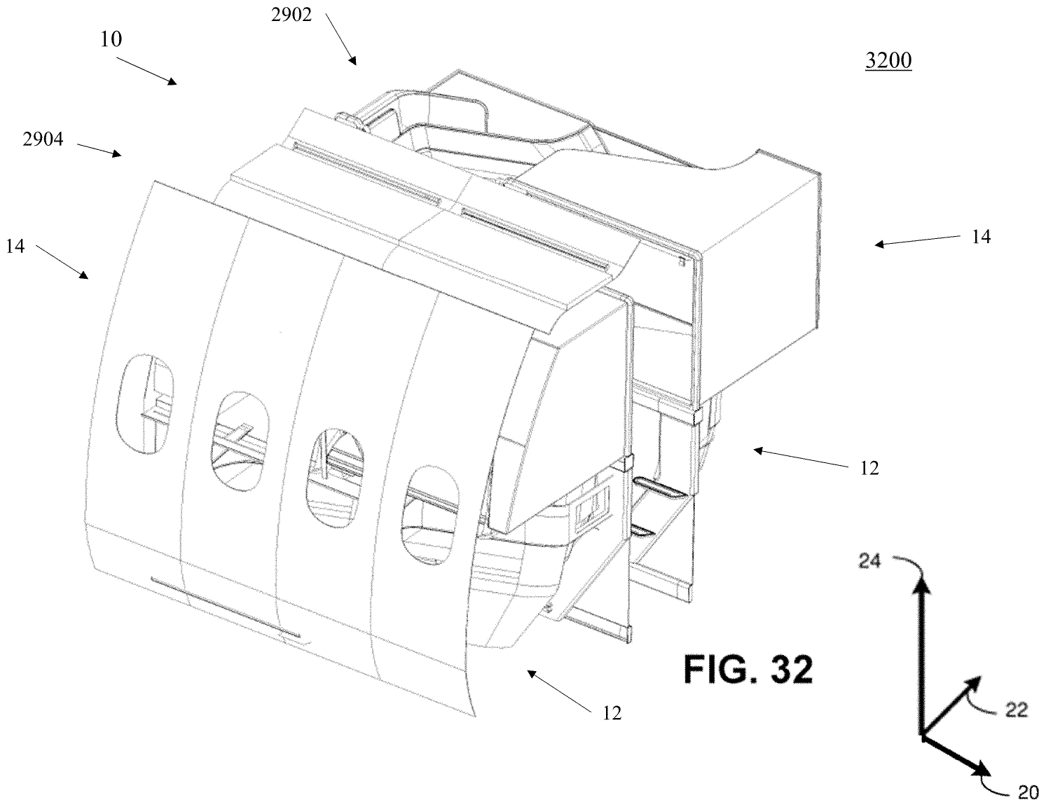

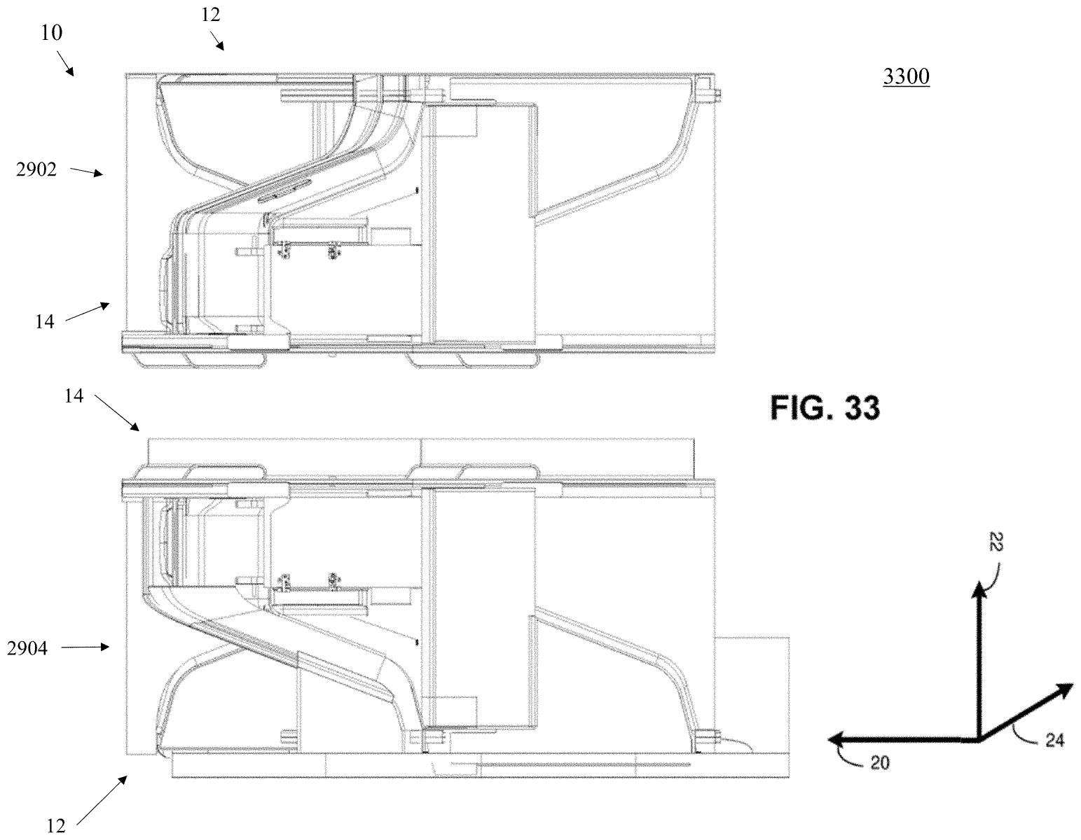

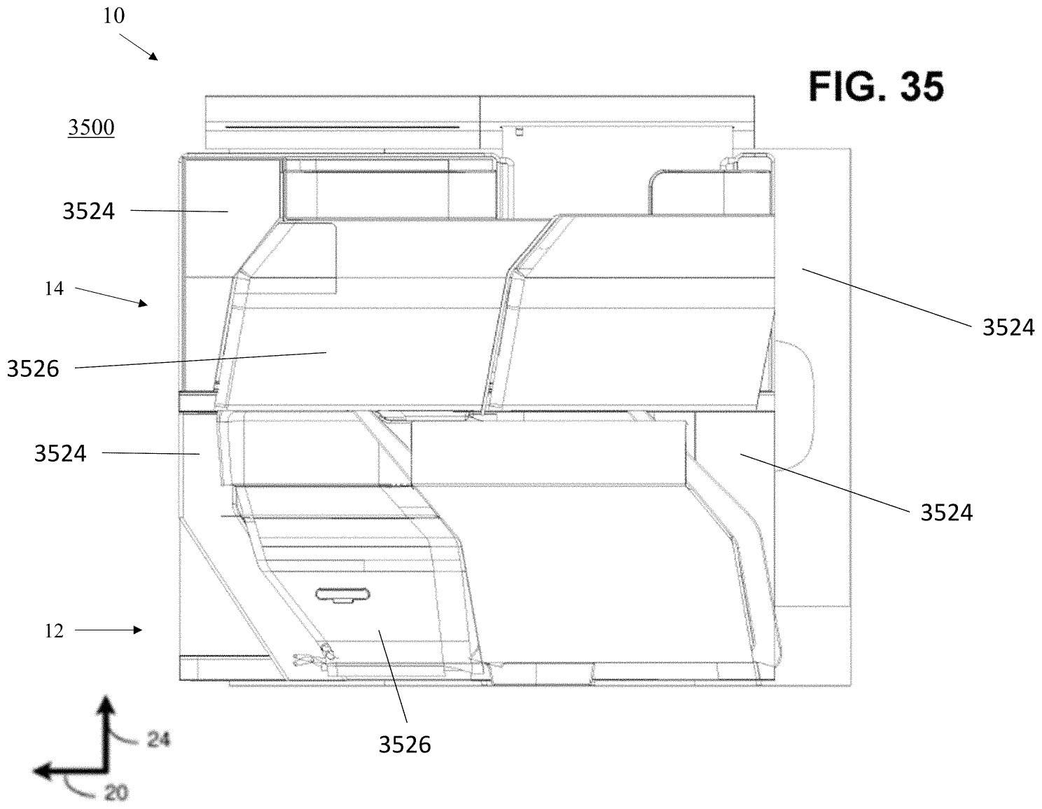

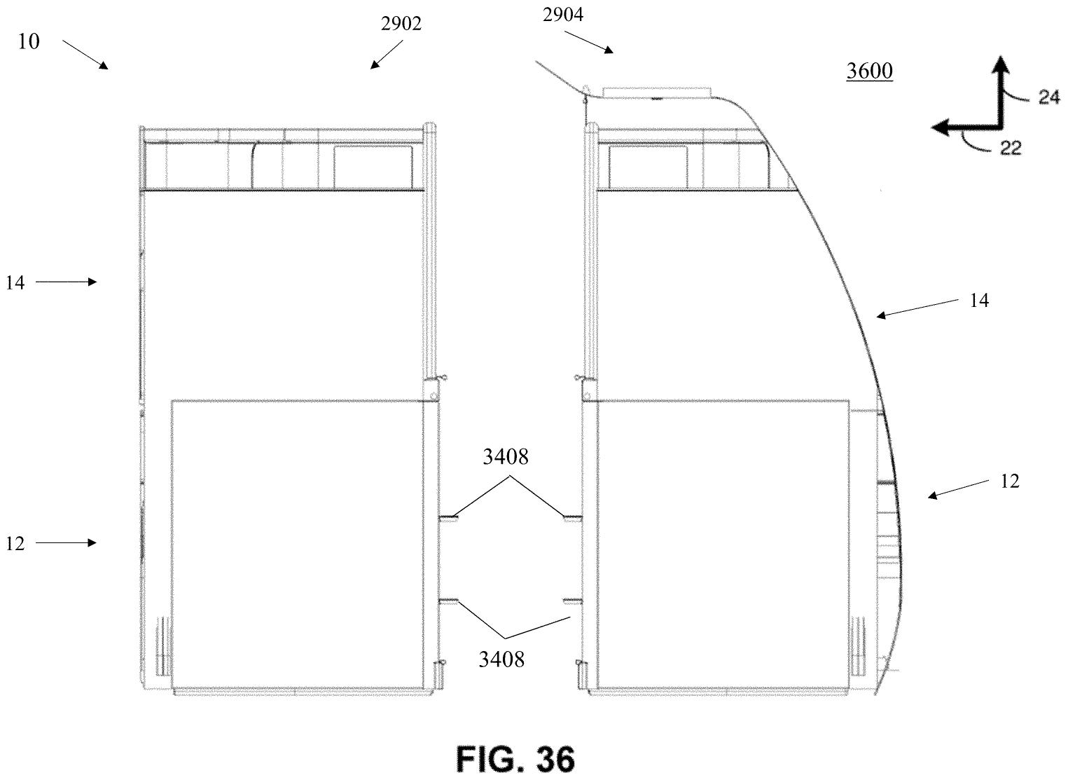

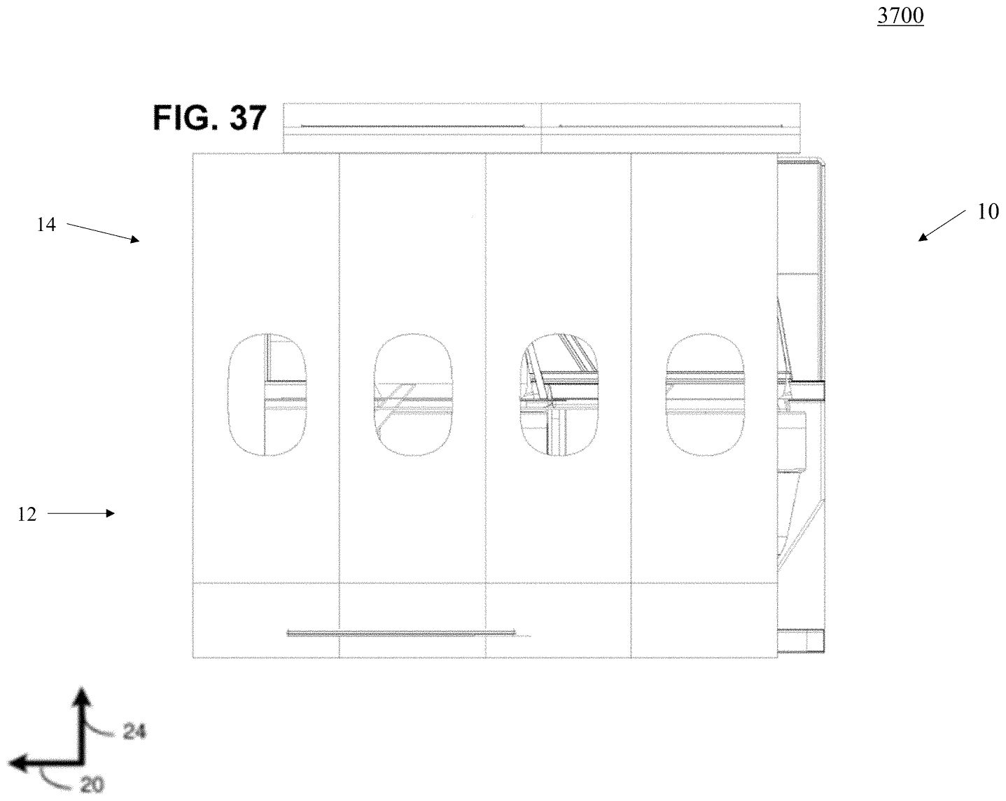

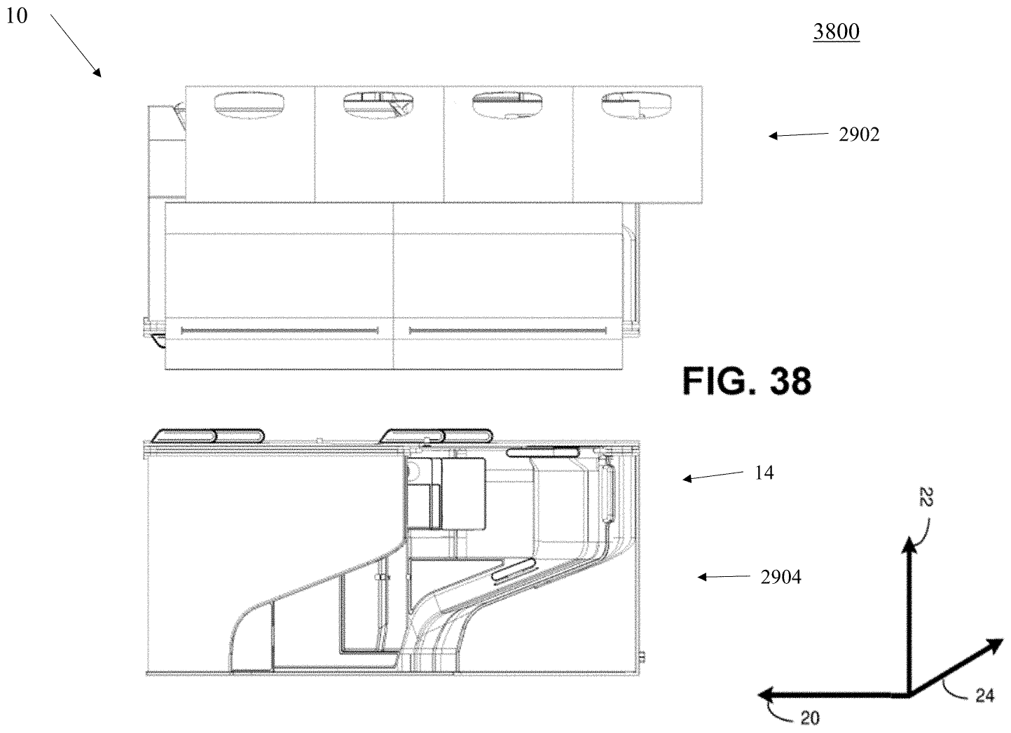

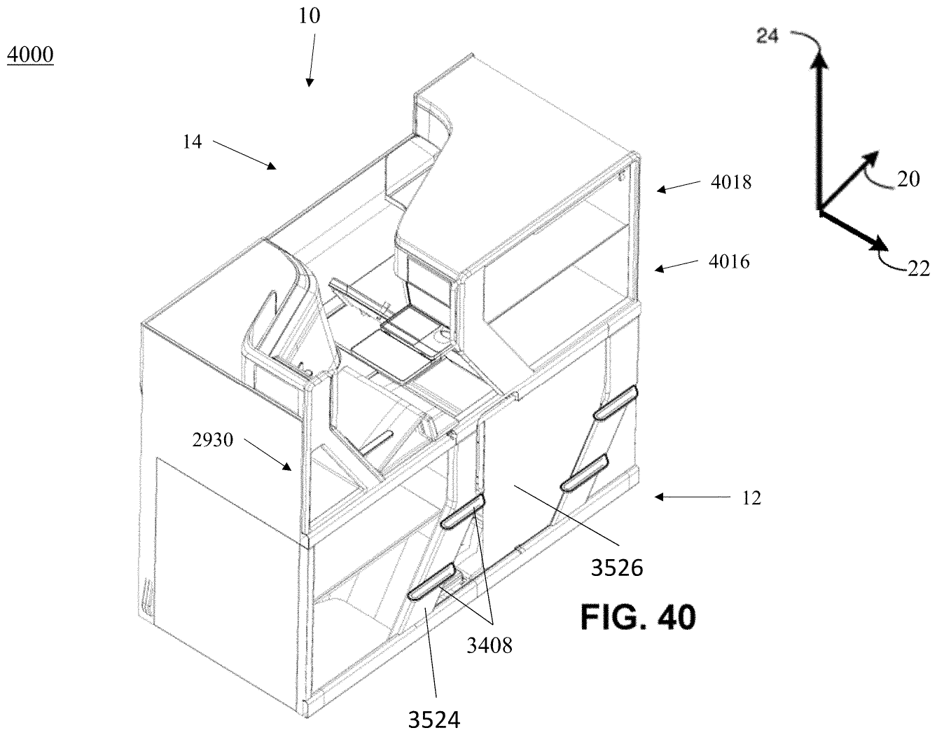

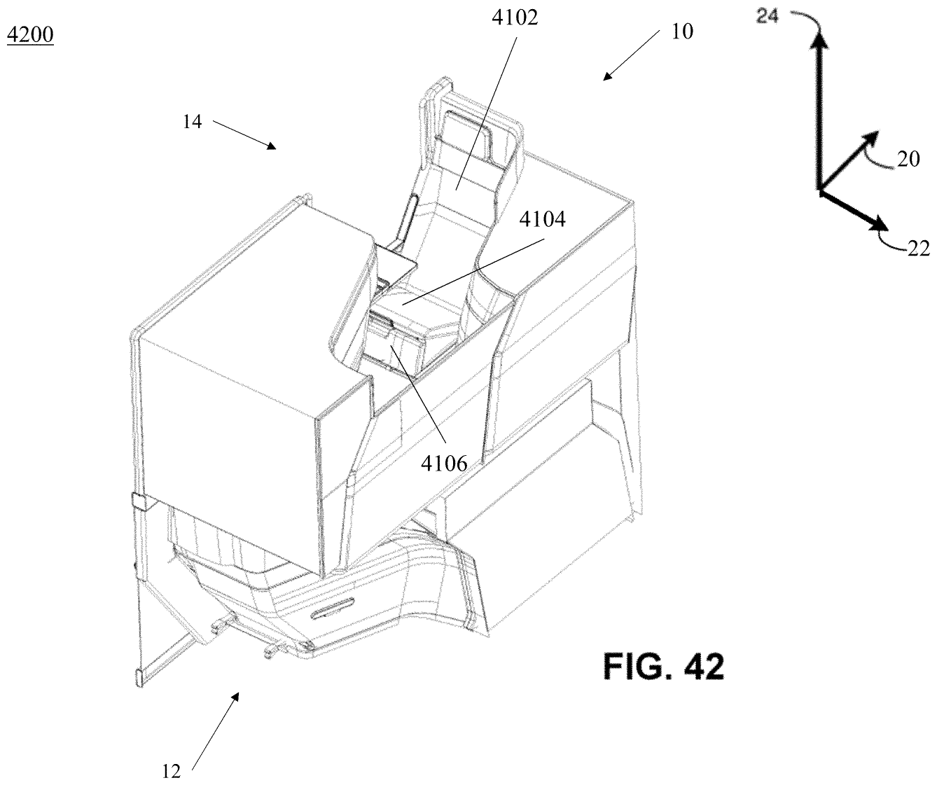

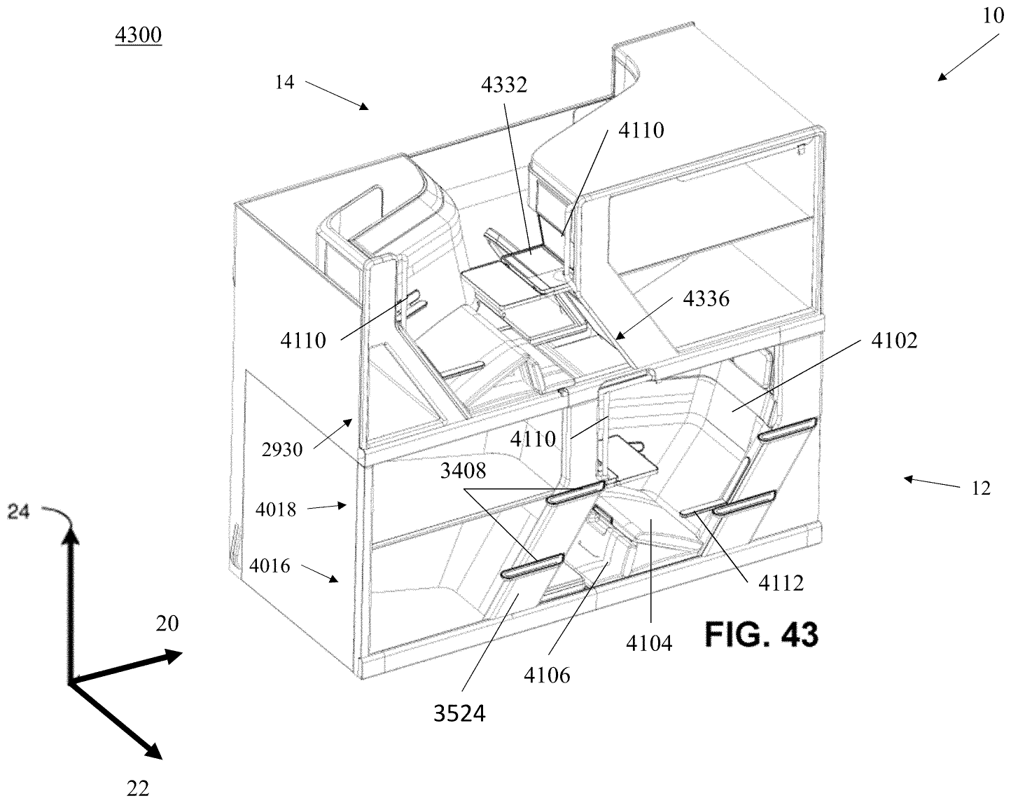

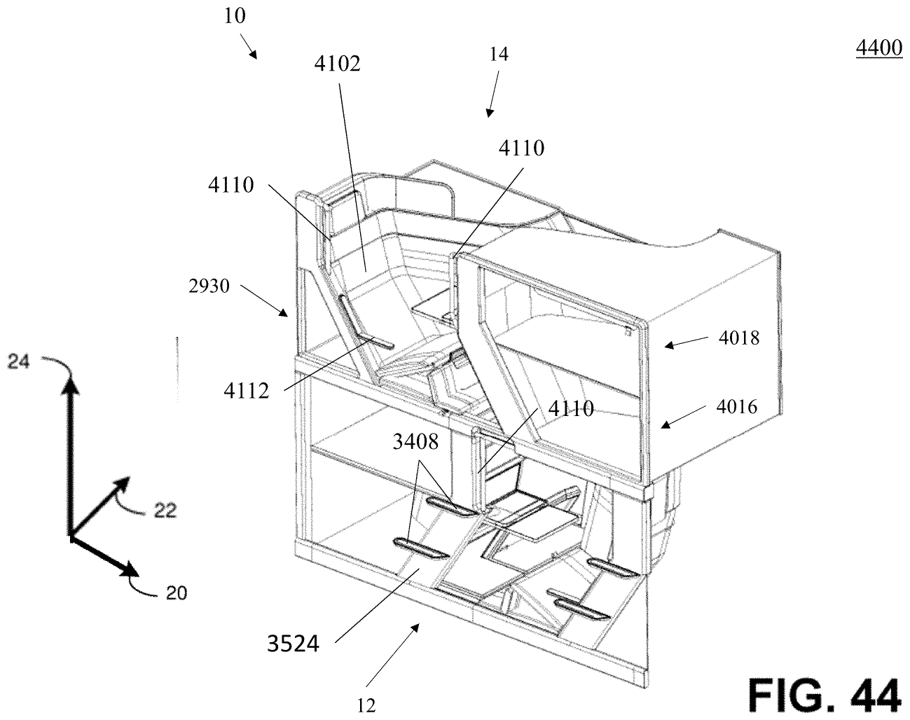

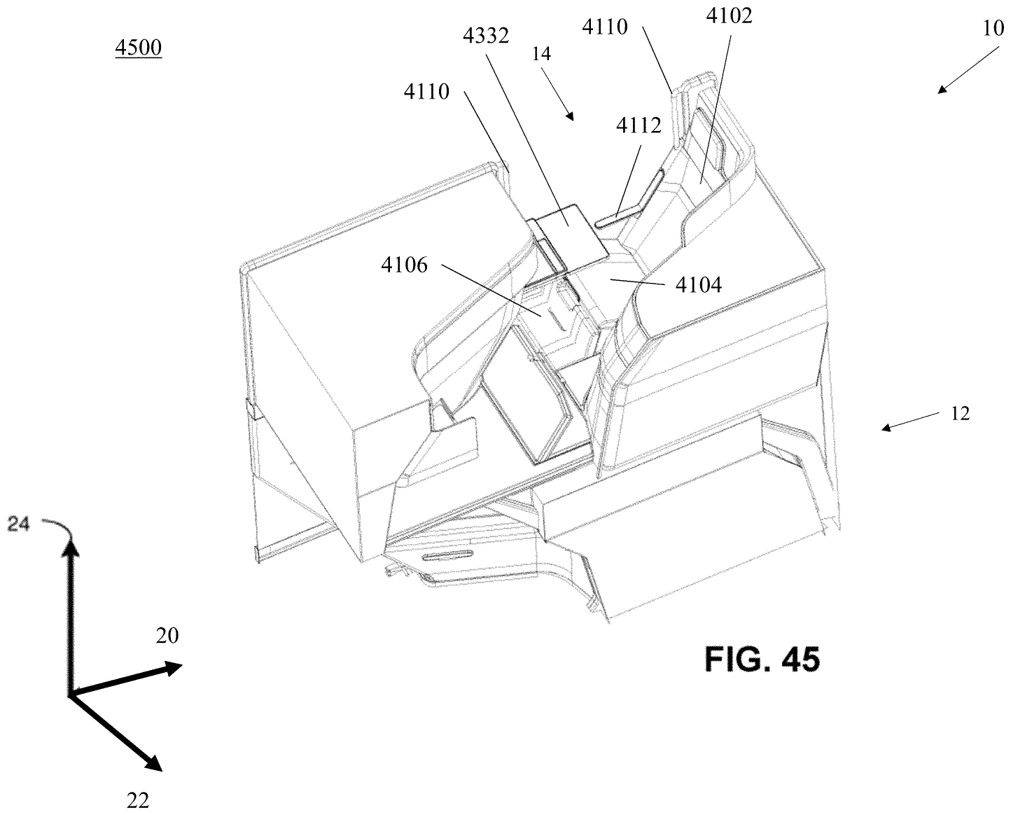

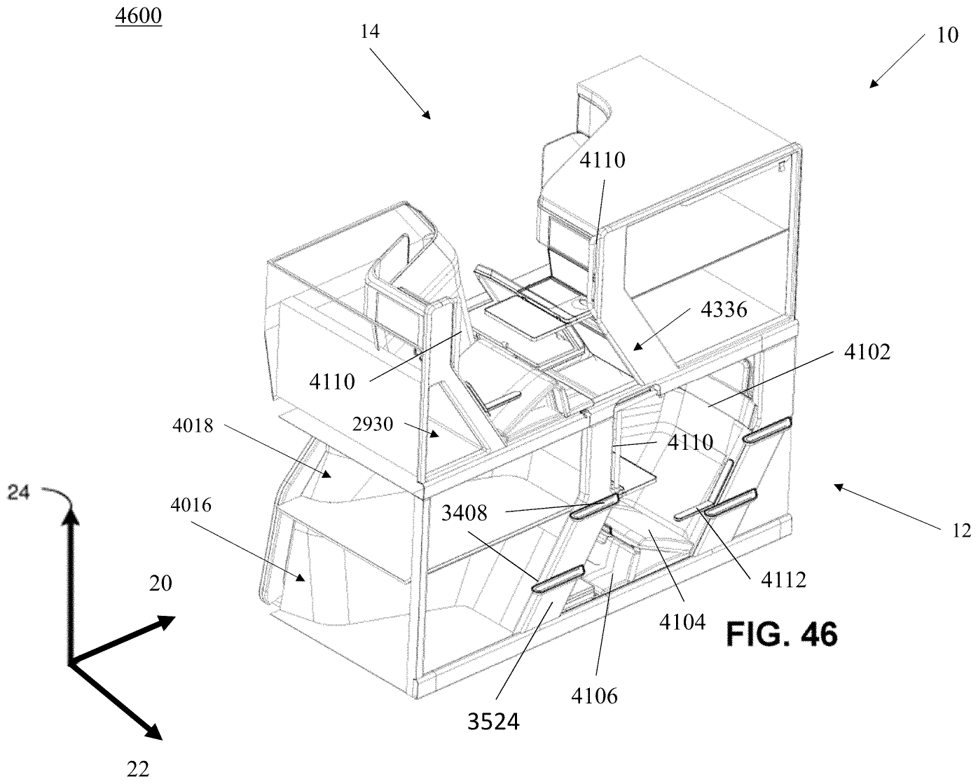

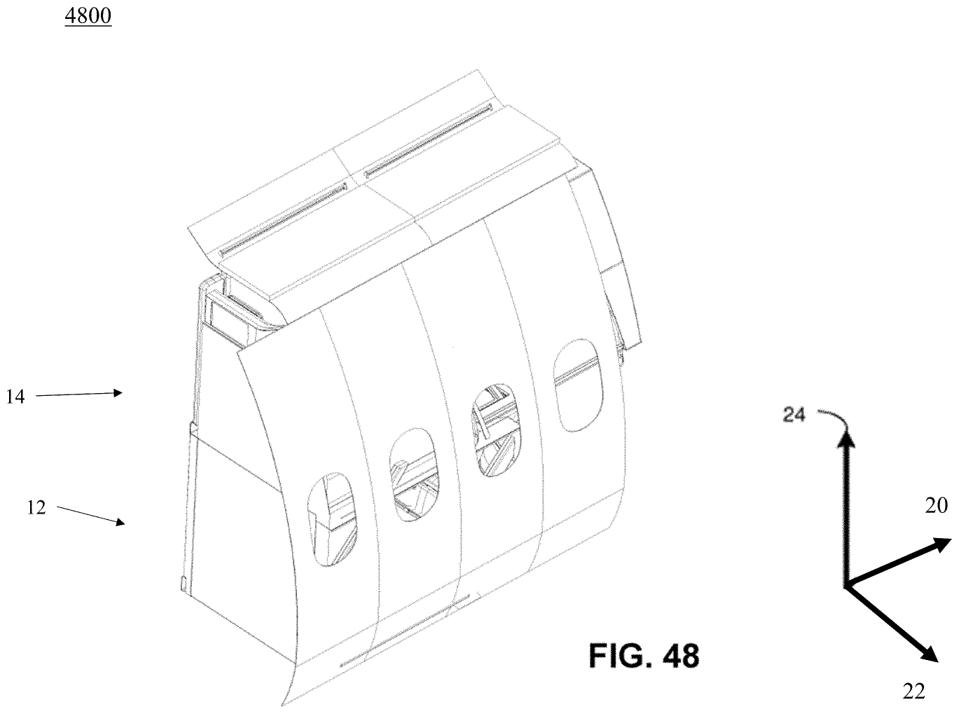

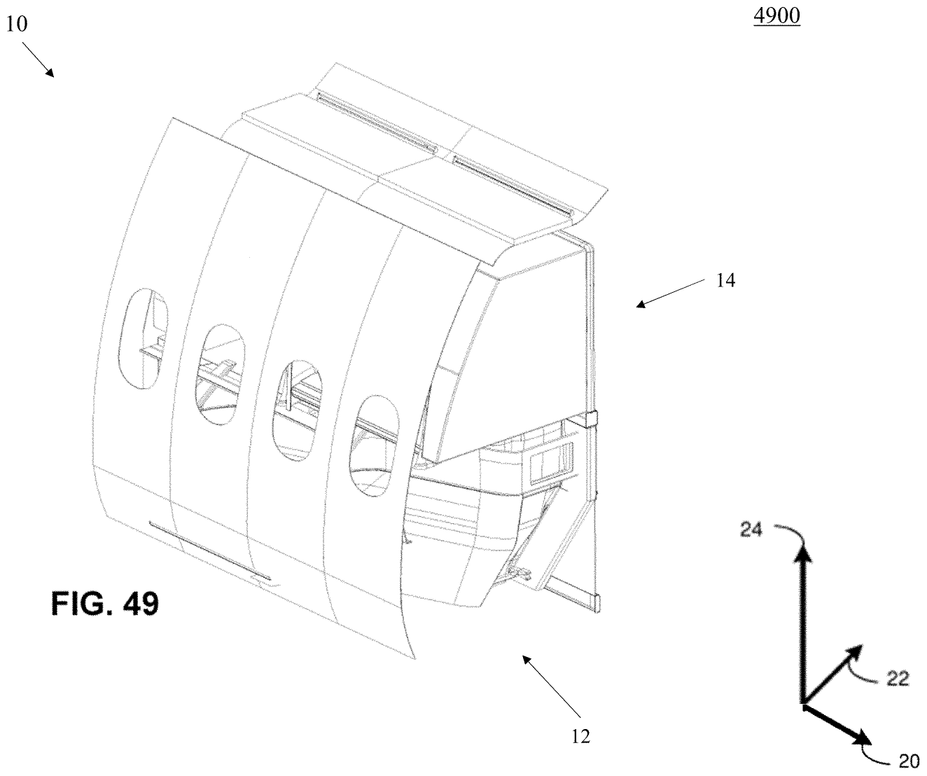

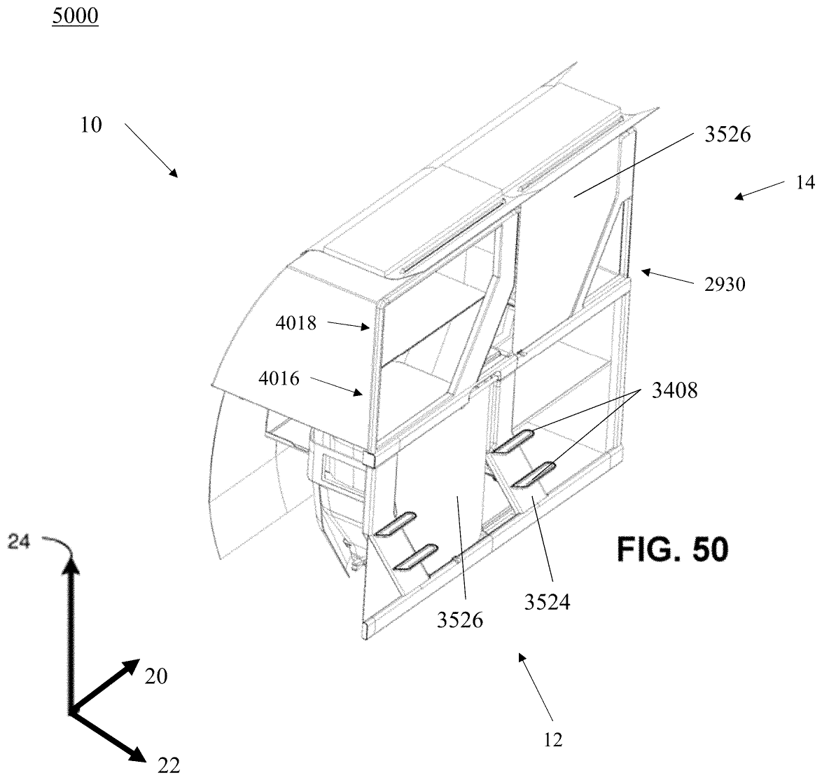

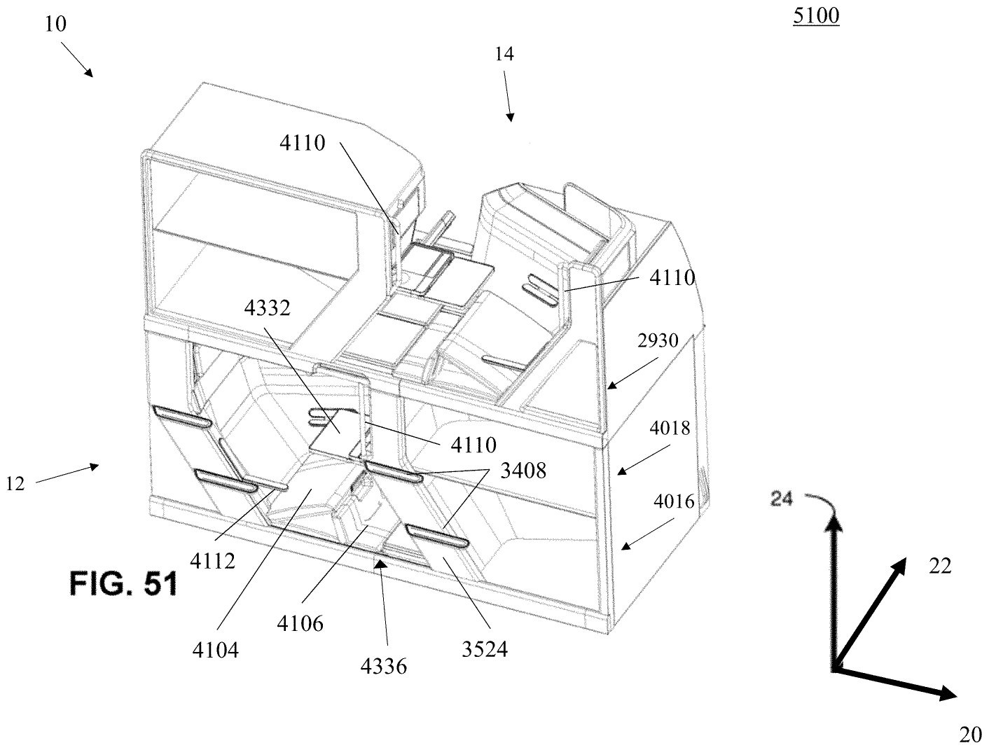

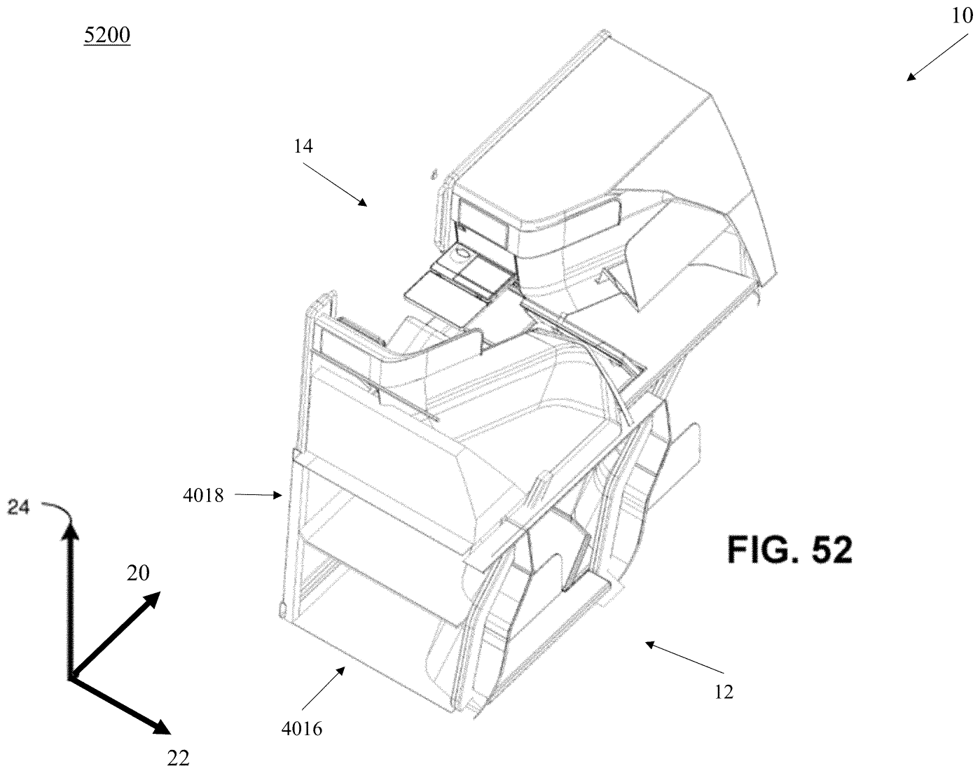

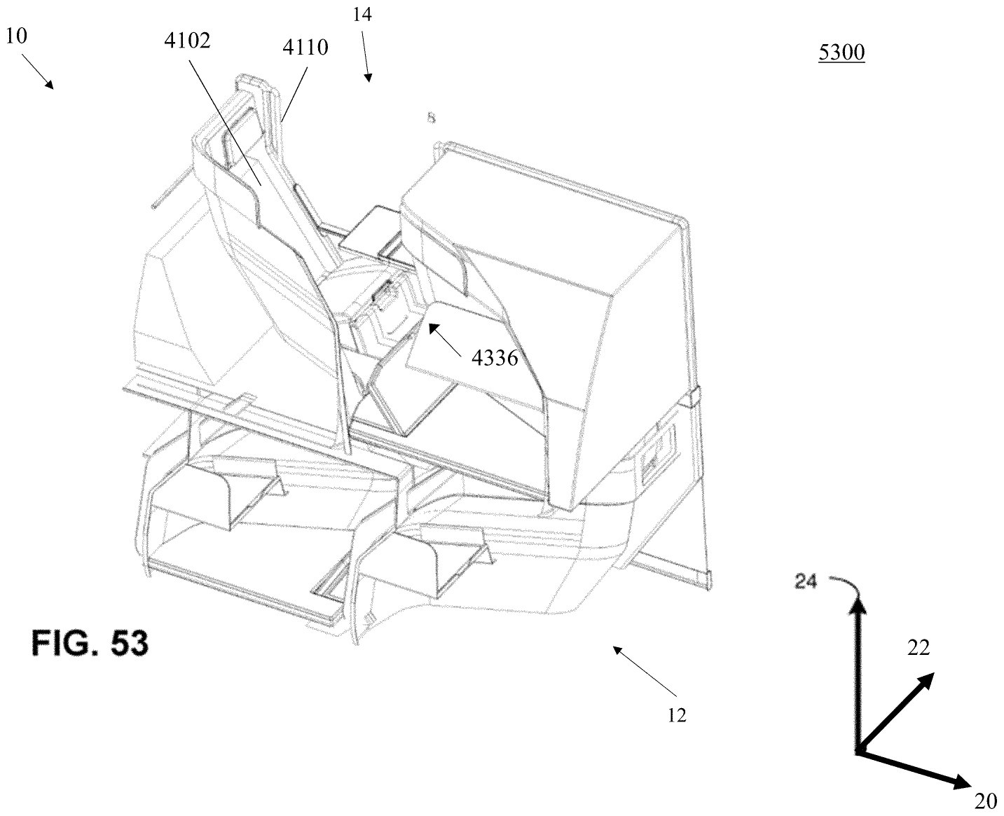

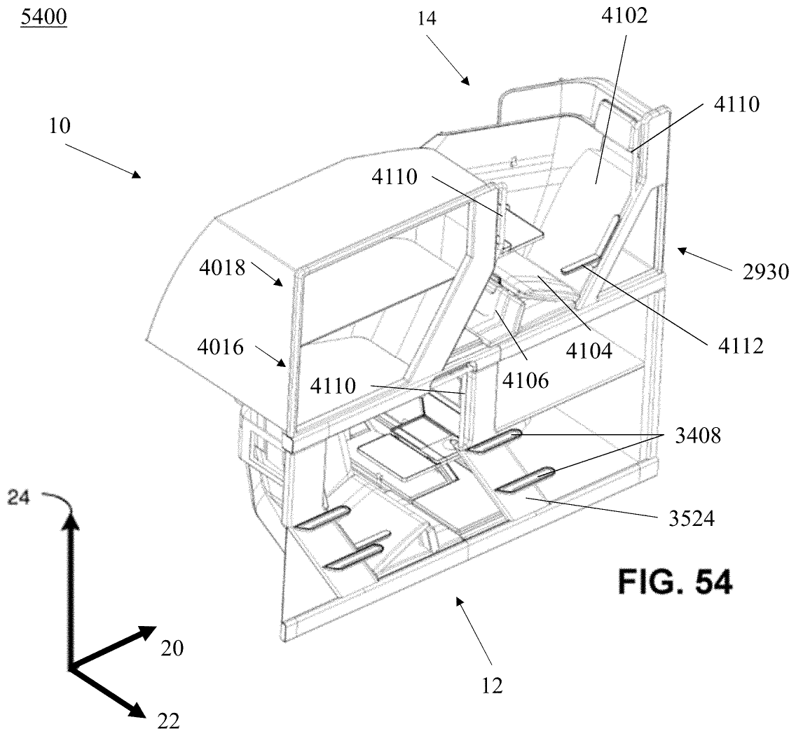

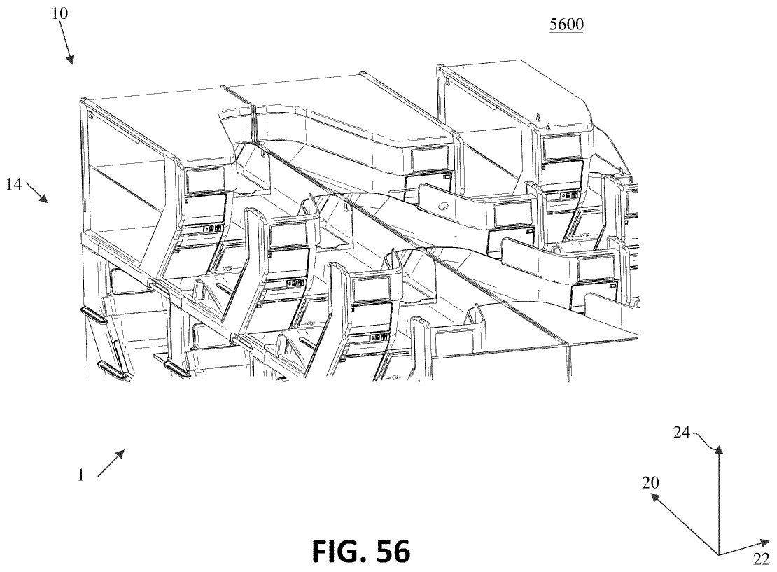

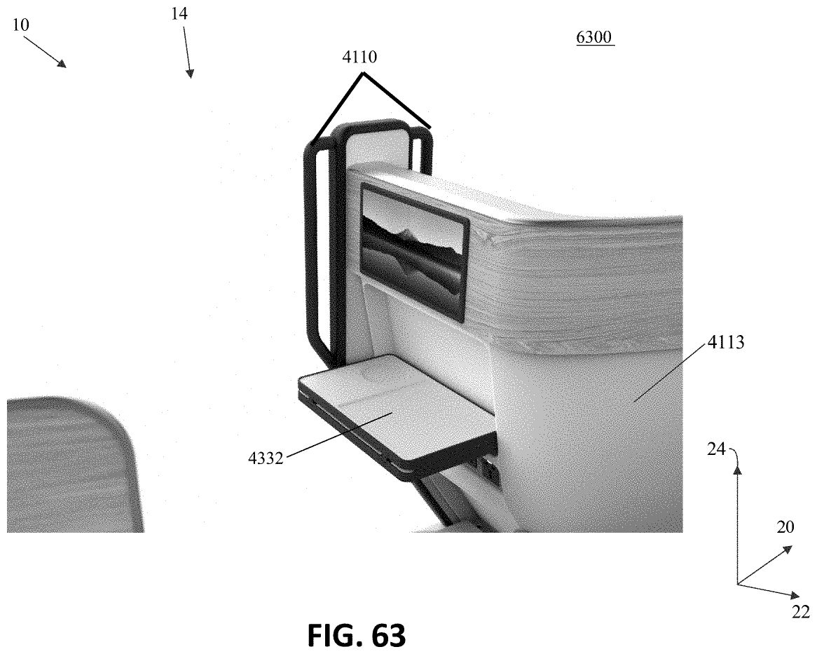

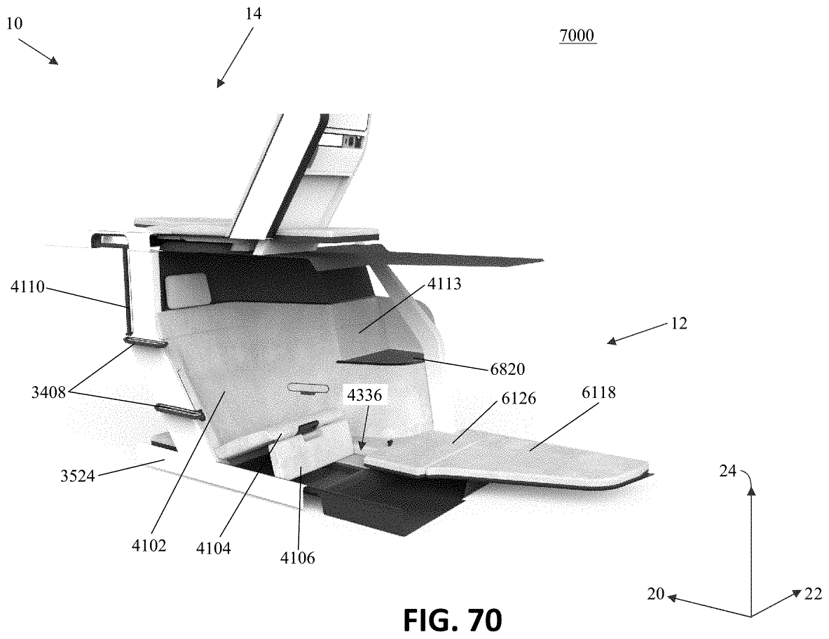

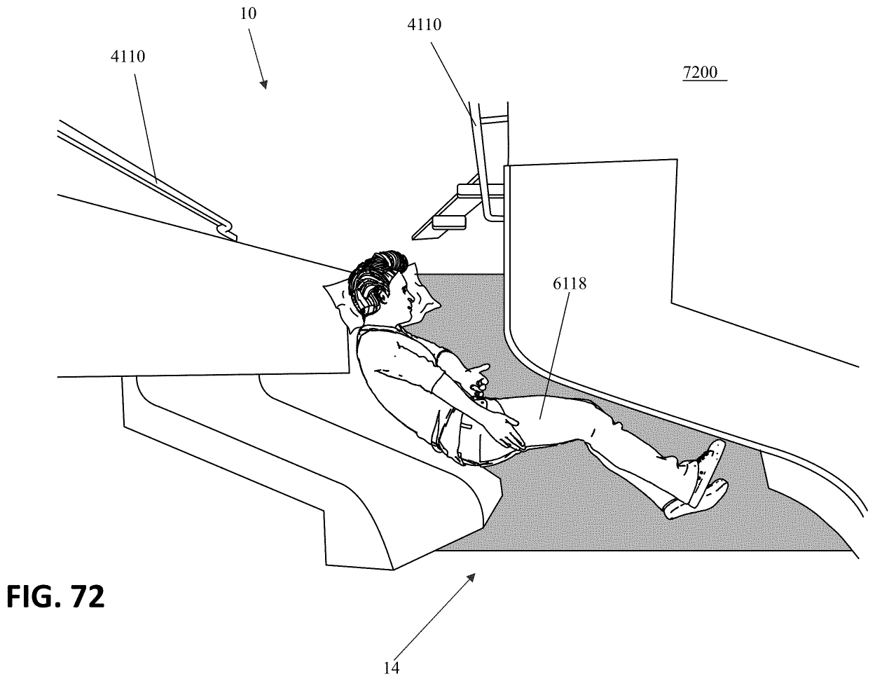

Now referring specifically to FIGS. 29-75, various additional or alternative embodiments of the vehicle seating arrangements 10 are shown in accordance with aspects of the present disclosure. It should be appreciated that features from the embodiments of the vehicle seating arrangement 10 of FIGS. 1-28 may be incorporated in the embodiments of the vehicle seating arrangement 10 of FIGS. 29-75 and vice-versa. As generally depicted in FIGS. 29-75, an arrangement is disclosed that incorporates a plurality of structural units (e.g., structural unit 2902 and/or structural unit 2904). Such structural units may be designed to be outboard, that is, configured to be positioned adjacent a window of a vehicle (e.g., structural unit 2904 of FIG. 29). The structural units may also be designed to be inboard, that is, configured to be positioned along an interior aisle of a vehicle (e.g., structural unit 2902 of FIG. 29). Structural units configured to be outboard may be configured to have access from an aisle of the vehicle on one side and a view from a window on the other side. Structural units configured to be inboard may have access from an aisle on one side and abut an inner wall of an adjacent structural unit on the other side.

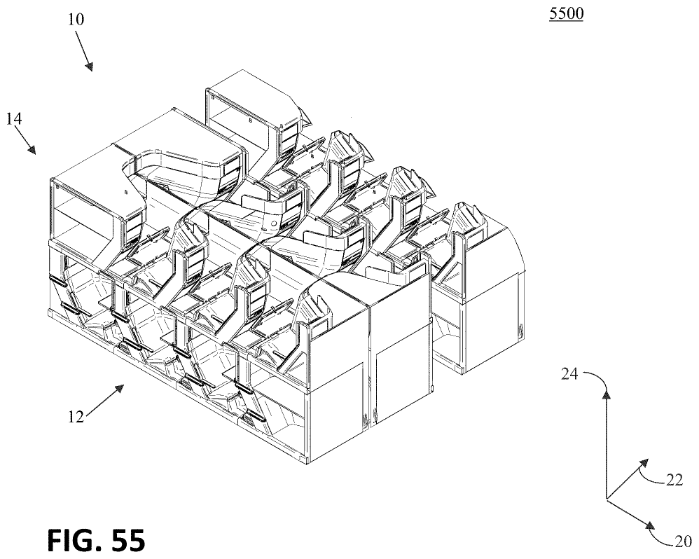

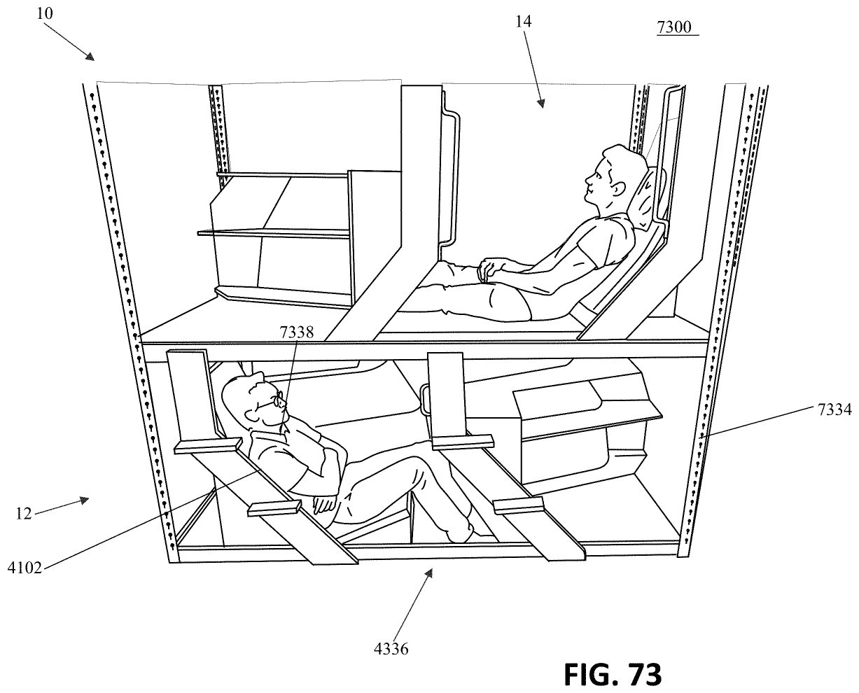

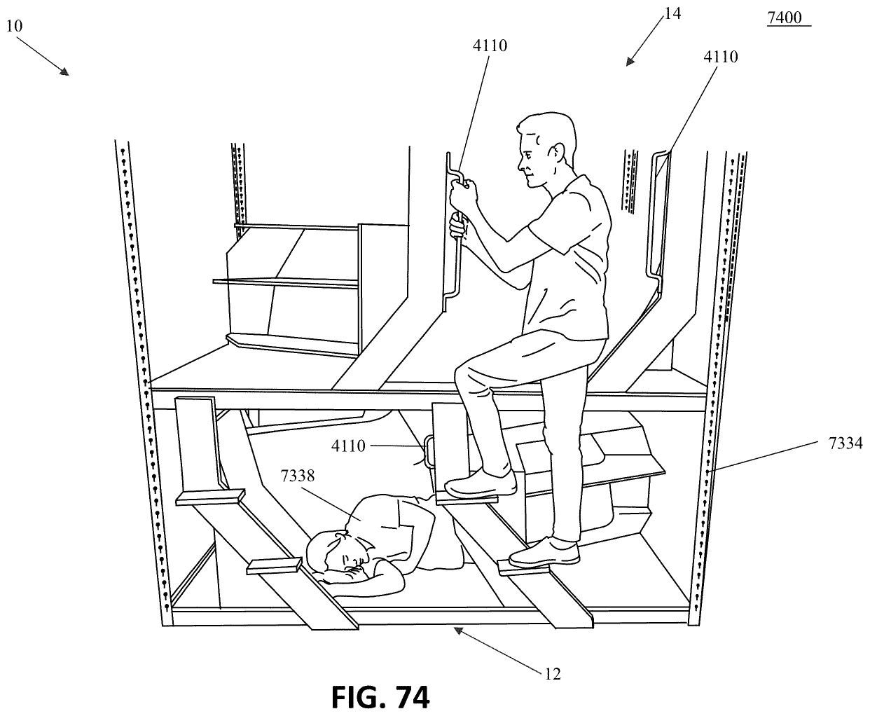

Structural units configured to be outboard may be configured to mesh with additional, similarly situated structural units in a row, as shown generally in FIG. 55. As also shown, structural units configured to be inboard may be configured to mesh with additional, similarly situated structural units in a row. Each of the structural units may be configured to attach to a support, frame, or the like (e.g., a frame 7334 as depicted in FIGS. 73 and 74). The frame 7334 may be supported relative to the vehicle, such as by rails positioned in the floor of the vehicle. Each structural unit may be configured to connected to the floor of the vehicle via engagement with a track or the like. Additionally, or alternatively, each structural unit may be configured to attached to another one of the structural units utilizing a track.

Referring back to the example embodiment of FIG. 55, the vehicle (e.g., an aircraft fuselage, train car, or the like) may include at least one column of nested vehicular seating suite configurations 10 against the edges of the fuselage or the like (e.g., structural units 2904). Additionally, or alternatively, the vehicle may include at least one central column of nested vehicular seating suite configurations 10, such as along the longitudinal axis 20 of the vehicle (e.g., structural units 2902). However, it will be appreciated that various positions are possible within the scope of the present disclosure.

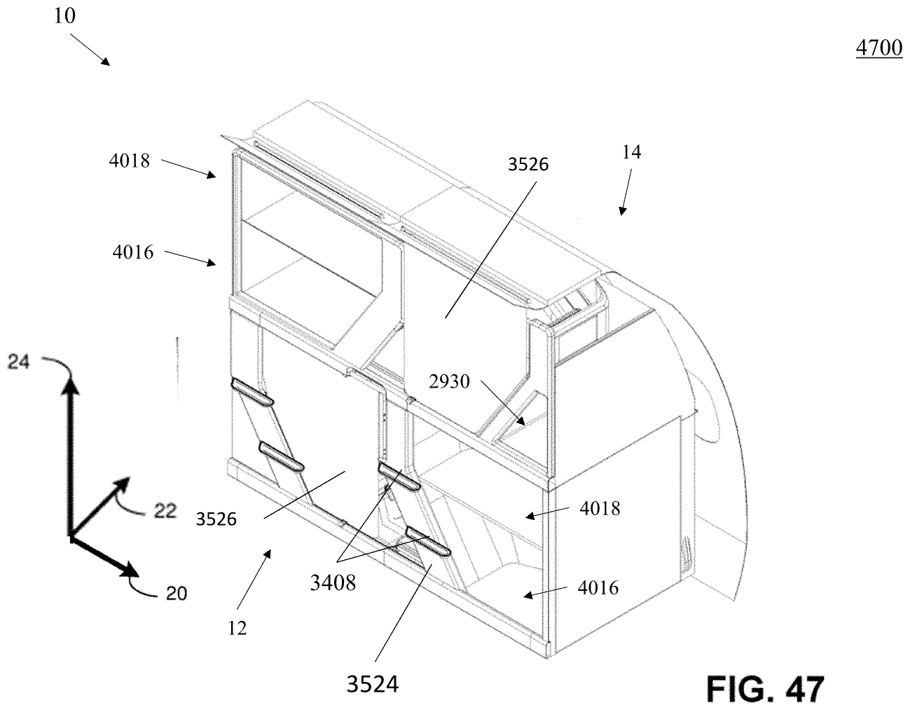

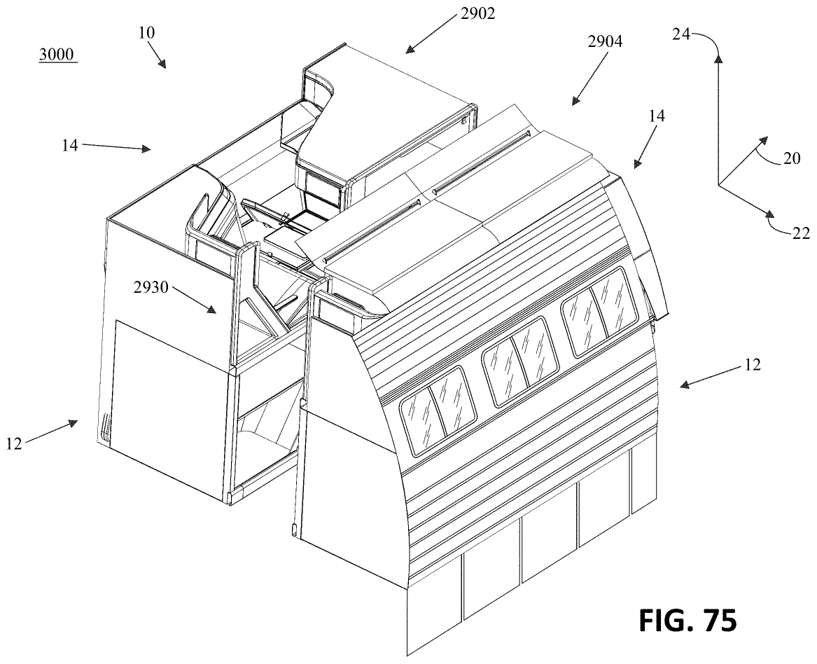

As shown generally with respect to at least FIGS. 47-55, the structural units 2902 may be configured to be positioned against a curved wall of an aircraft fuselage. In this example, a upper seating suite 14 may have curved walls and edges to contour to the curved wall of the aircraft fuselage. It will be appreciated that the upper and lower seating suites 14, 12 of a vehicular seating suite configuration(s) 10 may be contoured to fit various positions within a vehicle and/or for various types of vehicles. Additionally or alternatively, and as shown in FIGS. 55-57, the structural units 2902 and the structural units 2904 may be manufactured with different widths to accommodate a range of vehicle types and arrangements of the vehicle seating suite configurations 10. Additionally, or alternatively, there may be no central column but instead a central walkway (e.g., arranged along the longitudinal axis), as generally shown in the exemplary embodiment of FIG. 75.

In some embodiments, the vehicular seating suite configuration (e.g., vehicular seating suite configuration 10) may be configured to be positioned within a vehicle. In the example of FIGS. 29-32, 34, 36-38, 47-50, vehicular seating suite configuration (e.g., vehicular seating suite configuration 10) may be positioned within the fuselage of an aircraft, such as an airplane. However, it will be appreciated that embodiments of the vehicular seating suite configuration of the present disclosure may be adapted to and positioned within any suitable vehicle, such as a passenger vehicle, a boat, a train, a bus, a car, etc. For instance, as shown in the exemplary embodiment of FIG. 75, vehicular seating suite configuration (e.g., vehicular seating suite configuration 10) may be positioned within the a train, such as a rail car of a passenger train.

Each structural unit includes an upper suite 14 and a lower seating suite 12 positioned within the vehicle, e.g., an aircraft cabin or train car. Each suite of the respective upper and lower seating suites 14, 12 is optionally or variably configurable between a) an upright seating position as shown in FIG. 73, where an occupant (e.g., occupant 7338 of lower suite 12) may sit with the occupant's back against a backrest 4102 and the occupant's knees angled such that the occupant's feet are in a footwell 4336, and b) a lie-flat seating position as shown in FIG. 74, where the occupant (e.g., occupant 7338 of lower suite 12) may lie substantially flat. Each seating suite may include the backrest 4102, which may be incorporated and attached to the respective structural unit of the vehicle seating arrangement 10. When either of the respective upper or lower seating suites 14, 12 is configured in the upright seating position, the respective occupant 7338 may be positioned substantially along the vehicle's longitudinal axis 20.

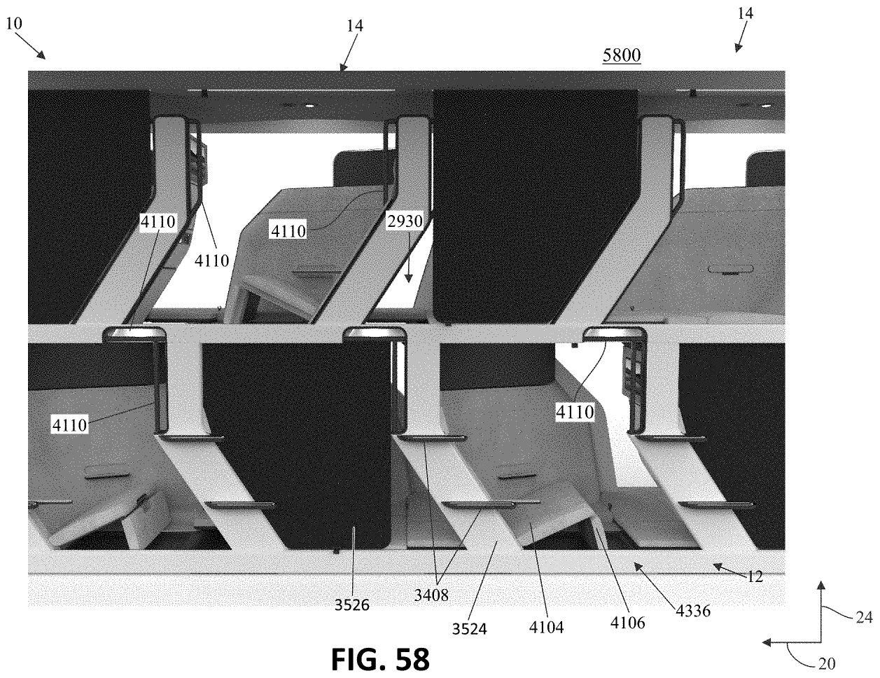

As shown in FIGS. 58-60 and 70 and in some embodiments, the backrest 4102 may include an orientation generally parallel to the vertical axis 24 of the vehicle. In other words, the backrest 4102 may generally extend along the vertical axis 24 of the vehicle. It will be appreciated that the backrest 4102 may be angled relative to a proximal end (e.g., a top or a head rest position) of backrest 4102 to provide at least a partial recline. For example and in some embodiments, the backrest 4102 may be perpendicular to the integrated seat pan 4104. In some embodiments, backrest 4102 may be oriented relative to the integrated seat pan 4104 to form an obtuse angle (e.g., an angle measured from a proximal end of the integrated seat pan 4104 to a distal end of the backrest 4102). In this manner, the combination of the integrated seat pan 4104 and the backrest 4102 may be configured to provide a reclined seat for a passenger.

In some embodiments, the backrest 4102 may not include any motorized components. However, it will be appreciated that, in other embodiments, the backrest 4102 may include motorized components configured to actuate the backrest 4102 relative to a wall, partial enclosure, etc. (e.g., wall 4113). For instance, internal actuators (e.g., inflatable bladders/air cushions in combination with suitable pressure regulation, internal movable parts in combination with motor mechanisms, and/or the like) that may cause the backrest 4102 to move relative to the wall 4113. In an additional or alternative embodiment, a segmented backrest 4102 may be actuated relative to the wall 4113 to alter the angle of recline between such segmented backrest 4102 and the integrated seat pan 4104. In additional or alternative embodiments, the backrest 4102 may include a rigid portion configured to support a passenger's back and a padded portion configured to cushion the passenger from the rigid portion. The padded portion may include various fabrics, cushioning elements, etc. known in the art. In this manner, a passenger may rest her or his back against the backrest 4102 comfortably.

The backrest 4102 may be generally aligned with the longitudinal axis 20 of the vehicle. For example, when a passenger is sitting with his or her back resting against the backrest 4102, a passenger may be oriented in parallel with longitudinal axis 20. However, in some embodiments, the backrest 4102 may be oriented in the same direction as a lie-flat bed 6118. In some embodiments, the backrest 4102 may be oriented in a different direction from the lie-flat bed 6118. Additionally, or alternatively, the backrest may include portions, sections, sub-parts, or the like that include multiple orientations such that a passenger may sit at multiple orientations relative to the lie-flat bed 6118, the backrest 4102, and/or the longitudinal axis 20 comfortably.

It should be appreciated that, in some embodiments, the integrated seat pan 4104 may be oriented at any angle ranging from parallel to the longitudinal axis 20 of the vehicle to perpendicular to the longitudinal axis 20 of the vehicle. Additionally, or alternatively, a generally horizontal seating surface (e.g., integrated seat pan 4104) is not required to be exactly parallel with this reference plane defined by the longitudinal axis (e.g., longitudinal axis 20) and the lateral axis (e.g., lateral axis 22) of the vehicle. In this manner, embodiments of the integrated seat pan 4104 may have at least some vertical distance or gradient between its ends (e.g., sloping up from one end to another or sloping down from one end to another). It will be appreciated that the vertical distance or pitch between the ends can be constrained by the lying position of a passenger. In other words, the amount of vertical distance between the ends of the integrated seat pan 4104 (e.g., the front and back ends relative to the longitudinal direction 20) may be constrained to a gradient that would allow a passenger to lay on the integrated seat pan 4104. As shown and in some embodiments, the integrated seat pan 4104 may be configured to rotate vertically to form an inclined seating surface. It will also be appreciated that the integrated seat pan 4104 may be at least partially rotated about the longitudinal axis (e.g., longitudinal axis 20).

It should be appreciated that each of the respective upper and lower seating suites 14, 12 of each of the structural units also has appropriate safety harnesses. Preferably, a seat belt is available to an occupant of the suite configured in the upright seating position and also to an occupant of the suite configured in the lie-flat position. According to the instant invention, the safety harness may be a two or three point harness and there may be separate harnesses for each of the upright seating position and lie-flat seating position.

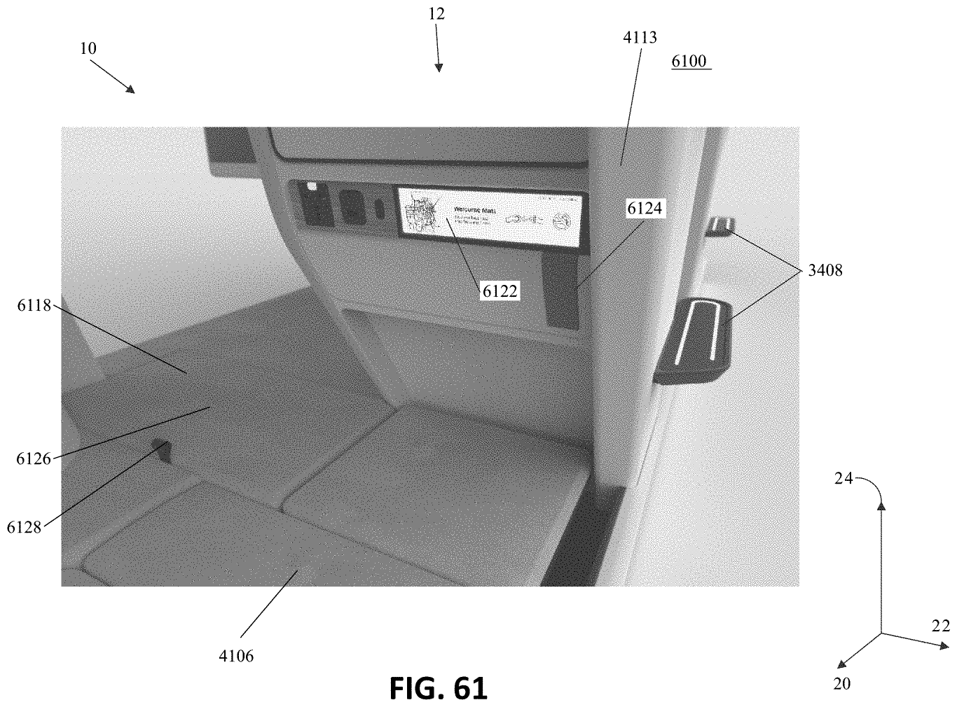

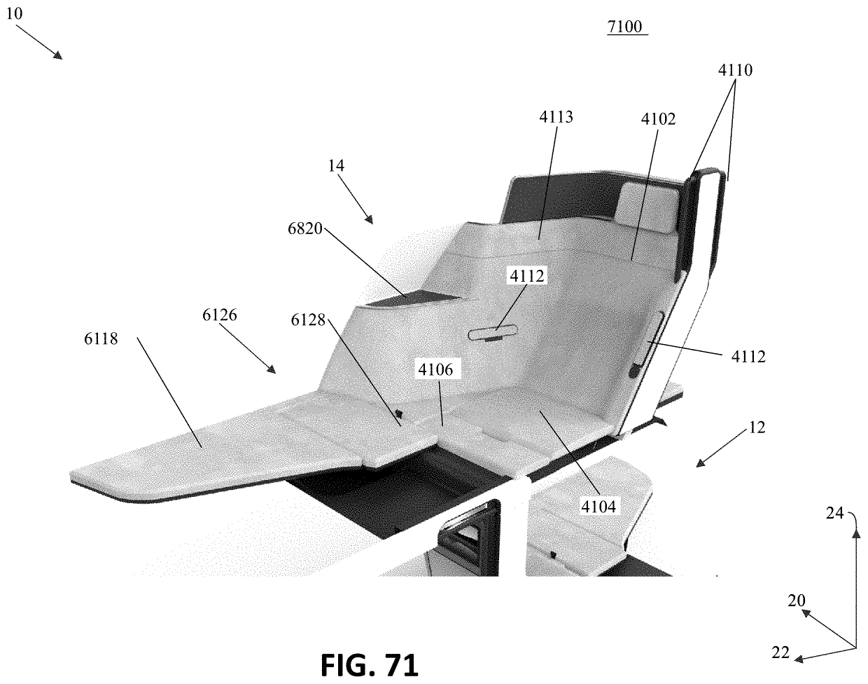

In some embodiments, the integrated seat pan 4104 and the lower extension portion 4106 may be configured to provide a continuous surface across the integrated seat pan 4104, the lower extension portion 4106, and the generally the lie-flat bed 6118 (see, e.g., FIG. 71). As shown in the exemplary embodiments of FIGS. 61, 66, and 71, the integrated seat pan 4104 and/or a lower extension portion 4106 for each suite may move to form a flat surface when configured in the lie-flat seating position (e.g., in combination with the lie-flat bed 6118). When the suite is configured in the lie-flat seating position, the occupant 7338 may be positioned at an angle to the longitudinal axis 20. In additional or alternative embodiments, the occupant 7338 may be positioned parallel to the longitudinal axis 20 when the respective suite (e.g., upper suite 14 or lower suite 12) is in the lie-flat position.

A seat pan mechanism may lower the integrated seat pan 4104 and/or the extension portion 1406 in order to configure the respective suite in the lie-flat position. For instance, the integrated seat pan 4104 and the lower extension portion 4106 may be coupled together. In some embodiments, the lower extension portion 4106 may be rotatably coupled to the integrated seat pan 4104. Additionally, or alternatively, both the integrated seat pan 4104 and the lower extension portion 4106 may be moved to close out the footwell 4336. In some embodiments, integrated seat pan 4104 may be moved together or separately with the lower extension portion 4106 to adjust the seating portion between relatively horizontal and inclined seating surfaces. Additionally or alternatively, the integrated seat pan 4104 and/or the lower extension portion 4106 may include motorized components for reclining, orienting, or transitioning between the upright seating position and the lie-flat position.

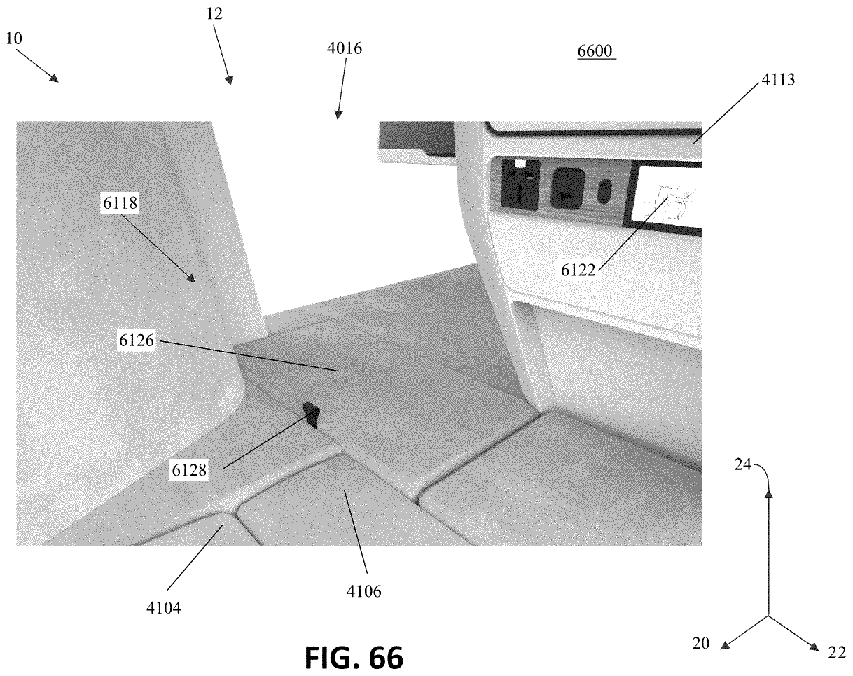

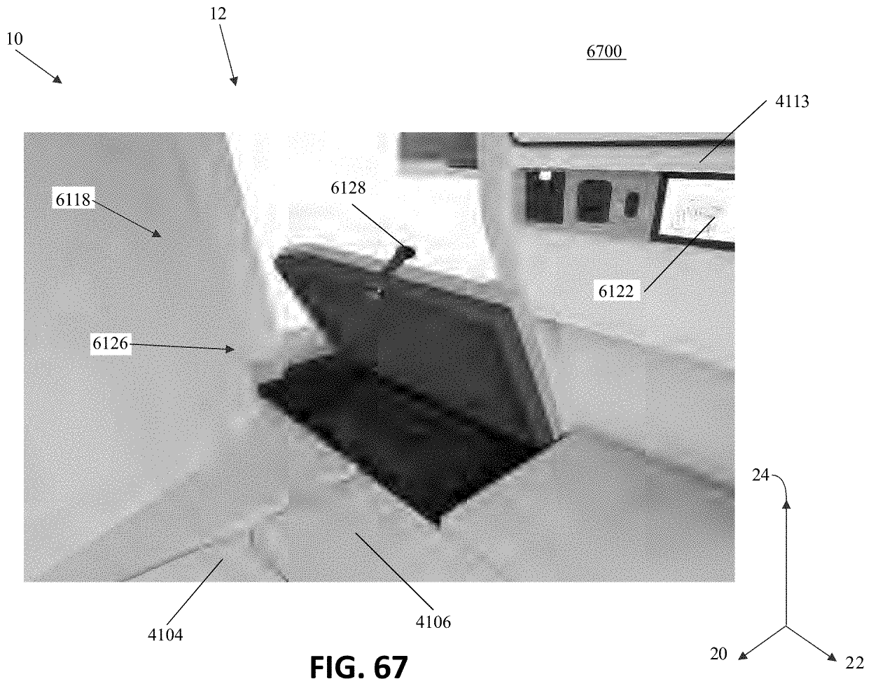

In some embodiments, each of the integrated seat pan 4104, lower extension portion 4106, and/or the lie-flat bed 6118 may include a rigid portion configured to support the weight of a passenger and a padded portion configured to cushion the passenger from the rigid portion. In some embodiments, the rigid portion may include a platform to support the padded portion. The padded portion include various fabrics, cushioning elements, etc. known in the art. In this manner, a passenger may sit or lay down in the respective suite (e.g., upper suite 14 or lower suite 12). In several exemplary embodiments and as generally shown in, e.g., FIGS. 66 and 67, one or more stowage compartments (e.g., stowage compartment 6126) may be positioned below the integrated seat pan 4104 and/or the lie-flat bed 6118 of each of the lower and/or upper seating suites 12, 14. These stowage compartments 6126 may have an upper padded surface forming a portion of the integrated seat pan 4104 and/or the lie-flat bed 6118. For example, in a closed position (e.g., as shown in FIG. 66), each stowage compartment 6126 may define a seamless or flush bed space and/or seating enclosure.

Additionally, or alternatively, each stowage compartment 6126 may include a flexible pull tab 6128 attached, coupled, or the like to the stowage compartment 6126 to allow an occupant to open the same (e.g., as shown in FIG. 67). Each stowage compartment may include or define a cavity configured to receive an associated occupant's personal items (e.g., a backpack, small luggage, and/or the like). Each stowage compartment 6126 may include a simple looking mechanism configured to retain the lid of the stowage compartment 6126 within the integrated seat pan 4104 and/or the lie-flat bed 6118 and to allow access to stowage compartment 6126 when the flexible pull tab 6128 is pulled. Additionally, or alternatively, the lid of the stowage compartment 6126 may be hollowed out and/or recessed within the interior of the stowage compartment 6126 in order to allow more storage for the associated occupant's personal items.

Additionally, or alternatively, the vehicular seating suite configuration 10 may include one or more storage compartments positioned adjacent to the lie-flat bed 6118 and oriented toward the aisle of the vehicle (e.g., lower storage compartment 4016 and/or upper storage compartment 4018) to provide a storage compartment (e.g., for luggage or other personal belongings) for each passenger of each pair of stacked seating suites (e.g., lower seating suite 12 and upper seating suite 14). Additionally, or alternatively, each of the lower seating suite 12 and the upper seating suite 14 may be provided a respective pair of storage compartment (e.g., lower storage compartment 4016 and/or upper storage compartment 4018) positioned adjacent to the lie-flat bed 6118 of the respective suite and oriented toward the aisle of the vehicle.

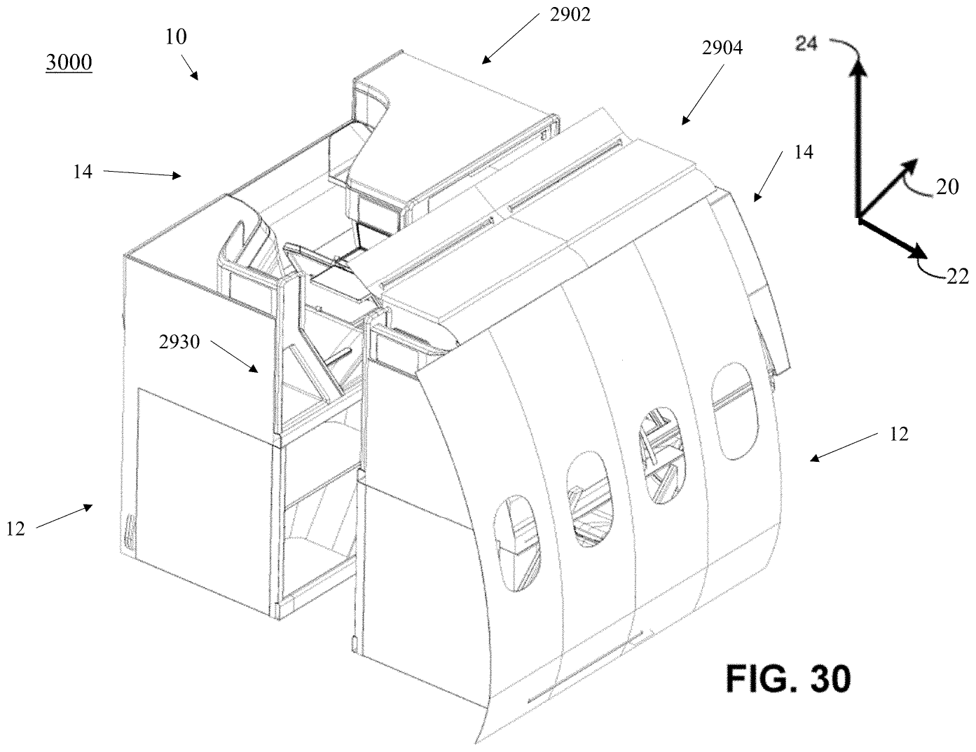

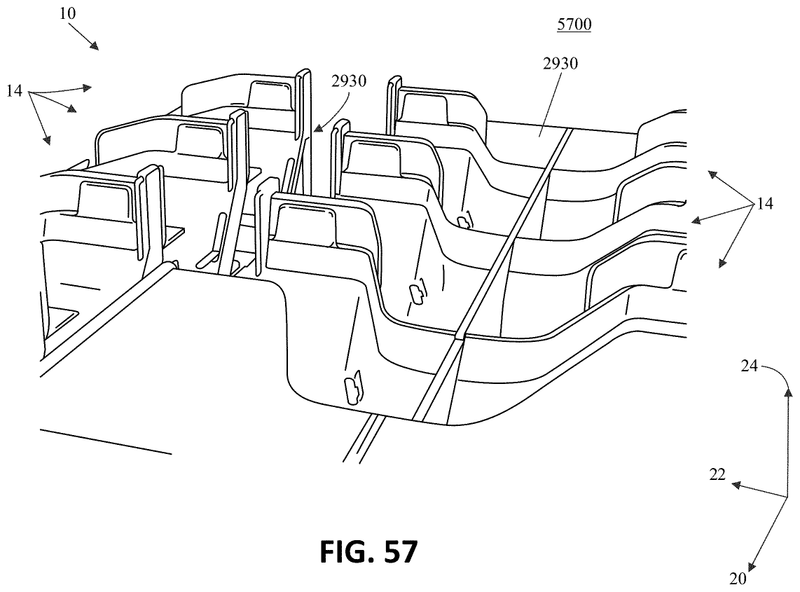

As shown in FIGS. 29, 33-37, 39, 45, 47-51, 54, and 55, in various embodiments, the upper suites 14 are positioned to each face in the aft direction, towards the rear of the vehicle. Likewise, the lower suites 12 are positioned to each face the forward direction, towards the front of the vehicle. One of skill in the art will recognize that the opposite position is also contemplated—that is the lower suites may be configured to face aft while the upper suites may be configured to face forward, e.g., as depicted in FIGS. 30-32, 38, 40-44, 46, 52, 53, 56-71, and 75. Additionally, or alternatively, the upper suites 14 may face a different longitudinal direction from the lower suites 12. As shown in FIG. 58 and in some embodiments, the upper seating suite 14 may be horizontally offset from the lower seating suite 12 along the longitudinal axis 20 of the vehicle. For instance, upper seating suite 14 may be horizontally offset or staggered from lower seating suite 12 along longitudinal axis 20 of the vehicle. Additionally, or alternatively, the footwell 4336 of upper seating surface 14 may extend down into the space of lower seating suite 12 without reducing the headroom of passenger in lower seating suite 12.

Where a plurality of structural units are utilized in rows within a vehicle interior as disclosed in the embodiments of FIGS. 29-75, often, there will be a structural unit that begins a particular row and a structural unit which terminates a particular row. Accordingly, the present embodiment contemplates that additional storage space may be positioned in these locations, likely between a bulkhead wall and either the beginning or the terminus of a particular row of structural units. For instance, several exemplary embodiments (see, e.g., FIG. 57) of the vehicle seating arrangement 10 include one or more end storage units 2930.

Additionally, or alternatively, vehicles such as aircraft or passenger train often include one or more vehicle seating suite configurations 10 intended for use by crew, attendants, pilots, operators, and the like. Such crew seating suite configurations may be separated from the seating suite configurations 10 intended for the passengers, interspersed throughout the seating suite configurations 10 intended for the passengers, or both. Further, safety requirement and regulations for crew members are often different (e.g., less restrictive) than those for the passengers. For example, crew members may not be required to be secured in a sitting position during all periods of travel, and seating suite configuration 10 may be configured to allow easier egress and entry. Additionally, or alternatively, it should be appreciated that upper suites 14 and lower suites 12 intended for crew members may be arranged in the vehicle at an angle to the longitudinal axis 20 and/or may include safety harnesses, equipment, and the like that allow crew to more quickly enter and exit the respective upper and lower seating suites 14, 12. For example, the integrated seat pans 4104 of the respective upper suites 14 and lower suites 12 may be generally oriented to extend along the lateral axis 22 (e.g., facing opposite or substantially opposite directions along the lateral axis 22).

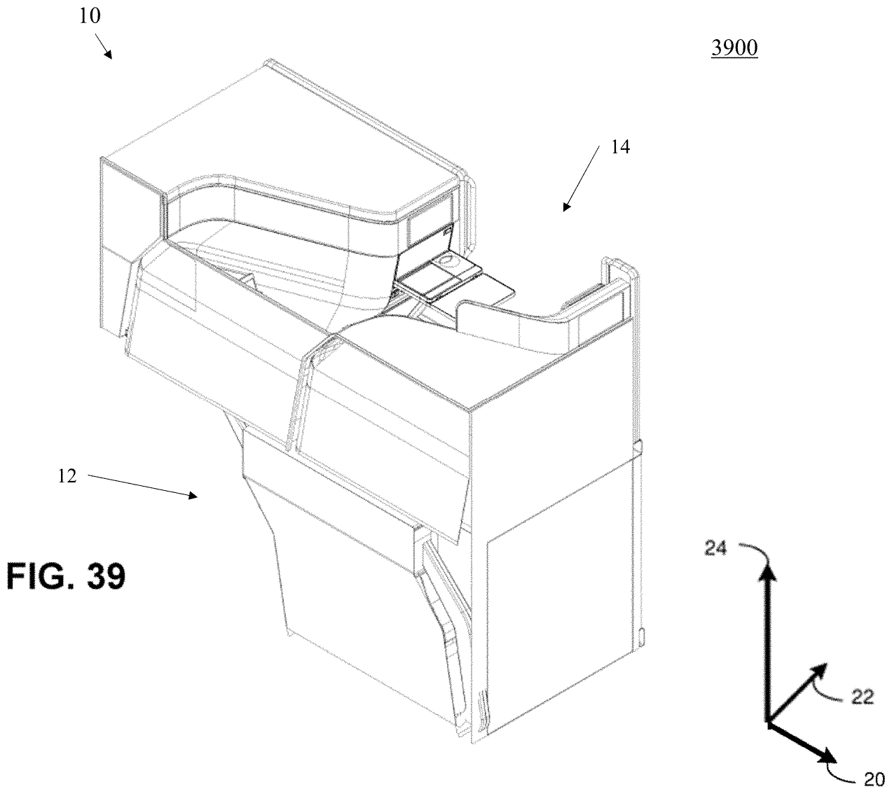

As depicted, the vehicle seating arrangement 10 may further include one or more shrouds 3524 connecting each of said structural units. The shroud(s) 3524 may serve both a functional purpose in connected the structural units and also an aesthetic function in presenting a unified appearance to the vehicle interior. Furthermore, one or more gaps may be defined between shrouds 3524 to allow for a passenger to access the seating suite. Thus, each seating suite may be almost entirely enclosed by wall 4113 and/or shroud(s) 3524 other than the gap to access the respective seating suite. For example, the one or more walls 3524 may extend from behind or from the top of the backrest 4102, around the back of the backrest 4102, and at least partially around at least one side of the integrated seat pan 4104. In the example of FIGS. 39-46, where the lower seating suite 12 is positioned along an interior wall of the vehicle, the wall(s) 3524 may extend around the back of the backrest 4102 and at least partially vertically between the backrest 4102 and the bottom of upper seating suite 14. It will be appreciated that each seating suite may be at least partially enclosed in various configurations within the scope of the present disclosure. For example, a seating suite positioned against a wall of a vehicle may be less enclosed than a seating suite positioned within the middle of the vehicle.

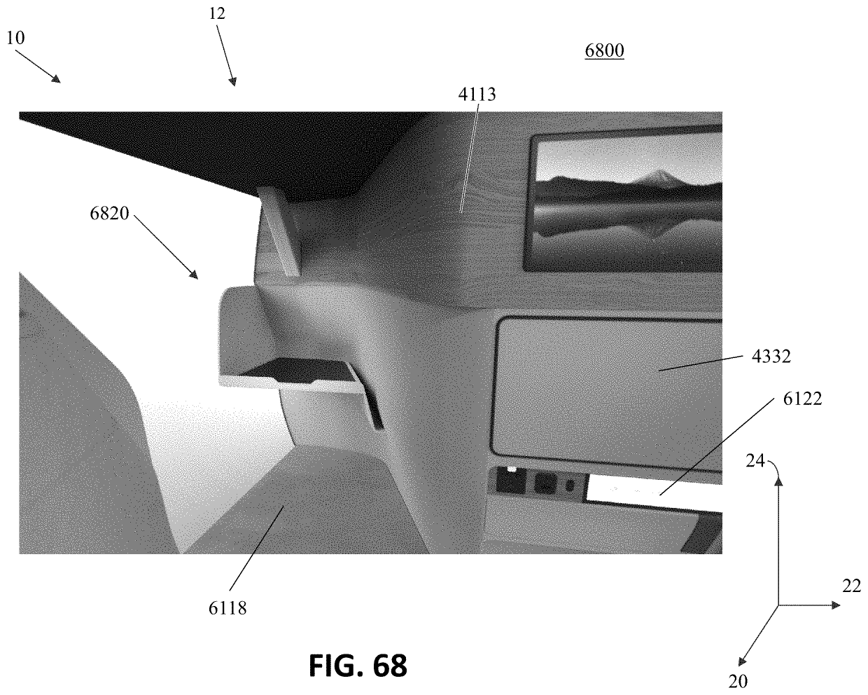

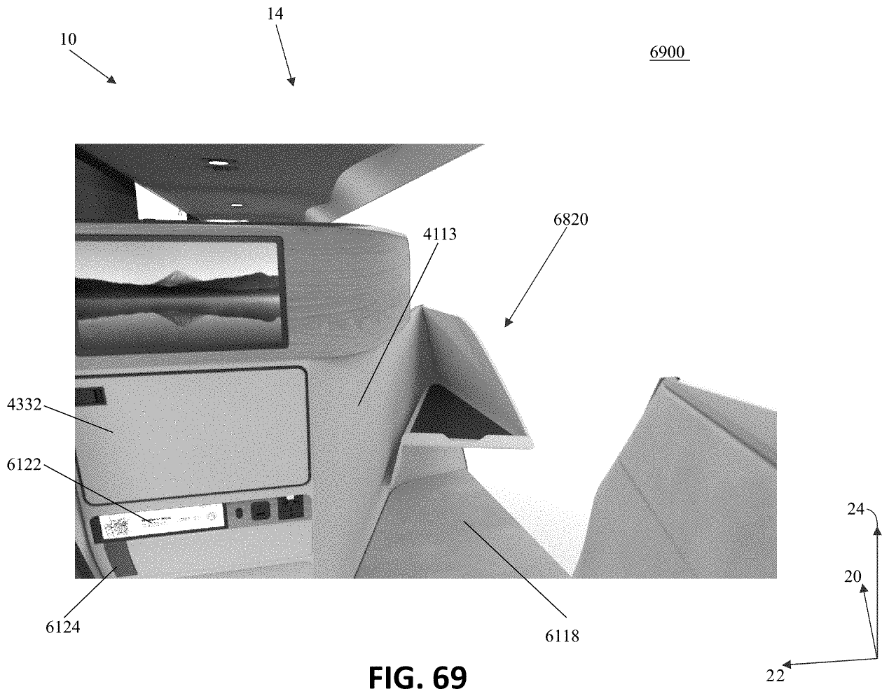

A storage area may be incorporated into an enclosure or the wall 4113 of the seating suite. As shown in FIGS. 68-69 and for example, the wall(s) 3524 may extend along one side of the integrated seat pan 4104 and may taper to form a storage area 6820. The storage area 6820 may be disposed over the footwell portion of the lie-flat bed 6118 of an exemplary seating suit to provide additional storage for personal items. For example, the storage area 6820 may be partially recessed into, formed by, or at least partially enclosed by the wall 4113. The storage area 6118 may include a side counsel, a small item table, and/or a laptop or magazine storage.

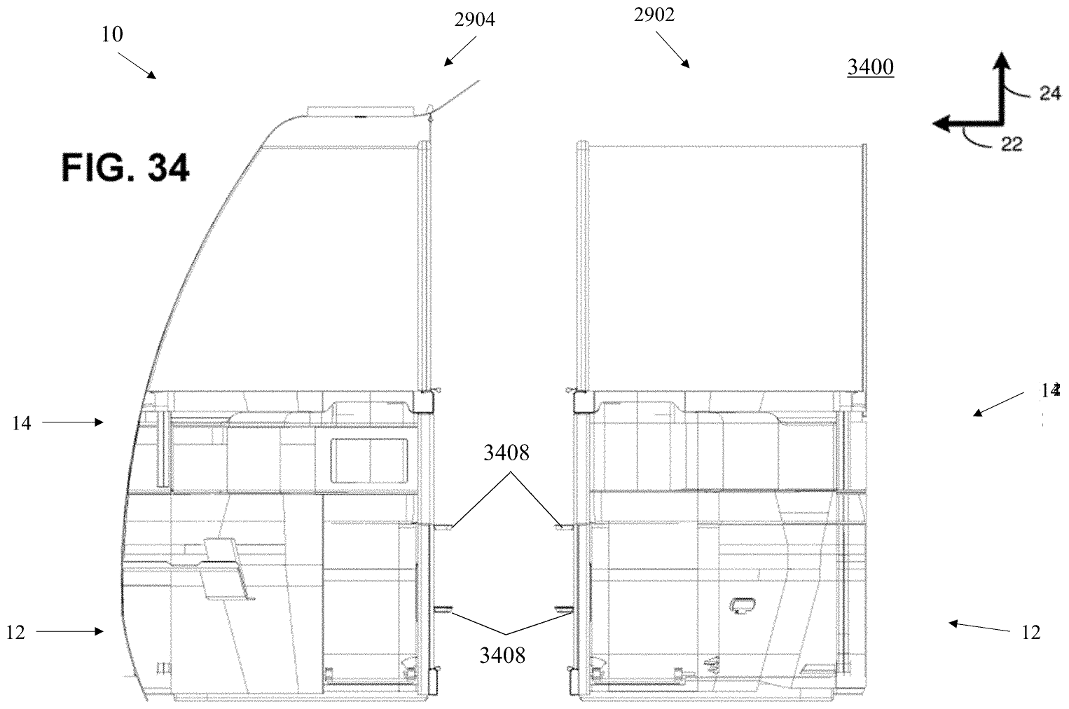

A plurality of steps 3408 for reaching the upper seating suite 14 may be positioned on the main structural unit on an outside surface of the lower seating suite 12 and/or a combination of lower seating suites 12. According to one embodiment, the steps 3408 may be positioned on the main structural unit below twenty-five inches. The steps 3408 are designed and oriented such that multiple foot orientations may be utilized in accessing the upper seating suite. Additionally, or alternatively, steps 3408 may extend from, attach to, couple to, or the like from the respective main structural unit, the frame 7334, and/or the associated shroud(s) 3524. According to another aspect of the invention, as shown in FIG. 34, the steps 3408 on each side of an aisle may be accessible from each side of the aisle in order to aid in accessing the upper seating suite(s) 14. However, it should be appreciated that the steps 3408 may be disposed anywhere on or between respective lower seating suite 12 and upper seating suite 14. The steps 3408 may be formed from any metal, metal alloy, plastic, wood, synthetic materials, etc. known in the art. Additionally or alternatively and as discussed above, a ladder (e.g., ladder 44, ladder 702, telescopic ladder 2502, or the like) may be disposed between the lower seating suite 12 and an upper seating suite 14. However, it should be appreciated that the disclosure herein is equally applicable to seating suite configurations 10 including suitable stairs, steps, ramps, or the like for accessing one or more upper seating suites 14.

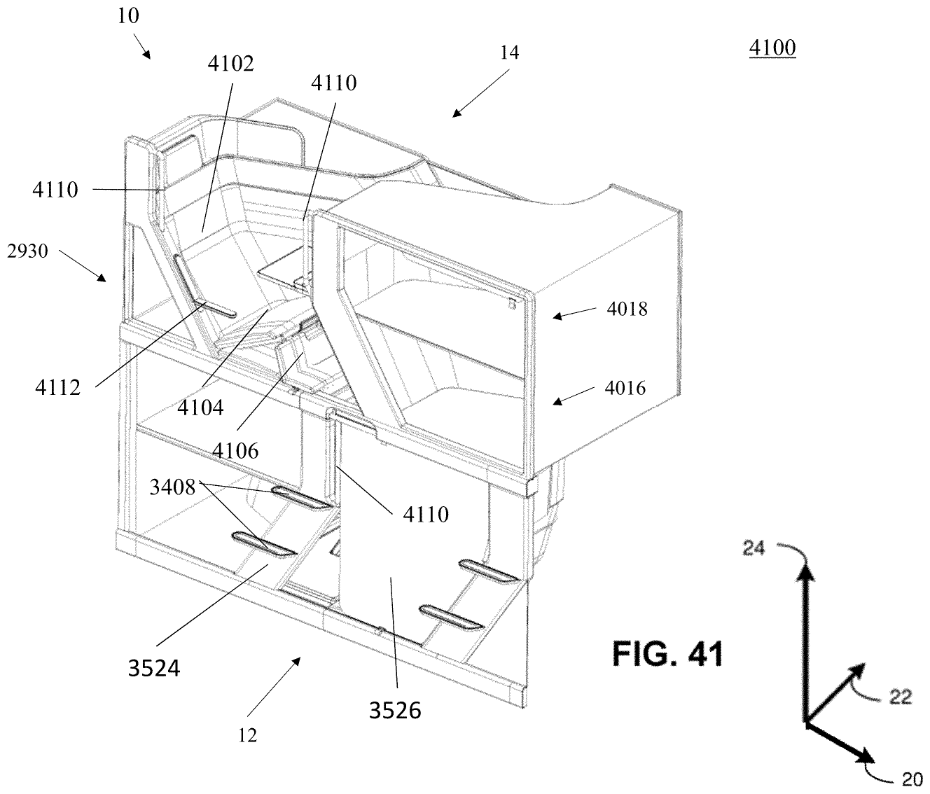

As shown (e.g., FIGS. 41, 58, 63-65, and 74), one or more handles 4110 may be incorporated in and attached to the main structural unit for assisting in reaching the upper seating suites 14. The handle(s) 4110 are generally configured to provide safe access to and from the respective upper seating suite 14. Additionally, or alternatively, one or more handles 4110 may be oriented generally along the vertically axis 24. Additionally, or alternatively, one or more handles 4110 may be oriented generally along the longitudinal axis 20.

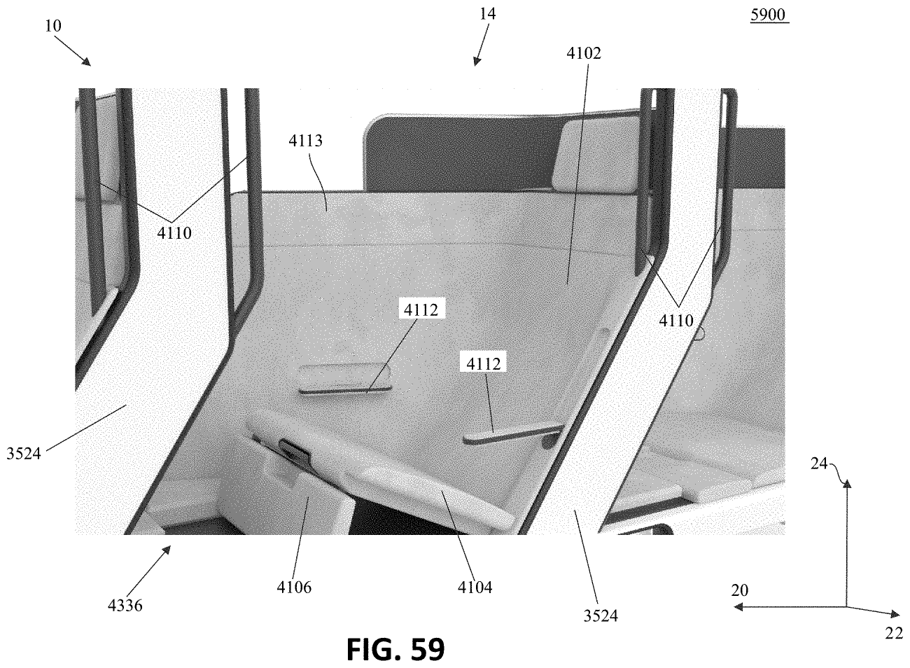

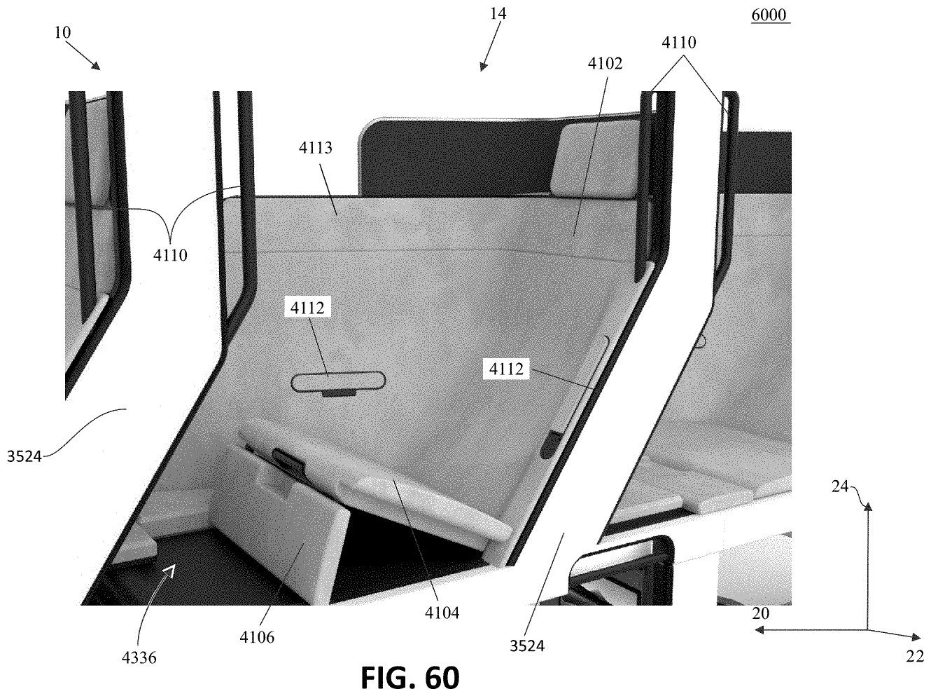

As shown particularly in FIGS. 59 and 60, each of the respective upper and lower seating suites 14, 12 may further include one or more folding armrests 4112, which move from a deployed position where the armrest(s) 4112 may be used by an occupant to a stowed position which may be helpful for ingress/egress from the suite. When in the deployed position, the folding armrest(s) 4112 may be positioned generally adjacent to backrest 4102, such as when a passenger is in the respective seating suite 14. As depicted, the armrest(s) 4112 may be configured to be flush relative to the respective seating suite (e.g., the wall 4113 and/or shroud 3524). For instance, the armrest(s) 4112 may be configured to provide a continuous surface relative to the wall 4113 and/or the shroud 3524 of the respective seating suite when in the stowed position. Additionally, or alternatively, the armrest(s) 4112 may include a soft touch top(s) to increase occupant comfort when in the deployed position. In some embodiments, the armrest(s) 4112 may include soft touch bottom(s) to increase occupant comfort when in the stowed position. It should be appreciated that the backrest 4102, the wall 4113, the integrated seat pan 4104, the lower extension portion 4106, and/or the lie-flat bed 6118 may additionally or alternatively include one or more soft touch surfaces to increase occupant comfort.

As shown in the exemplary embodiments of FIGS. 61, 62, and 66-69, when multiple structural units are positioned in a row, each of the upper and lower seating suites 14, 12 may include a passenger service unit (PSU 6122) integrated into a rear surface of the respective suite such that a passenger seated in another suite immediately behind said suite may interact with the PSU 6122. The PSU 6122 may generally be configured to provide a passenger of the respective seating suite with relevant information. Additionally, or alternatively, the PSU 6122 may be configured to include no smoking and/or seat belt signs. In another embodiment, the PSU 6122 may include appropriate electronic or communication connection receptacles (e.g., power connections, electrical sockets, USB receivers, AUX connections, other audio or visual communication connections, and/or the like). Similarly, a personal flotation device such as an inflatable life vest (e.g., life jacket pull tab 6124, a life jacket button, or the like) may be positioned along with the PSU 6122, e.g., in the wall 4113 of the respective seating suite and/or the rear of a suite such that it is accessible to the rearward seated occupant.

According to the embodiments of FIGS. 29-74, oxygen systems accessible to occupants of the upper seating suites 14 may be located in the ceiling of the vehicle. Also, oxygen systems accessible to occupants of the lower seating suites 12 may be located and integrated with the structural unit above the respective lower seating suites 12 and below the associated upper seating suite 14.

In some embodiments, the gap for entry to each seating suite (e.g., defined by wall 4113 and/or at least one shroud 3524) may be associated with a respective curtain to provide a passenger privacy in their seating suite. For instance, referring particularly to the exemplary embodiment of FIG. 58, a curtain for upper suite 14 may be hidden in a custom ceiling associated with upper suite 14 and/or the ceiling of the vehicle. Additionally, or alternatively, a curtain for lower suite 12 may be hidden in the associated shroud 3524 (e.g., a longitudinally oriented shroud 3524) and/or an associated handle 4110 (e.g., a longitudinally oriented handle 4110). In additional or alternative embodiments, a privacy screen 3526 may be attached to a top portion of the structural unit or to the ceiling of the vehicle interior for providing privacy to the occupant of the upper seating suite 14. Similarly, a privacy screen 3526 may be attached to a central portion of the associated structural unit, at a top portion of the lower seating suite 12, for providing privacy to the occupant of the lower seating suite 12. In some embodiments, one or more structural units may include additional privacy screens 3526 for providing privacy for the associated occupants' personal items. For instance, the lower storage compartment 4016 and/or the upper storage compartment 4018 may each include or be associated with a privacy screen 3526, as shown. A privacy screen 3526, as used herein, may include a retractable textile screen that that moves from a deployed to a stowed position at the option of the occupant.

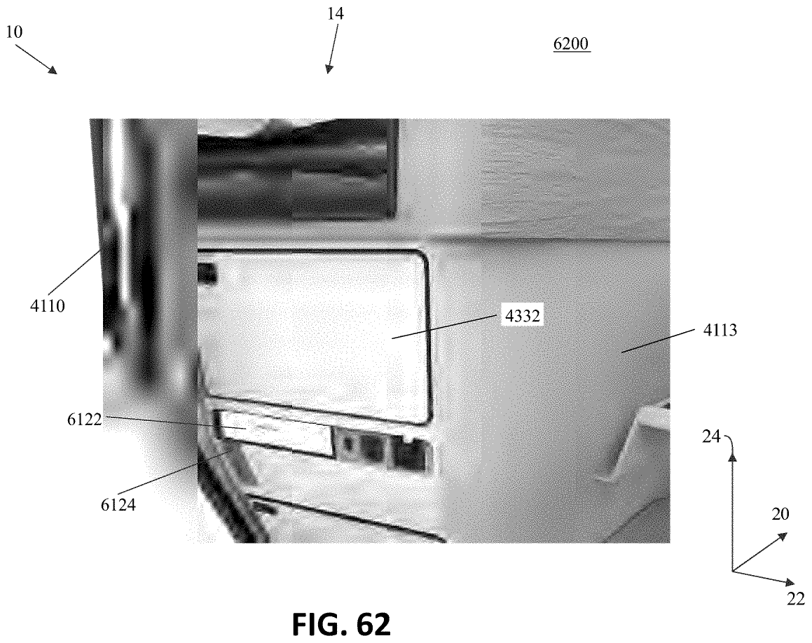

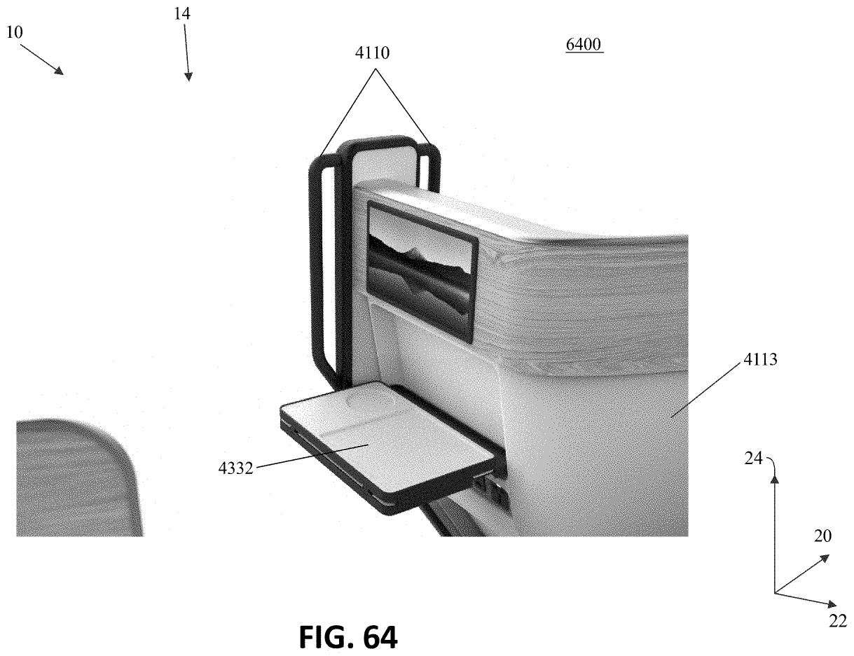

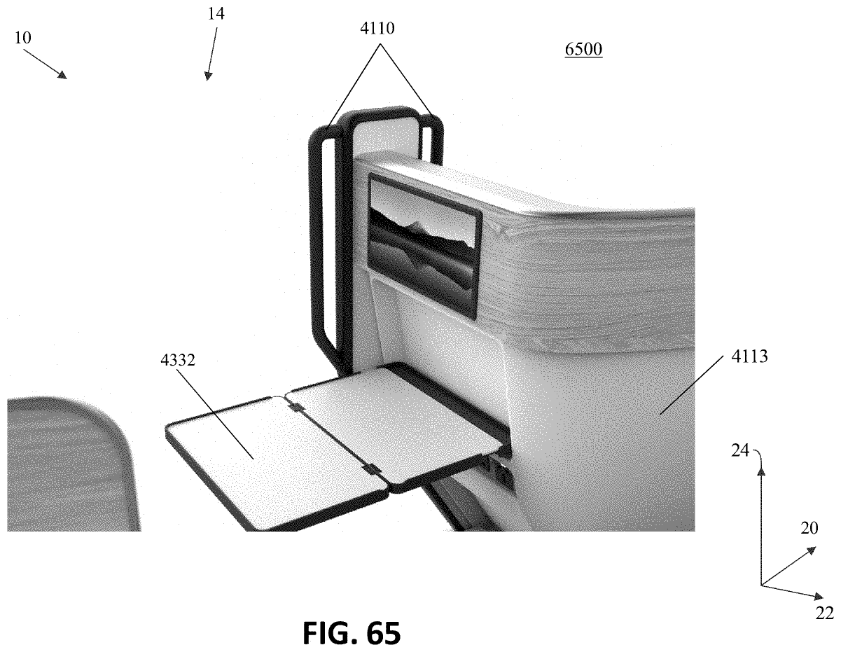

In some embodiments (see, e.g., FIGS. 62-65), a seating suite may include a tray table disposed adjacent to the integrated seat pan 4104. For example, each seating suite may include tray table 4332 incorporated into the wall 4113, shroud 3524, and/or integrated into a rear surface of a seating suite configured to be in front of an occupant of the associated seating suite. In some embodiments, tray table 4332 may be a bi-fold tray table. In additional or alternative embodiments, tray table 4332 may fold out and/or extend out, as shown. The tray table 4332 may include a cocktail table portion configured to retain a occupant's beverage, e.g., a depression in tray table 4332. In some embodiments (e.g., FIG. 64), the cocktail table portion may be configured to be accessible to an associated occupant when the tray table 4332 is in a semi-folded out position. Furthermore, in some embodiments (e.g., FIG. 65), the tray table 4332 may include a full tray table configured to be accessible to an associated occupant when the tray table 4332 is in a fully-folded out position. For instance, the cocktail table portion may be positioned on an opposite surface of at least a portion of the full tray table, as shown. However, it will be appreciated that various configurations for the tray table are possible within the scope of the present disclosure.

The foregoing has described various embodiments of a vehicle suite seating arrangement. While specific embodiments of the present invention have been described, it will be apparent to those skilled in the art that various modifications thereto can be made without departing from the spirit and scope of the invention. Accordingly, the foregoing description of the invention and the best mode for practicing the invention are provided for the purpose of illustration only and not for the purpose of limitation. It is envisioned that other embodiments may perform similar functions and/or achieve similar results. Any and all such equivalent embodiments and examples are intended to be within the scope of the claims if they include structural elements that do not differ from the literal language of the claims, or if they include equivalent structural elements with insubstantial differences from the literal languages of the claims.

What is claimed is:

1. A vehicle seating arrangement comprising a plurality of structural units positioned along a longitudinal axis of a vehicle, each structural unit comprising:
a frame supported relative to the vehicle;
a lower seating suite generally facing a forward portion of the vehicle and being configurable between an upright seating position and a lie-flat seating position;
an upper seating suite generally facing an aft portion of the vehicle and being configurable between an upright seating position and a lie-flat seating position; and
an integrated seat pan and extension positioned in each of the respective upper and lower seating suites for optionally configuring the respective upper or lower seating suite in either the upright seating position or the lie-flat seating position.

2. The vehicle seating arrangement of claim 1, further comprising:
a plurality of steps supported relative to the frame on an exterior surface of the lower seating suite, the plurality of steps configured for accessing the upper seating suite.

3. The vehicle seating arrangement of claim 1, wherein each one of the structural units are connected one to another in a row along an outboard wall of the vehicle.

4. The vehicle seating arrangement of claim 1, wherein each one of the structural units are connected one to another in a row along an inboard aisle of the vehicle.

5. The vehicle seating arrangement of claim 1, wherein a first set of structural units are connected one to another in a row along an outboard wall of the vehicle, and wherein a second set of structural units are connected one to another in row along an aisle of the vehicle, the aisle formed between the respective first set of structural units and second set of structural units.

6. The vehicle seating arrangement of claim 1, wherein the vehicle is configured as an aircraft.

7. The vehicle seating arrangement of claim 1, wherein the vehicle is configured as an airplane.

8. The vehicle seating arrangement of claim 1, wherein the vehicle is configured as a train.

9. A vehicle seating arrangement comprising a plurality of structural units positioned along a longitudinal axis of a vehicle, each structural unit comprising:
a frame supported relative to the vehicle;
a lower seating suite generally facing an aft portion of the vehicle and being configurable between an upright seating position and a lie-flat seating position;
an upper seating suite generally facing a forward portion of the vehicle and being configurable between an upright seating position and a lie-flat seating position; and
an integrated seat pan and extension positioned in each of the respective upper and lower seating suites for optionally configuring the respective upper or lower seating suite in either the upright seating position or the lie-flat seating position.

10. The vehicle seating arrangement of claim 9, further comprising:
a plurality of steps supported relative to the frame on an exterior surface of the lower seating suite, the plurality of steps configured for accessing the upper seating suite.

11. The vehicle seating arrangement of claim 9, wherein each one of the structural units are connected one to another in a row along an outboard wall of the vehicle.

12. The vehicle seating arrangement of claim 9, wherein each one of the structural units are connected one to another in a row along an inboard aisle of the vehicle.

13. The vehicle seating arrangement of claim 9, wherein a first set of structural units are connected one to another in a row along an outboard wall of the vehicle, and wherein a second set of structural units are connected one to another in row along an aisle of the vehicle, the aisle formed between the respective first set of structural units and second set of structural units.

14. The vehicle seating arrangement of claim 9, wherein the vehicle is configured as an aircraft.

15. The vehicle seating arrangement of claim 9, wherein the vehicle is configured as an airplane.

16. The vehicle seating arrangement of claim 9, wherein the vehicle is configured as a train.

17. A vehicle seating arrangement comprising a plurality of structural units positioned within a vehicle, each structural unit comprising:
a frame supported relative to the vehicle;
a lower seating suite generally facing a first direction relative to the vehicle and being configurable between an upright seating position and a lie-flat seating position;
an upper seating suite generally facing a second direction relative to the vehicle and being configurable between an upright seating position and a lie-flat seating position, wherein the second direction is substantially opposite to the first direction; and
an integrated seat pan and extension positioned in each of the respective upper and lower seating suites for optionally configuring the respective upper or lower seating suite in either the upright seating position or the lie-flat seating position.

18. The vehicle seating arrangement of claim 17, further comprising:
a plurality of steps supported relative to the frame on an exterior surface of the lower seating suite, the plurality of steps configured for accessing the upper seating suite.

19. The vehicle seating arrangement of claim 17, wherein the vehicle is configured as an aircraft.

20. The vehicle seating arrangement of claim 17, wherein the vehicle is configured as a train.
